(19) United States
(12) Patent Application Publication
(10) Pub. No.: US 2024/0227164 A1
(43) Pub. Date: Jul. 11, 2024

(54) Stance Adjustment for A Robotic System

(71) Applicant: Sarcos Corp., Salt Lake City, UT (US)

(72) Inventor: Fraser M. Smith, Salt Lake City, UT (US)

(21) Appl. No.: 18/094,294

(22) Filed: Jan. 6, 2023

(51) Int. Cl. B25J 9/00

(52) U.S. Cl. CPC B25J 9/0009; B25J 9/0006

(57) ABSTRACT

A stance adjustment system operable to adjust a stance of a robotic system. The stance adjustment system includes a guide member, an adjustable appendage support member, and an adjustment mechanism being operable to facilitate adjustment of the first adjustable appendage support member and the first ground contacting appendage between a first position and a second position relative to a sagittal plane of the robotic system. The first position of the adjustable appendage support member is associated with the first stance, and the second position of the adjustable appendage support member is associated with the second stance. The first and second stances comprise different distances of the ground contacting appendage relative to the sagittal plane of the robotic system.

### BACKGROUND

Robots and robotic systems (e.g., humanoid robots, wearable robotic exoskeletons, and others), can be complex systems with many component parts and control operations working together to provide mobility and functionality of the robotic system. In the case of wearable exoskeletons, it is likely that many different people of many different shapes, sizes, heights, weights, and widths may be required to wear and operate the same single robotic exoskeleton. However, with the complex systems and multiple component parts of the robotic exoskeleton, it can be difficult to adjust the size of the exoskeleton to accommodate different users. Additionally, adjustments can take significant amounts of time, requiring long periods of downtime for the robotic exoskeleton when switching out users of the exoskeleton.

Additionally, even robots that are not wearable by a user may require size adjustment in one or more dimensions. For example, a humanoid robot may benefit from additional stability provided by a wider stance or wider distance between the ground contacting legs of the humanoid robot. Therefore, size adjustability can also be beneficial for robots that are not wearable by a human. If a robot is suffering from a lack of stability during operation, it may be beneficial to make quick size adjustments to the robot without requiring significant downtime. Accordingly, efficient devices, systems, and methods that allow the size of the exoskeleton/robot to be adjusted quickly with low downtime continue to be developed.

### SUMMARY

An initial summary of the disclosed technology is provided here. Specific technology examples are described in further detail below. This initial summary is intended to set forth examples and aid readers in understanding the technology more quickly, but is not intended to identify key features or essential features of the technology nor is it intended to limit the scope of the claimed subject matter.

According to one example in the present disclosure, a robotic system can include an adjustable joint/appendage locator mechanism to facilitate adjusting a hip width or stance of a robotic system. In accordance with one example, a robotic system configured to provide different stances can include a first ground contacting appendage. The robotic system can further include a stance adjustment system operable to adjust a stance of the robotic system between a first stance and a second stance. The stance adjustment system can include a guide member comprising a first end and a second end opposite to the first end. The stance adjustment system can further include a first adjustable appendage support member comprising a first appendage mounting portion to which the first ground contacting appendage can be mounted and an adjustment portion adjustably coupled to the first end of the guide member. The stance adjustment system can further include an adjustment mechanism coupled to at least one of the guide member and the first adjustable appendage support member. The adjustment mechanism can be operable to facilitate adjustment of the first adjustable appendage support member and the first ground contacting appendage between a first position and a second position relative to a sagittal plane of the robotic system. The first position of the first adjustable appendage support member can be associated with the first stance, and the second position of the first adjustable appendage support member can be associated with the second stance. The first and second stances can comprise different distances of the first ground contacting appendage relative to the sagittal plane of the robotic system.

According to another example in the present disclosure, a robotic system can be configured to provide different stances can include a first ground contacting appendage and a second ground contacting appendage. The robotic system can further include a stance adjustment system operable to adjust a stance of the robotic system between a first stance and a second stance. The stance adjustment system can include a guide member comprising a first end and a second end opposite to the first end. The stance adjustment system can further include a first adjustable appendage support member comprising a first appendage mounting portion to which the first ground contacting appendage is mounted and an adjustment portion adjustably coupled to the first end of the guide member. The stance adjustment system can further include a second adjustable appendage support member comprising a second appendage mounting portion to which the second ground contacting appendage is mounted and an adjustment portion adjustably coupled to the second end of the guide member. The stance adjustment system can further include an adjustment mechanism coupled to the first adjustable appendage support member and the second adjustable appendage support member. The adjustment mechanism can be operable to facilitate adjustment of the first and second adjustable appendage support members and first and second ground contacting appendages between first positions and second positions relative to a sagittal plane of the robotic system. The first positions of the first and second adjustable appendage support member can be associated with the first stance, and the second positions of the first and second adjustable appendage support members can be associated with the second stance. The first and second stances can comprise different distances of the first and second ground contacting appendages relative to the sagittal plane of the robotic system.

According to another example in the present disclosure, a robotic exoskeleton configured to accommodate users of different size can include a first ground contacting appendage comprising one or more joints corresponding to respective degrees of freedom of a first leg of a user and a second ground contacting appendage comprising one or more joints corresponding to respective degrees of freedom of a second leg of the user. The robotic exoskeleton can further include a frame mount in support of the first and second ground contacting appendages. The robotic exoskeleton can further include a stance adjustment system coupled to the frame mount and operable to adjust a stance of the robotic exoskeleton from a first stance to a second stance. The stance adjustment system can include a guide member comprising a first end and a second end opposite to the first end. The stance adjustment system can further include a first adjustable appendage support member comprising a first appendage mounting portion to which the first ground contacting appendage is mounted and an adjustment portion moveably coupled to the first end of the guide member. The stance adjustment system can further include a second adjustable appendage support member comprising a second appendage mounting portion to which the second ground contacting appendage is mounted and a second adjustment portion moveably coupled to the second end of the guide member. The stance adjustment system can further include an adjustment mechanism coupled to the first adjustable appendage support member and the second adjustable appendage support member. The adjustment mechanism can be operable to facilitate adjustment of the first and second adjustable appendage support members and first and second ground contacting appendages between first positions and second positions relative to a sagittal plane of the robotic system. The first positions of the first and second adjustable appendage support member can be associated with the first stance, and the second positions of the first and second adjustable appendage support members can be associated with the second stance. The first and second stances can comprise different distances of the first and second ground contacting appendages relative to the sagittal plane of the robotic system to accommodate different hip widths of the different users.

Another example of the present disclosure is directed to a method of facilitating stance adjustment of a robotic system. The method can include a step of configuring the robotic system to include a first ground contacting appendage. The method can further include a step of configuring the robotic system to include a stance adjustment system operable to adjust a stance of the robotic system from a first stance to a second stance. The method can further include a step of configuring the stance adjustment system to include a guide member comprising a first end and a second end opposite to the first end. The method can further include a step of configuring the stance adjustment system to include a first adjustable appendage support member comprising a first appendage mounting portion to which the first ground contacting appendage is mounted and an adjustment portion adjustably coupled to the guide member. The method can further include a step of configuring the stance adjustment system to include an adjustment mechanism coupled to at least one of the guide member and the first adjustable appendage support member. The adjustment mechanism can be operable to facilitate adjustment of the first adjustable appendage support member and the first ground contacting appendage between a first position and a second position relative to a sagittal plane of the robotic system. The adjustment mechanism can be operable to move the first adjustable appendage support member from a first position associated with the first stance to a second position associated with the second stance. The first and second positions can have different distances relative to the sagittal plane of the robotic system. The first position of the first adjustable appendage support member can be associated with the first stance, and the second position of the first adjustable appendage support member can be associated with the second stance. The first and second stances can comprise different distances of the first ground contacting appendage relative to the sagittal plane of the robotic system.

In some examples, the guide member can include a first slot defined in the first end and configured to receive at least a part of the adjustment portion of the first adjustable appendage support member. The first adjustable appendage support member can be configured to adjust position within the first slot in response to operation of the adjustment mechanism to adjust the first adjustable appendage support member between the first position and the second position.

In some examples, the guide member can include a first guide rail formed in the first end and configured to slideably support at least a part of the adjustment portion of the first adjustable appendage support member. The first adjustable appendage support member can be configured to slide along the first guide rail in response to operation of the adjustment mechanism to adjust the first adjustable appendage support member between the first position and the second position.

In some examples, the adjustment mechanism can include a first actuator operable to adjust the first adjustable appendage support member between the first position and the second position to thereby adjust the stance of the robotic system between the first stance and the second stance.

In some examples, the first adjustable appendage support member can include a threaded hole formed in the adjustment portion. The adjustment mechanism can further include a first elongated rod coupled to the first actuator and having a threaded surface formed thereon. The threaded surface of the first elongated rod can be configured to engage with the threaded hole of the first adjustable appendage support member. The first actuator can be operable to cause rotation of the first elongated rod causing the first adjustable appendage support member to adjust position along the first elongated rod between the first position and the second position to thereby adjust the stance of the robotic system between the first stance and the second stance.

In some examples, the adjustment mechanism can include a first linkage coupling the first adjustable appendage support member to the first actuator. The actuator can be operable to move the first linkage to adjust the first adjustable appendage support member between the first position and the second position to thereby adjust the stance of the robotic system between the first stance and the second stance.

In some examples, the robotic system can include a second adjustable appendage support member comprising a second appendage mounting portion to which the second ground contacting appendage is mounted and an adjustment portion adjustably coupled to the second end of the guide member.

In some examples, the robotic system can further include a second adjustment mechanism coupled to at least one of the guide member and the second adjustable appendage support member. The second adjustment mechanism can be operable to facilitate adjustment of the second adjustable appendage support member and the second ground contacting appendage between a first position and a second position relative a sagittal plane of the robotic system. The first position of the second adjustable appendage support member can be associated with the first stance, and the second position of the second adjustable appendage support member can be associated with the second stance.

In some examples, the guide member can include a second slot defined in the second end and configured to receive at least a part of the adjustment portion of the second adjustable appendage support member. The second adjustable appendage support member can be configured to adjust position within the second slot in response to operation of the adjustment mechanism to adjust the second adjustable appendage support member from the first position to the second position.

In some examples, the guide member can include a second guide rail formed in the second end and configured to slideably support at least a part of the adjustment portion of the second adjustable appendage support member. The second adjustable appendage support member can be configured to slide along the second guide rail in response to operation of the adjustment mechanism to adjust the second adjustable appendage support member between the first position and the second position.

In some examples, the second adjustment mechanism can include a second actuator operable to adjust the second adjustable appendage support member between the first position and the second position to thereby adjust the stance of the robotic system between the first stance and the second stance.

In some examples, the adjustment mechanism can include an adjustable bridge that connects the first ground contacting appendage to the second ground contacting appendage via the first and second adjustable appendage support members. The adjustable bridge can be operable to facilitate adjustment of the first and second adjustable appendage support members and the first and second ground contacting appendages. The adjustable bridge can include an actuator wherein the actuator can be operable to adjust the first adjustable appendage support member between the first position and the second position. The actuator can be operable to adjust the second adjustable appendage support member between a first position and a second position of the second adjustable appendage support member relative a sagittal plane of the robotic system. The first position and the second position of the second adjustable appendage support member being respectively associated with the first stance and the second stance.

In some examples, the actuator can be operable to adjust the first and second adjustable appendage support members by a same amount relative to the sagittal plane such that positions of the first and second adjustable appendage support members are symmetrical about the sagittal plane in both the first stance and the second stance.

In some examples, the first adjustable appendage support member can include a threaded hole formed in the adjustment portion thereof. The adjustment mechanism can further include a first elongated rod coupled to the actuator and having a threaded surface formed thereon. The threaded surface of the first elongated rod can be configured to engage with the threaded hole of the first adjustable appendage support member.

In some examples, the second adjustable appendage support member can include a threaded hole formed in the adjustment portion thereof. The adjustment mechanism can further include a second elongated rod coupled to the actuator and having a threaded surface formed thereon. The threaded surface of the second elongated rod can be configured to engage with the threaded hole of the second adjustable appendage support member.

In some examples, the actuator can be operable to cause rotation of the first elongated rod and the second elongated rod causing the first adjustable appendage support member to adjust position along the first elongated rod between the first position and the second position, and the second adjustable appendage support member to adjust position along the second elongated rod between the first position and the second position to adjust the stance of the robotic system from the first stance to the second stance.

In some examples, rotation of the actuator in a first direction can cause the first adjustable appendage support member and the second adjustable appendage support member to adjust away from the sagittal plane, thereby increasing a distance between the first ground contacting appendage and the second ground contacting appendage.

In some examples, rotation of the actuator in a second direction can cause the first adjustable appendage support member and the second adjustable appendage support member to adjust towards the sagittal plane, thereby decreasing a distance between the first ground contacting appendage and the second ground contacting appendage.

In some examples, the adjustable bridge can include a first linkage coupling the first adjustable appendage support member to the actuator. The adjustable bridge can further include a second linkage coupling the second adjustable appendage support member to the actuator. The actuator can be operable to move the first linkage and the second linkage to adjust the first adjustable appendage support member and the second adjustable appendage support member between their respective first positions and their respective second positions, to thereby adjust the stance of the robotic system from the first stance to the second stance.

In some examples, the actuator can be operable to adjust the first and second linkages to adjust the first and second adjustable appendage support members by a same amount relative to the sagittal plane such that positions of the first and second adjustable appendage support members are symmetrical about the sagittal plane in both the first stance and the second stance.

In some examples, the actuator can include a threaded rod having a threaded surface formed thereon.

In some examples, the adjustment mechanism can further include one or more threaded brackets moveably engaged with the threaded surface of the threaded rod. The first linkage and the second linkage can be each coupled to the one or more threaded brackets.

In some examples, rotation of the threaded rod of the actuator can cause the threaded brackets to adjust position along the threaded surface of the threaded rod to adjust positions of the first linkage and the second linkage, thereby moving the first and second adjustable appendage support members between their respective first positions and second positions to adjust the stance of the robotic system from the first stance to the second stance.

In some examples, the adjustment mechanism can include a plurality of holes formed in one or more of the first end and the second end of the guide member at a plurality of different distances from the sagittal plane. The adjustment mechanism can further include one or more holes formed in the first adjustable appendage support member and configured to align with one or more of the plurality of holes formed in one or more of the first end and the second end of the guide member. The adjustment mechanism can further include one or more fasteners configured to couple the first adjustable appendage support member to the guide member at a desired distance from the sagittal plane.

In some examples, the one or more holes formed in the first adjustable appendage support member can be formed at a plurality of different distances relative the coronal plane of the robotic system to facilitate adjustment of the first adjustable appendage support member relative to the coronal plane.

In some examples, the robotic system can further include a clamp. The clamp can include an upper body configured to fix an upper portion of the first adjustable appendage support member to an upper portion of the first end of the guide member. The upper body can have one or more holes formed therein configured to align with one or more holes of the guide member and one or more holes of the first adjustable appendage support member. The clamp can further include a lower body configured to fix a lower portion of the first adjustable appendage support member to a lower portion of the first end of the guide member. The lower body can have one or more holes formed therein configured to align with one or more holes of the guide member, one or more holes of the first adjustable appendage support member, and one or more holes of the upper body of the clamp. The clamp can be configured to clamp the adjustable appendage support member to the guide member by insertion of one or more fasteners into the one or more holes of the upper body and the lower body of the clamp aligned with one or more holes of the guide member and one or more holes of the first adjustable appendage support member.

In some examples, the robotic system can further include a first coronal adjustment mechanism coupled to the first appendage mounting portion and the adjustment portion of the first adjustable appendage support member. The first coronal adjustment mechanism can be operable to facilitate adjustment of the first adjustable appendage support member and the first ground contacting appendage between a first coronal position and a second coronal position relative to a coronal plane of the robotic system. The first coronal position of the first adjustable appendage support member can be associated with a first coronal stance of the robotic system, and the second coronal position of the first adjustable appendage support member can be associated with a second coronal stance of the robotic system. The first and second stances can comprise different distances of the first ground contacting appendage relative to the coronal plane of the robotic system.

In some examples, the robotic system can further include a second coronal adjustment mechanism coupled to the second appendage mounting portion and the adjustment portion of the second adjustable appendage support member. The second coronal adjustment mechanism can be operable to facilitate adjustment of the second adjustable appendage support member and the second ground contacting appendage between a first coronal position and a second coronal position relative to a coronal plane of the robotic system. The first coronal position of the second adjustable appendage support member can be associated with a first coronal stance of the robotic system. The second coronal position of the second adjustable appendage support member can be associated with a second coronal stance of the robotic system. The first and second stances can comprise different distances of the second ground contacting appendage relative to the coronal plane of the robotic system.

In some examples, the robotic system can further include a lower exoskeleton portion configured to receive at least a portion of a lower body of a user. The robotic system can further include an upper exoskeleton portion configured to receive at least a portion of an upper body of a user. The robotic system can further include a frame mount coupled to one or more of the lower exoskeleton portion and the upper exoskeleton portion. The guide member of the stance adjustment system can be coupled to the frame mount.

In some examples, the robotic system can further include a lower exoskeleton portion configured to receive at least a portion of a lower body of a user. The robotic system can further include an upper exoskeleton portion configured to receive at least a portion of an upper body of a user. The lower exoskeleton portion and the upper exoskeleton portion can be coupled to the stance adjustment system.

In some examples, the adjustment mechanism can be operable to facilitate adjustment of the first adjustable appendage support member and the first ground contacting appendage between three or more positions relative to a sagittal plane of the robotic system.

In some examples, the second adjustment mechanism can be operable to facilitate adjustment of the second adjustable appendage support member and the second ground contacting appendage between three or more positions relative to a sagittal plane of the robotic system.

In some examples, the adjustable bridge can be operable to facilitate adjustment of each of the first and second adjustable appendage support members between three or more positions relative to a sagittal plane of the robotic system.

In some examples, the actuator can comprise a pinion gear. The adjustment mechanism can further include a first rack coupling the first adjustable appendage support member to the pinion gear. The pinion gear can be operable to move the first rack to adjust the first adjustable appendage support member between a first position and a second position, to thereby adjust the stance of the robotic system from the first stance to the second stance.

In some examples, the actuator can comprise a pinion gear. The adjustable bridge can further include a first rack coupling the first adjustable appendage support member to the pinion gear. The adjustable bridge can further include a second rack coupling the second adjustable appendage support member to the pinion gear. The pinion gear can be operable to move the first rack and the second rack to adjust the first adjustable appendage support member and the second adjustable appendage support member between their respective first positions and their respective second positions, to thereby adjust the stance of the robotic system from the first stance to the second stance.

In some examples, the pinion gear can be operable to adjust the first and second racks to adjust the first and second adjustable appendage support members by a same amount relative to the sagittal plane such that positions of the first and second adjustable appendage support members are symmetrical about the sagittal plane in both the first stance and the second stance.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1A illustrates an isometric view of a robot in the form of a wearable exoskeleton in accordance with an example of the present disclosure.

FIG. 1B illustrates an isometric view of the exoskeleton robot of FIG. 1A with certain portions omitted for clarity.

FIG. 2A illustrates a front view of a mounting structure of the robot of FIG. 1A in accordance with an example of the present disclosure.

FIG. 2B illustrates an isometric view of the mounting structure of FIG. 2A.

FIG. 3A illustrates an isometric view of legs of the exoskeleton of FIG. 1A in accordance with an example of the present disclosure.

FIG. 3B illustrates a side view of a leg of the exoskeleton of FIG. 1A in accordance with an example of the present disclosure.

FIG. 4A illustrates a rear view of legs of the exoskeleton of FIG. 1A connected by a stance adjustment system in accordance with an example of the present disclosure.

FIG. 4B illustrates a schematic diagram of leg appendages of the exoskeleton of FIG. 1A connected by a stance adjustment system and the stance adjustment system coupled to a frame mount of the robotic system in accordance with an example of the present disclosure.

FIG. 5A illustrates an isometric view of a stance adjustment system in accordance with an example of the present disclosure.

FIG. 5B illustrates an exploded view of the stance adjustment system of FIG. 5A.

FIG. 5C illustrates a side view of the stance adjustment system of FIG. 5A.

FIG. 5D illustrates a front view of the stance adjustment system of FIG. 5A.

FIG. 6 illustrates a top view of an adjustment mechanism of the stance adjustment system of FIG. 5A.

FIG. 7 illustrates a top view of various connection configurations of the adjustment mechanism of FIG. 6.

FIG. 8 illustrates a side view of the stance adjustment system of FIG. 5A and adjustment thereof in a forward direction with a user wearing the exoskeleton of FIG. 1A.

FIG. 9A illustrates an isometric view of a portion of the stance adjustment system of FIG. 5A coupled to a spine of a robotic system.

FIG. 9B illustrates a top view of a portion of the stance adjustment system of FIG. 5A coupled to a spine of a robotic system in a forward oriented configuration.

FIG. 9C illustrates a top view of a portion of the stance adjustment system of FIG. 5A coupled to a spine of a robotic system in a rearward oriented configuration.

FIG. 10A illustrates an isometric view of a coupling of the stance adjustment system in accordance with an example of the present disclosure.

FIG. 10B illustrates an isometric view of a coupling of the stance adjustment system of FIG. 10A.

FIG. 11A illustrates an internal view of a coupling of the stance adjustment system of FIG. 10A.

FIG. 11B illustrates a top view of a coupling of the stance adjustment system of FIG. 10A.

FIG. 12A illustrates a rear view of a stance adjustment system in accordance with an example of the present disclosure in both retracted and extended positions.

FIG. 12B illustrates a top view of the stance adjustment system of FIG. 12A.

FIG. 12C illustrates a cross-sectional view of the stance adjustment system of FIG. 12A with the internal workings of the mechanism illustrated in both retracted and extended positions.

FIG. 12D illustrates a top view of a stance adjustment system in accordance with an example of the present disclosure in both retracted and extended positions.

FIG. 12E illustrates a rear view of the stance adjustment system of FIG. 12D.

FIG. 13 illustrates a top view of a stance adjustment system in accordance with an example of the present disclosure.

FIG. 14A illustrates a rear view of legs of the exoskeleton of FIG. 1A connected by the stance adjustment system of FIG. 12A with the legs in a retracted position.

FIG. 14B illustrates a rear view of legs of the exoskeleton of FIG. 1A connected by the stance adjustment system of FIG. 12B with the legs in an extended position.

FIG. 15 illustrates a perspective view of portions of the stance adjustment system of FIG. 12B in accordance with an example of the present disclosure.

FIG. 16 illustrates a rear view of a stance adjustment system of FIG. 12B in accordance with an example of the present disclosure and including the portions of FIG. 15.

FIG. 17A illustrates a perspective view of a portion of the stance adjustment system of FIG. 16.

FIG. 17B illustrates a perspective view of a portion of the stance adjustment system of FIG. 16.

FIG. 18A illustrates an isometric view of a stance adjustment system in accordance with an example of the present disclosure.

FIG. 18B illustrates an isometric view of a portion of the stance adjustment system of FIG. 18A.

FIG. 18C illustrates a top view of the stance adjustment system of FIG. 18A.

FIG. 19A illustrates a rear view of the stance adjustment system of FIG. 18A in both extended and retracted positions.

FIG. 19B illustrates a rear view of the stance adjustment system in accordance with an example of the present disclosure.

FIG. 20 illustrates a top view of the stance adjustment system of FIG. 18A connecting the legs of the exoskeleton of FIG. 1A.

FIG. 21 illustrates a side view of an exemplary adjustable appendage support member of any of the stance adjustment systems described herein. The internal workings of the adjustable appendage support member are illustrated to demonstrate the function of the adjustable appendage support member.

FIG. 22 illustrates a side view of the exemplary adjustable appendage support member FIG. 21 in an extended position.

FIG. 23A illustrates a side view of the exemplary adjustable appendage support member of any of the stance adjustment systems described herein. The internal workings of the adjustable appendage support member are illustrated to demonstrate the function of the adjustable appendage support member.

FIG. 23B illustrates a top view of the exemplary adjustable appendage support member of FIG. 23A.

FIG. 24 illustrates a side view of the exemplary adjustable appendage support member of any of the stance adjustment systems described herein.

FIG. 25 illustrates a side view of the exemplary adjustable appendage support member of any of the stance adjustment systems described herein.

FIG. 26A illustrates an isometric view of a stance adjustment system in accordance with an example of the present disclosure in both retracted and extended positions.

FIG. 26B illustrates a rear view of a stance adjustment system in accordance with an example of the present disclosure in both retracted and extended positions.

FIG. 26C illustrates a cross-sectional view of the stance adjustment system of FIG. 26B.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” can be either abutting or connected. Such elements can also be near or close to each other without necessarily contacting each other. The exact degree of proximity can in some cases depend on the specific context.

A “jointed appendage” refers to a structure or assembly comprising one or more joints between two or more structural members. The structure or assembly of the jointed appendage is configured to connect the two or more structural members at the joint. The jointed appendage can be configured to facilitate movement of the two or more structural members relative to one another about one or more axes. Such movement can include translation and/or rotation of the two or more structural members relative to one another in one or more degrees of freedom. For example, a “ground contacting appendage” can be a jointed appendage of a robot that is configured to contact the ground during operation of the robot.

An “actuator” comprises an element configured to be actuatable to cause relative movement between the two or more structural members about one or more axes in one or more degrees of freedom.

A “joint” is defined as a place where two or more members are joined together. Members can be joined together at a joint such that there is no relative movement between the members or such that the members can move relative to one another in one or more degrees of freedoms.

A “structural member” is a rigid support that is a constituent part of a structure or system of the robot or robotic system, such as part of a ground contacting or other appendage (e.g., a ground contacting jointed appendage, such as a leg appendage of a robotic exoskeleton).

A “stance adjustment system” refers to a system of components configured to facilitate adjustment of a stance of a robotic system about a ground surface between a first stance and a second stance. More specifically, the stance adjustment system can be configured to adjust a stance about a ground surface of a ground contacting appendage relative to another ground contacting appendage (e.g., two leg appendages of an exoskeleton type of robotic system) and/or a sagittal plane through the robotic system. For example, the stance adjustment system can be configured to facilitate adjustment of a single ground contacting appendage relative to a sagittal plane of the robotic system. In another example, the stance adjustment system can be configured to facilitate simultaneous adjustment of two ground contacting appendages relative to one another and the sagittal plane. In one example, the stance adjustment system can comprise an adjustable appendage support member, a guide member, and an adjustment mechanism operably coupled to, or otherwise operable with, the adjustable appendage support member and the guide member.

A “guide member” refers to a structural member of the stance adjustment system that is configured to support one or more other structural members, such as an adjustable appendage support member, that is/are moveable relative to the guide member via an adjustment mechanism.

An “adjustable appendage support member” refers to a structural member of the stance adjustment system that is configured to receive and support a ground contacting appendage (i.e., the ground contacting appendage can mount to the adjustable appendage support member), such as a ground contacting jointed appendage (e.g., a leg appendage having one or more joints moveable in one or more degrees of freedom). The adjustable appendage support member can be moveably coupled to the guide member.

An “adjustment mechanism” is defined as a mechanism of the stance adjustment system that is used to couple or move an adjustable appendage support member relative to another structure, such as the guide member. The adjustment mechanism can comprise a non-actuatable mechanism configured to be adjustable via fasteners, a quick-release type of system, or any other type of non-actuatable mechanism, or an actuatable mechanism configured to impart movement of the adjustable appendage support member relative to the guide member via one or more actuators. In one example, the adjustment mechanism can comprise a series of fasteners and a plurality of available through holes, wherein the fasteners can be fastened and unfastened to effectuate adjustment of the adjustable appendage support member relative to the guide member. In another example, the adjustment mechanism can comprise an actuatable mechanism configured to impart movement of the adjustable appendage support member to achieve one or more positions of at least one ground contacting appendage corresponding to one or more stances or stance positions. In one aspect, an actuatable adjustment mechanism can be configured to adjust a single ground contacting appendage, or in another aspect, the actuatable adjustment mechanism can be configured to simultaneously adjust two ground contacting appendages.

An “interface” is defined as a connection or contact between a first structural member and a second structural member via one or more interfacing surfaces of each of the first and second structural members. The interface can further include an intervening structural member between a first structural member and a second structural member, with the intervening structural member facilitating communication, coupling, or movement between the first and second structural members and their interfacing surfaces.

An “adjustable bridge” is defined as a mechanism that is adjustable in size in one or more degrees of freedom and that connects a first appendage of the robot to a second appendage of the robot.

A “appendage mounting portion” is defined as a portion of the adjustable appendage support member configured to receive and support a ground contacting appendage, such as a leg appendage of an exoskeleton robotic system.

An “adjustment portion” is defined as a portion of the adjustable appendage support member configured to facilitate movement and adjustment of the adjustable appendage support member relative to the guide member via the adjustment mechanism or by hand.

A “stance” refers to a relative distance between two or more ground contacting appendages of a robotic system about a ground surface. A “stance” can be adjusted via the stance adjustment system, wherein an adjustment of the stance results in any deviation in relative distance from one point on a ground contacting appendage to a similar point on a second ground contacting appendage (e.g., the distance between respective hip joints, knee joints, feet, ankle joints, or others of the two ground contacting appendages).

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter. To further describe the present technology, examples are now provided with reference to the figures.

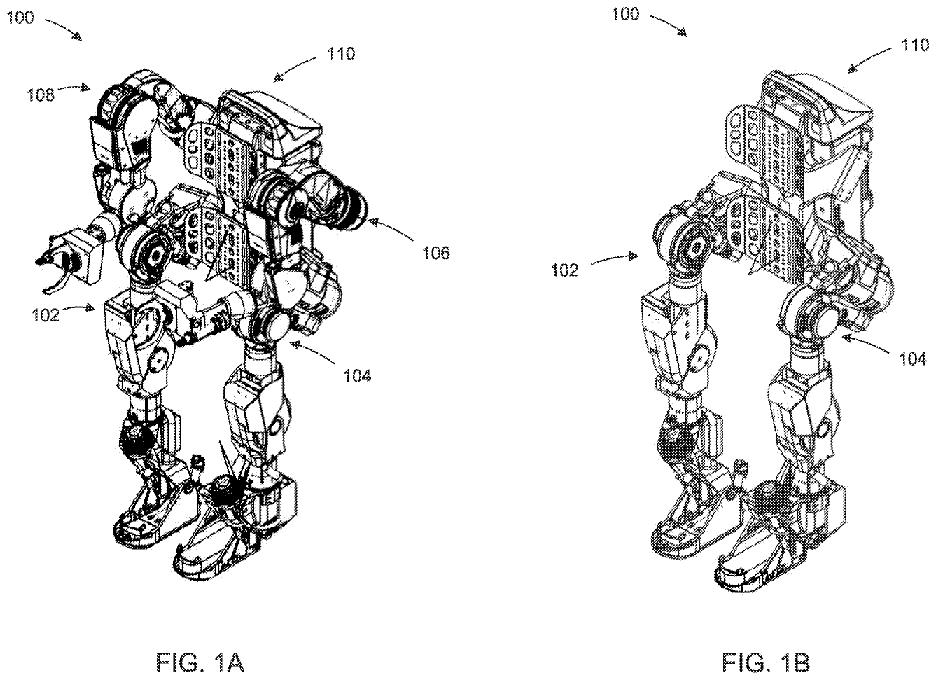

For convenience in discussion, FIG. 1A illustrates an exemplary robot or robotic system in the form of a wearable exoskeleton robotic system 100 that can be donned by a user. The robotic system 100 shown in FIG. 1A is a configuration currently known in the art. The present disclosure describes improvements over the robotic system 100 that allows for accommodating operators of different sizes and dimensions. Although the discussion below is centered around the exoskeleton-type robotic system 100 shown, the disclosure is not intended to be limited to this type of robotic system in any way. Indeed, the hip/stance adjustment technology disclosed herein as part of the robotic system 100 can be implemented in and utilized on other types of robots or robotic systems.

The robotic systems which can utilize the principles and improvements described in this disclosure can be any robotic system, not just the exoskeleton of system 100. For example, in at least one example, the robotic system can be gait-capable, although non-gait-capable robots and exoskeletons are also within the scope of this disclosure. The term “gait-capable” as used herein is intended to refer to one or more types of movements or operations relative to ground that a robot with any number of jointed appendages in contact with the ground (i.e., robotic limbs or legs having a ground contacting portion, such as feet or other ground contacting structures/assemblies) can perform during operation of the robot or robotic system 100. These can include gait-based locomotion movements, capabilities, or operations, such as, but not limited to, walking gait locomotion movements, running gait locomotion movements, crawling movements, and others. These can further include gait-associated movements or operations, such as, but not limited to, jumping, hopping, and others. These can further include stance-associated movements or capabilities or operations, such as, but not limited to, standing (i.e., where the robot is capable of operating in an erect position), squatting, toe stance (i.e., support of the robot with only the forefoot section of a foot), transitioning movements between possible stances for the robot, and others similar to the capabilities of humans as will be apparent to those skilled in the art. The exoskeleton-type robotic system 100 shown is one example of such a gait-capable robot.

In one example, contemplated robots or robotic devices can be any gait-capable robot or robotic device capable of both gait-based movements (i.e., gait movements for locomotion, and gait-associated movements) and stance-associated operations (e.g., standing, squatting, toe stance, and others). In another example, contemplated robots or robotic devices can be any robot capable of only one of these, such as only stance-associated movements or operations, or only gait-based movements.

The hip/stance adjustment technology can be implemented in humanoid robots that are not wearable by a user, non-humanoid robots, or any others that can benefit from the ability to adjust an operating width of ground contacting members, limbs, or appendages (e.g., stance) provided by the hip/stance adjustment technology disclosed herein. More specifically, a robot or robotic device utilizing the adjustable hip/stance technology disclosed in accordance with examples described herein can be an autonomous robot, a tele-operated robot, a wearable exoskeleton, a humanoid robot, a non-humanoid robot, a legged robot, a robot having one or more appendage(s) for facilitating locomotion, a surface-contacting locomotion-capable robot, or any other robot as understood by those of skill in the art. Advantages of such technology are discussed herein, and include the ability to make adjustments in the stance (e.g., relative distance between two or more ground contacting appendages) to improve stability of the robot during operation, such as during locomotion, while standing, etc.

The exemplary exoskeleton-type robotic system 100 shown in FIGS. 1A and 1B is a robotic system without the capability of adjusting a stance of the ground contacting appendages of the robotic system 100. It can be seen that the robotic system 100 can comprise one or more appendages, which in some examples can be jointed appendages, such as a right jointed appendage 102 (e.g., right leg appendage) and a left jointed appendage 104 (e.g., left leg appendage). The left and right jointed appendages 102 and 104 of the robotic system 100 can ground contacting appendages that contact the ground or other ground-like supporting surface to facilitate gait-based locomotion movements, gait-associated movements or operations, stance-based operations, or any combination of these of the robotic system 100. The left and right jointed appendages 102 and 104 can further receive and support a right and left leg of a user who wears the robotic system 100. The appendages, such as the left and right jointed appendages 102 and 104, of a robot, such as the robotic system 100, can be designed based on a human leg with various one or more similar degrees of freedom of movement, wherein the appendages can be configured to operate in a manner similar to a human leg, such as during a gait cycle. The jointed appendages can have one or more joints that correspond to one or more degrees of freedom of a human leg, such as a leg of the user. The joints can correspond approximately to the degrees of freedom such that the joints approximate the movement of a degree of freedom of the human appendage without departing from the present disclosure. Portions of the left and right jointed appendages 102 and 104 of the robotic system 100 can be referred to using common terms used to refer to the features of a human leg.

The robotic system 100 can further comprise additional appendages, such as the left and right jointed appendages 106 and 108. Jointed appendages 106 and 108 can be designed based on a human arm, and can be configured to operate in a manner similar to a human arm having one or more joints corresponding to degrees of freedom of a human arm. The jointed appendages can have one or more joints that correspond to one or more degrees of freedom of a human arm, such as an arm of the user. The joints can correspond approximately to the degrees of freedom such that the joints approximate the movement of a degree of freedom of the human appendage without departing from the present disclosure. Portions of the appendages 106 and 108 of the robotic system 100 can be referred to using common terms used to refer to the features of a human arm.

In the robotic system 100, the appendages 102, 104, 106, and 108 can be mounted to a mounting structure 110. The mounting structure 110 can be considered a spinal structure of the robotic system 100, and can be comprised of one or more supports or support structures capable of supporting appendages of the robotic system 100. In some examples, the mounting structure 110 can be sized and configured as a back rest to provide support to a user operating the robotic system 100, while in other examples, the mounting structure 110 can support a separate back rest component coupled thereto. In some examples, the mounting structure 110 can be sized and configured to support other components and systems of the robotic system 100, such as power systems, hydraulic systems, control systems, batteries, and others used for controlling, powering, and otherwise operating the robotic system 100.

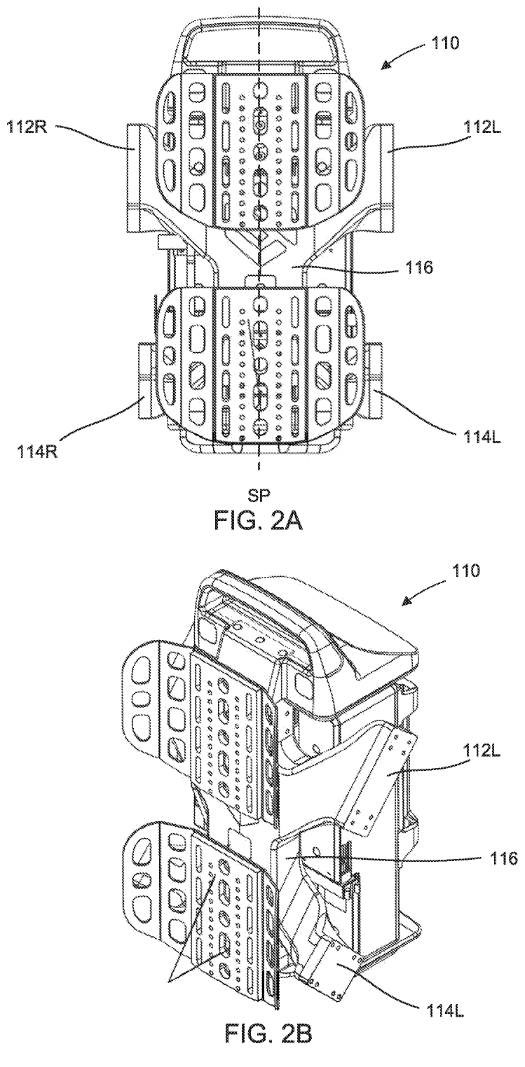

FIG. 1B illustrates an isometric view of the robotic system 100 with the arm appendages 106 and 108 removed from the mounting structure 110 for clarity in illustrating the leg appendages 102 and 104 mounted to the mounting structure 110. The leg appendages 102 and 104 can be mounted to leg mounting portions of the mounting structure 110. Such mounting portions are illustrated in FIG. 2A which shows an exemplary mounting structure 110 in the art, without adjustment capabilities, to which the appendages 102, 104, 106, and 108 can be mounted. As illustrated, the mounting structure 110 can include right and left arm appendage mounting portions 112L and 112R to which the appendages 106 and 108 can be mounted. The mounting structure 110 can further include right and left leg appendage mounting portions 114L and 114R to which the appendages 102 and 104 can be mounted. The mounting portions 112L, 112R, 114L, and 114R can comprise one or more mounting surfaces configured to receive and interface or engage with one or more surfaces on a respective receiving appendage 102, 104, 106, or 108 to be mounted thereto.

In the current state of the art, as shown in FIGS. 2A and 2B, the mounting portions 114L and 114R are fixed in place and have no adjustment capabilities to accommodate different sized users. In other words, the appendage mounting portions 112L, 112R, 114L, and 114R, as illustrated in FIGS. 2A and 2B, are formed integrally with, or rigidly fixed to, a frame mount 116 of the mounting structure 110 and therefore are disposed at fixed, non-adjustable positions. However, in examples in accordance with principles of the present disclosure, the mounting structure 110 can be separate from one or more of the mounting portions configured to receive appendages 102, 104, 106, or 108 such that the mounting portions can be removably coupled to a frame mount similar to frame mount 110. Such a configuration, as will be described below, will allow for the distance between mounting portions and appendages of a robotic system to be adjustable so that users of different sizes (e.g., hip widths) can be accommodated in the exoskeleton. Or, alternatively, the stance (e.g., width between ground contacting appendages including surface of the appendage that contact the ground) of the robot can be adjustable to provide additional stability to a robotic system.

The method and/or mechanism for mounting the appendages to the mounting portions of a robotic system are not particularly described, nor are they intended to be limited in any way by this disclosure. In one example, one or more holes can be formed in the mounting portions for receiving fasteners therein through the appendages to couple the appendages to the mounting portions. However, it will be appreciated that the appendages can be mounted to the mounting portions using any known method (e.g., fasteners inserted through holes in the appendages and corresponding holes in the mounting portions, couplings, other mounting hardware, adhesives, chemical bonding, heat bonding, or any other known methods). The methods, components, or systems for coupling the appendages to the mounting portions are not intended to be limited in any way by this disclosure.

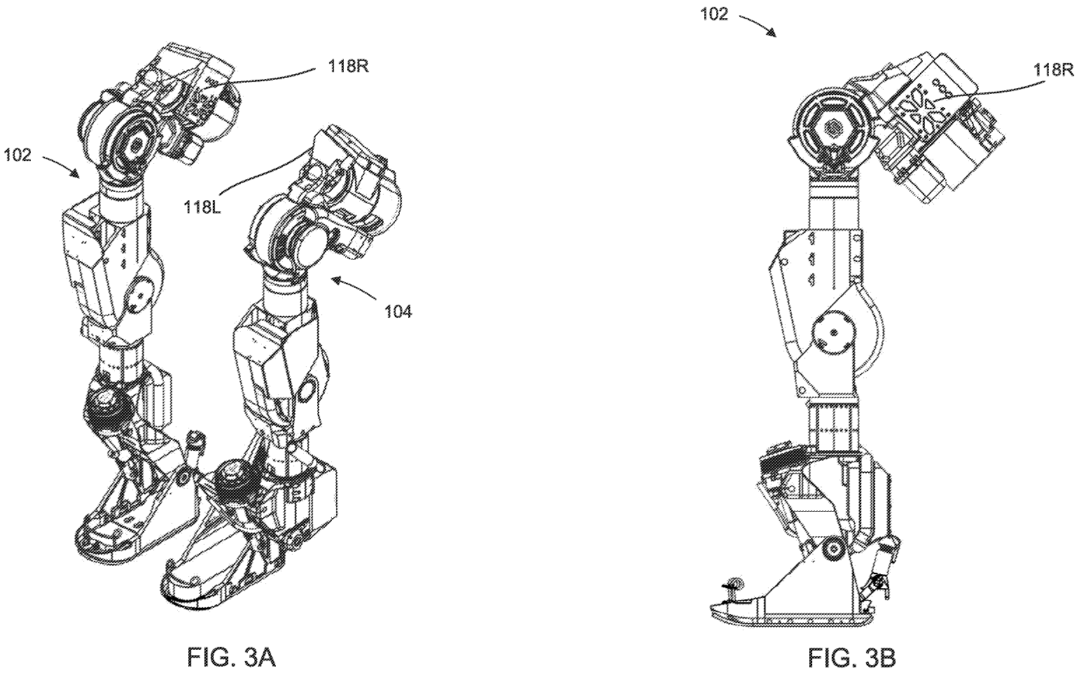

With continued reference to FIGS. 1-2B, FIGS. 3A and 3B illustrate the leg appendages 102 and 104 of the robot 100 separate from any other parts of the robot 100. It is to be understood that leg appendages (e.g., ground contacting appendages) similar to leg appendages 102 and 104 can be coupled to the stance adjustment systems described herein. As illustrated in FIG. 3A, each of the leg appendages 102 and 104 can include a mounting portion (e.g., see mounting portion 118R on leg appendage 102, and mounting portion 118L on leg appendage 104) configured to interface with the mounting portions 114L and 114R of the mounting structure 110, respectively, to mount the leg appendages 102 and 104 to the mounting structure 110. For example, fasteners can be inserted through the mounting portions 114L and 114R of the mounting structure 110 and into the mounting portions 118L and 118R of the appendages 102 and 104 to couple the appendages to the mounting structure 110.

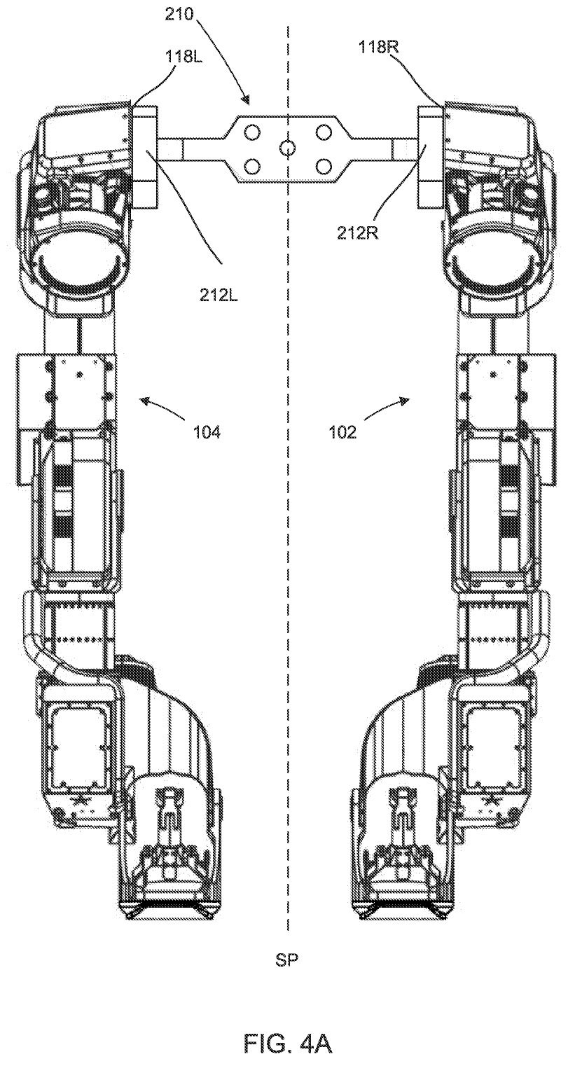

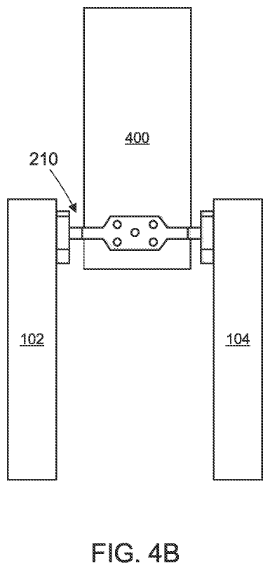

As described above, the mounting structure 110 illustrates mounting portions 112L, 112R, 114L, and 114R that are fixed relative to the frame mount 116 of the mounting structure 110. However, in accordance with the principles of this disclosure, an alternative mounting structure can be used to mount the leg appendages 102 and 104 to a frame mount of a robotic system. FIG. 4A illustrates the leg appendages 102 and 104 mounted to an example stance adjustment system 210. The right and left leg appendages 102 and 104 are shown coupled, respectively, to right and left appendage mounting portions 212R and 212L of the stance adjustment system 210, such as via respective adjustable appendage support members comprising the right and left appendage mounting portions 212R and 212L, as discussed below. The right and left leg appendages 102 and 104 are coupled to the right and left appendage mounting portions 212R and 212L at the interface between the appendage mounting portions 212R, 212L and the mounting portions 118R and 118L of the appendages 102 and 104.

In at least one example of the present disclosure, one or both of the legs 102 and 104 can be mounted to the stance adjustment system 210. In turn, the stance adjustment system 210 can be coupled to a frame mount 400 of the robotic system. The coupling between the stance adjustment system 210 and the frame mount 400 is illustrated in FIG. 4B. The frame mount 400 can be a support structure similar to the mount structure 110 of FIGS. 2A and 2B. The frame mount 400 can act as a support for various elements, components, and systems for a robotic system. For example, the frame mount can be in support of a power system, a control system, a battery system or any other system of the robotic system. The frame mount 400 can similarly act as a support for arm appendages of the robotic system.

The method and/or mechanism for supporting the stance adjustment system 210 with the frame mount 400 can be accomplished in a number of ways, some of which are set forth herein, but which are not intended to be limited in any way. In one example, one or more through holes can be formed in the frame mount 400 for receiving fasteners therein through the stance adjustment system 210 to couple the stance adjustment system 210 to the frame mount 400. However, it will be appreciated that the stance adjustment system 210 can be mounted to the frame mount 400 using any known method or mechanism (e.g., fasteners inserted through holes in the appendages and corresponding holes in the mounting portions, couplings, other mounting hardware, adhesives, chemical bonding, heat bonding, or any other known methods). Again, the methods, components, or systems for coupling the stance adjustment system 210 to the frame mount 400 are not intended to be limited in any way by this disclosure. Furthermore, while FIG. 4B illustrates stance adjustment system 210 mounted to frame mount 400, any of the stance adjustment systems described herein may similarly be mounted to a frame mount 400. The mounting configuration shown in FIG. 4B is not limited to only the stance adjustment system 210.

It will be appreciated that many robotic systems contain both lower exoskeleton/robotic portions and upper body exoskeleton/robotic portions. The lower exoskeleton/robotic portions can receive a lower body of a user or can be a lower body of the robotic system. The upper exoskeleton/robotic portions can receive an upper body of a user or can be an upper body of the robotic system. The frame mount 400 is not limited as being a part of either the upper or lower portions of a robot or exoskeleton. The frame mount 400 can be formed on or coupled to or otherwise part of a lower exoskeleton/robotic portion or an upper exoskeleton/robotic portion. Alternatively, the frame mount can be formed on or can be a connecting structure between upper and lower exoskeleton/robotic portions. In other words, the stance adjustment systems described herein can be coupled to or supported by any portion of a robotic system or exoskeleton without limitation.

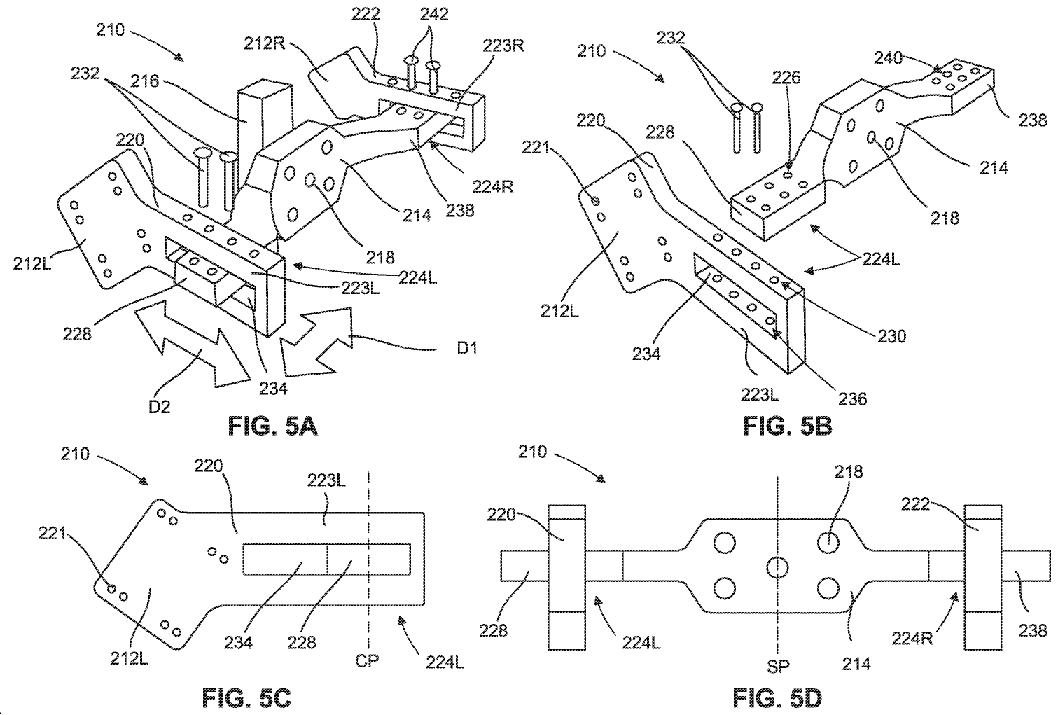

With reference to FIGS. 1-5D, FIG. 5A illustrates an isometric view of the stance adjustment system 210 configured to locate relative to one another respective joints of two appendages of a robot or robotic system, such as the exoskeleton robotic system 100. In the case of the example robotic system 100, the stance adjustment system 210 can also be referred to as a joint width adjustment system as it is operable to adjust the relative distance between respective joints (e.g., the respective hip joints, knee joints, and/or ankle joints) of the leg appendages 102 and 104. Generally speaking, however, the stance adjustment system 210 can comprise a system for facilitating adjustment of at least one of a stance, a stance width, a relative joint width, a robotic appendage position, a relative joint distance, or any other identifying distance between one or more appendages (or one or more points on the one or more appendages) of a robotic system, and/or a distance between one or more appendages (or one or more points on the one or more appendages) of the robotic system and a sagittal plane SP. In this example, the sagittal plane SP of the robotic system 100 (which can also comprise the sagittal plane of a human wearing the exoskeleton) is shown in FIGS. 2A, 4 and 5D. With respect to the robotic system 100, the stance adjustment system 210, as implemented thereon, can be configured to facilitate, at least, adjustment of a width distance of the leg appendages 102, 104 relative to one another along a coronal plane CP (see FIG. 5C) or a plane parallel to the coronal plane, as well as relative to the sagittal plane SP.

The stance adjustment systems described herein (e.g., stance adjustment system 210) can be operable to adjust a stance of the robotic system between a first stance and a second stance, the first stance being representative of a first relative distance between one or more points on a first ground contacting appendage and a second ground contacting appendage and/or a sagittal plane, and the second stance being representative of a second or different relative distance between one or more points on the first ground contacting appendage and the second ground contacting appendage and/or the sagittal plane. The stance adjustment system 210 can comprise a guide member 214 having a first end 228 and a second end 238 opposite to the first end. The guide member 214 can be mounted in a fixed position on and relative to a support structure of the robotic system 100, such as a frame mount 216 of the robotic system. As illustrated in FIG. 5A, the guide member 214 can be removably coupled to the frame mount 216. Of course, this is not intended to be limiting in any way as the robotic system 100 can comprise other support structures or frame mounts to which the guide member 214 can be coupled or integrally formed with. In any case, the guide member 214 is intended to be mounted to, or be an integral part of, a structure (e.g., frame mount 216) of the robotic system 100 that can support, either directly or indirectly, the mounting of the various appendages of the robotic system 100 that are intended to be adjustable relative to one another via the stance adjustment system 210. The guide member 214 can comprise a rigid structure configured to be removably coupled to the frame mount 216 via any know method or mechanism without any limitation intended. For example, as illustrated, one or more holes 218 can be formed in the guide member 214. The holes 218 can each receive a fastener to removably couple the guide member 214 to the frame mount 216. Accordingly, in use, the guide member 214 can remain in a fixed position relative to the frame mount 216.

The stance adjustment system 210 can further include a first adjustable appendage support member 220 and a second adjustable appendage support member 222, each being configured to be adjustably coupled to the guide member 214. The first adjustable appendage support member 220 can include the first appendage mounting portion 212L and the second adjustable appendage support member 222 can include the second appendage mounting portion 212L. Each of the first adjustable appendage support member 220 and the second adjustable appendage support member 222 can be configured to receive and support a ground contacting appendage (e.g., appendage 102 and/or appendage 104 of robotic system 100) thereon. In other words, the appendages 102 and 104 can be mounted to the first adjustable appendage support member 220 and the second adjustable appendage support member 222 at the appendage mounting portions 212L and 212R, respectively. The appendage mounting portions 212L and 212R can have a plurality of holes 221 formed therein to facilitate coupling the appendages 102 and 104 of the robot 100 to the appendage mounting portions 212L and 212R of the first and second adjustable appendage support members 220 and 222, respectively, such as via one or more fasteners.

The first adjustable appendage support member 220 and the second adjustable appendage support member 222 can each include an adjustment portion 223L and 223R that can be adjustably coupled to the respective first and second ends 228 and 238 of the guide member 214 to facilitate adjustment of the first adjustable appendage support member 220 and the second adjustable appendage support member 222 in a lateral and/or medial direction D1 relative to the guide member 214 and the sagittal plane SP. A first adjustment mechanism 224L can be provided, coupled to or formed in the guide member 214 and/or the first adjustable appendage support member 220. The first adjustment mechanism can be operable to facilitate adjustment of the first adjustable appendage support member 220, and the first ground contacting appendage (e.g., 102) attached to the first adjustable appendage support member 220, between a first position and a second position relative to the sagittal plane SP and the guide member 214 of the robotic system 100.

The exemplary first adjustment mechanism 224L is illustrated in FIGS. 5A-5D. The first adjustment mechanism 224L can comprise a plurality of holes 226 formed in the first end 228 of the guide member 214 at a plurality of different distances from the sagittal plane SP. For support of the first adjustable appendage support member 220 in the direction D1, the holes 226 can be formed in the first end 228 of the guide member 214, the guide member 214 being configured to adjustably support the first adjustable appendage support member 220. As in the example illustrated, the holes 226 can be formed in the first end 228 in two rows and three columns to provide stable support for the first adjustable appendage support member 220 and to provide multiple different possible mounting positions in which the first adjustable appendage support member 220 can be coupled to the guide member 214. However, it is to be appreciated that the number and arrangement of the holes in the first end 228 is not intended to be limited and can be in any arrangement and of any number desired to provide the desired support and adjustable positioning for the first adjustable appendage support member 220 on the first end 228 of the guide member 214.

The first adjustment mechanism 224L can further include one or more holes 230 formed in the first adjustable appendage support member 220. The holes 230 can be configured to align with one or more of the plurality of holes 226 formed in the first end 228 of the guide member 214 to mate or couple the first adjustable appendage support member 220 to the first end 228 of the guide member 214 in one of a plurality of available mounting positions provided. The adjustment mechanism 224L can further include one or more fasteners 232 configured to be inserted through the holes 226 of the guide member 214 and the holes 230 and 236 of the first adjustable appendage support member 220 to couple the first adjustable appendage support member 220 to the guide member 214 at a desired position and distance from the sagittal plane SP.

The adjustment mechanism 224L can further include an adjustment interface between the guide member 214 and the first adjustable appendage support member 220, wherein the adjustment interface is configured to facilitate relative movement between the guide member 214 and the first adjustable appendage support member 220 into one of a plurality of mounting positions. In the example shown, the adjustment interface can comprise a slot 234 formed in the first adjustable appendage support member 220 configured to receive the first end 228 of the guide member 214 therein, wherein the first adjustable appendage support member 220 and the guide member 214 are moveable (in this example slidable) relative to one another along one or more axes. The holes 230 can be formed in a portion of the first adjustable appendage support member 220 that defines an upper or first surface of the slot 234, and a second set of holes 236 can be formed in a portion of the first adjustable appendage support member 220 that defines a lower or second surface of the slot 234, wherein the holes 230 and the holes 236 are aligned with one another. Accordingly, when coupling the guide member 214 to the first adjustable appendage support member 220, the guide member 214 and the first adjustable appendage support member 220 can be positioned relative to one another in a desired mounting position by aligning one or more holes of the plurality of holes 230 and 236 of the first adjustable appendage support member 220 with one or more holes of the plurality of holes 226 of the guide member 214. Once the desired mounting position is selected, the fasteners 232 can be caused to enter into a select number of the holes 230 of the first adjustable appendage support member 220, continue through corresponding holes 226 in the first end 228 of the guide member 214 with the first end 228 of the guide member 214 inserted into the slot 234 of the first adjustable appendage support member 220, and then continue through corresponding holes 236 of the first adjustable appendage support member 220. The fasteners 232 can be fastened in place by any known means (e.g., threaded fastener with a bolt, welding, adhesive, or the holes 230, 236, 226 of the adjustable appendage support member and the guide member can be threaded to receive a threaded fastener).

In addition to the first end 228, the guide member 214 can include the second end 238 configured to adjustably support the second adjustable appendage support member 222 thereon. A second adjustment mechanism 224R can be provided, coupled to or formed in the guide member 214 and/or the second adjustable appendage support member 222. The second adjustment mechanism 224R can be operable to facilitate adjustment of the second adjustable appendage support member 222, and the second ground contacting appendage (e.g., 104) attached to the second adjustable appendage support member 222, between a first position and a second position relative to the sagittal plane SP and the guide member 214 of the robotic system 100.

The exemplary second adjustment mechanism 224R is illustrated in FIGS. 5A-5D. Like the first adjustment mechanism 224L, the second adjustment mechanism 224R can include a plurality of holes 240 formed in the second end 238 of the guide member 214 at a plurality of different distances from the sagittal plane SP. For support of the second adjustable appendage support member 222 in the direction D1, the holes 240 can be formed in a second end 238 of the guide member 214, the guide member 214 being configured to adjustably support the second adjustable appendage support member 222. As in the example illustrated, the holes 240 can be formed in the second end 238 in two rows and three columns to provide stable support for the second adjustable appendage support member 222 and to provide multiple different possible mounting positions in which the second adjustable appendage support member 222 can be coupled to the guide member 214. However, it is to be appreciated that the number and arrangement of the holes in the second end 238 is not intended to be limited and can be in any arrangement and of any number desired to provide the desired support and adjustable positioning for the second adjustable appendage support member 222 on the second end 238 of the guide member 214.

Similar to the first adjustment mechanism 224L, the second adjustment mechanism 224R can further include one or more holes 236 formed in the second adjustable appendage support member 222 in similar locations as those holes 230 formed in the first adjustable appendage support member 220. The holes can be configured to align with one or more of the plurality of holes 240 formed in the second end 238 of the guide member 214 to mate or couple the second adjustable appendage support member 222 to the second end 238 of the guide member 214 in one of a plurality of available mounting positions provided. The arrangement and/or number of holes in the second adjustable appendage support member 222 are not intended to be limited by this disclosure in anyway as long as the holes correspond to one or more holes 240 of the second end 238 to facilitate coupling the second adjustable appendage support member 222 to the guide member 214. The adjustment mechanism 224R can further include one or more fasteners 242 configured to be inserted through the holes 240 of the guide member 214 and the first and second set of holes above and below the slot of the second adjustable appendage support member 222, respectively, to couple the second adjustable appendage support member 222 to the guide member 214 at a desired position and distance from the sagittal plane SP.

The second adjustment mechanism 224R, like the first adjustment mechanism 224L, can further include an adjustment interface between the guide member 214 and the second adjustable appendage support member 222, wherein the adjustment interface is configured to facilitate relative movement between the guide member 214 and the second adjustable appendage support member 222 into one of a plurality of mounting positions. As in the example shown, the adjustment interface can comprise a slot formed in the second adjustable appendage support member 222 configured to receive the second end 238 of the guide member 214 therein, wherein the second adjustable appendage support member 222 and the guide member 214 are moveable (in this example slidable) relative to one another along one or more axes. As indicated, two sets of holes can be formed in both portions of the second adjustable appendage support member 222 that are above and below the slot (similar to how the holes are formed in the first adjustable appendage support member 220. Accordingly, when coupling the guide member 214 to the second adjustable appendage support member 222, the guide member 214 and the second adjustable appendage support member 222 can be positioned relative to one another in a desired mounting position by aligning one or more holes of the plurality of holes of the second adjustable appendage support member 222 with one or more holes of the plurality of holes 240 of the guide member 214. Once the desired mounting position is selected, the fasteners 242 can be caused to enter into a select number of the holes of the second adjustable appendage support member 222, continue through corresponding holes 240 in the second end 238 of the guide member 214 with the second end 238 of the guide member 214 inserted into the slot of the second adjustable appendage support member 222, and then continue through corresponding holes of the second adjustable appendage support member 222. The fasteners 242 can be fastened in place by any known means (e.g., threaded fastener with a bolt, welding, adhesive, or the holes of the adjustable appendage support member and the guide member can be threaded to receive a threaded fastener).

In addition to adjustment of the first adjustable appendage support member 220 and the second adjustable appendage support member 222 in the medial/lateral directions D1 relative to (i.e., toward or away from) the sagittal plane SP, the adjustment mechanisms 224L and 224R can facilitate adjustment relative to (i.e., toward or away from) a coronal plane CP of the robotic system 100. Adjustment relative to the coronal plane CP can be in a rearward/forward direction D2. Adjustment in direction D2 can be facilitated by the multiple holes 230, 236 formed in the first adjustable appendage support member 220 at a plurality of different distances relative to the coronal plane CP. For example, aligning different combinations of holes 230, 236 of the first adjustable appendage support member 220 with different holes 226 of the guide member 214 can provide multiple positions and configurations of the first adjustable appendage support member 220 relative to the guide member 214 in medial, lateral, forward, and rearward directions (e.g., in both directions D1 and D2). The same can be true for the second adjustable appendage support member 222.

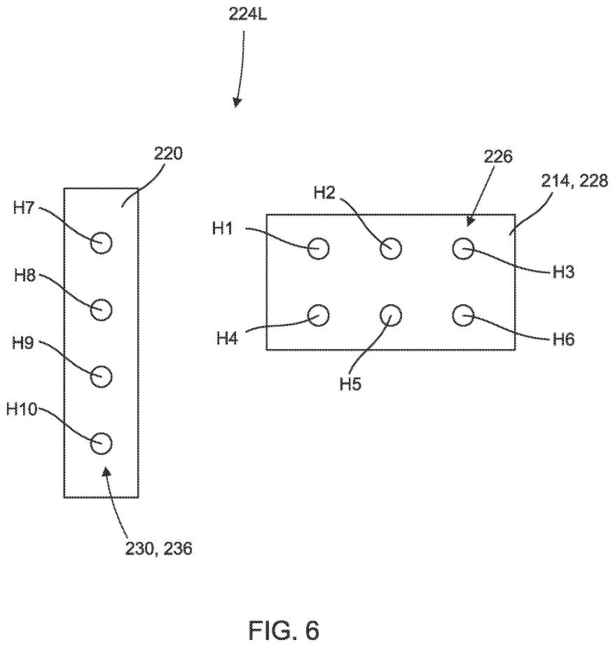

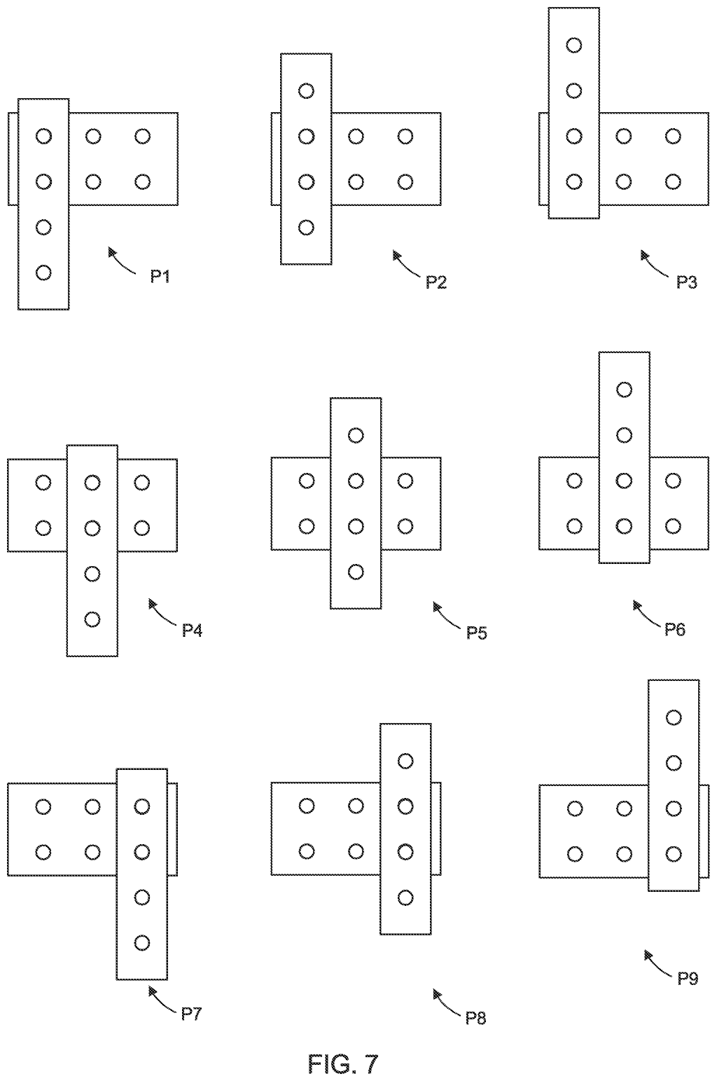

Examples of various combinations of holes and various mounting positions of the first adjustable appendage support member 220 relative to the guide member 214 and the first end 228 are described with respect to FIGS. 6 and 7. With reference to FIGS. 1-7, FIG. 6 illustrates an exemplary configuration and arrangement of representative holes 226 on the first end 228 of guide member 214. FIG. 6 further illustrates an exemplary configuration and arrangement of representative holes 230 and 236 on the first adjustable appendage support member 220. As shown, the first end 228 of guide member 214 can include holes H1, H2, H3, H4, H5, and H6. Holes H1, H2, and H3 can be arranged in a common row and holes H4, H5, and H6 can be arranged in another common row. Holes H1 and H4 can be arranged in a column, holes H2 and H5 can be arranged in a column, and Holes H3 and H6 can be arranged in a column.

The holes H7, H8, H9, and H10 of the first adjustable appendage support member 220 can be arranged in a single column. It will be appreciated that the holes (e.g., H7, H8, H9, and H10) of the first adjustable appendage support member 220 can be aligned with various combinations of the holes H1, H2, H3, H4, H5, and H6 of the guide member 214.

These various combinations can lead to 9 unique mounting positions P1-P9 that are each illustrated in FIG. 7. For example, in position P1, holes H1 and H4 of the guide member 214 can be aligned with holes H7 and H8 of the first adjustable appendage support member 220. In position P2, holes H1 and H4 of the guide member 214 can be aligned with holes H8 and H9 of the first adjustable appendage support member 220. In position P3, holes H1 and H4 of the guide member 214 can be aligned with holes H9 and H10 of the first adjustable appendage support member 220. In position P4, holes H2 and H5 of the guide member 214 can be aligned with holes H7 and H8 of the first adjustable appendage support member 220. In position P5, holes H2 and H5 of the guide member 214 can be aligned with holes H8 and H9 of the first adjustable appendage support member 220. In position P6, holes H2 and H5 of the guide member 214 can be aligned with holes H9 and H10 of the first adjustable appendage support member 220. In position P7, holes H3 and H6 of the guide member 214 can be aligned with holes H7 and H8 of the first adjustable appendage support member 220. In position P8, holes H3 and H6 of the guide member 214 can be aligned with holes H8 and H9 of the first adjustable appendage support member 220. In position P9, holes H3 and H6 of the guide member 214 can be aligned with holes H9 and H10 of the first adjustable appendage support member 220.

It will be appreciated that similar adjustments and positions described with respect to the first adjustable appendage support member 220 can be had with the second adjustable appendage support member 222 using a similar number and arrangement of holes in the second adjustable appendage support member 222 and the guide member 214. It will be additionally appreciated that other configurations, numbers, and arrangements of holes on both the guide member 214 and the adjustable appendage support members 220 and 222 are possible. Indeed, the number and arrangement of holes shown in FIGS. 6 and 7 are not intended to be limiting in any way. Those skilled in the art will recognize that any number and arrangement of holes can be utilized to provide more or less options than are presented in FIGS. 6 and 7. Furthermore, additional hole patterns can be used as long as one or more holes of the plurality of holes of the guide member 214 aligns with one or more holes of the plurality of holes of the adjustable appendage support member.

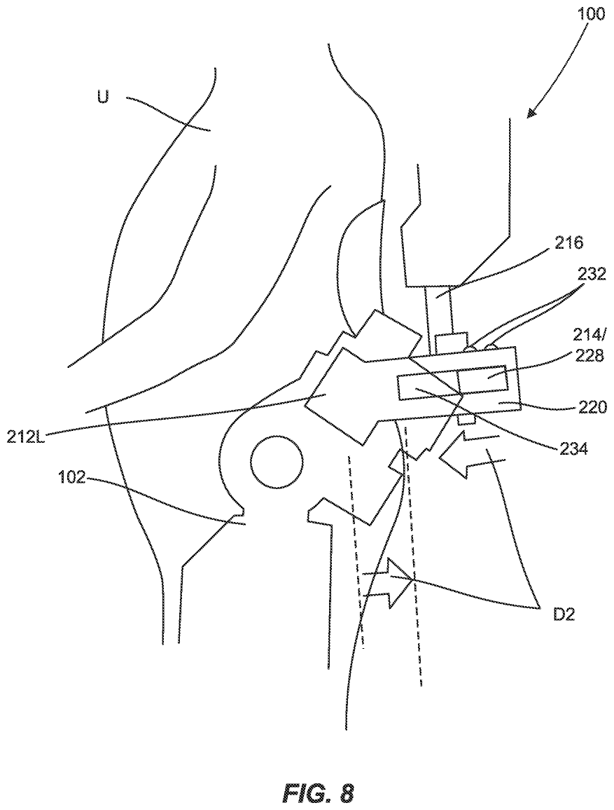

With reference to FIGS. 1-8, adjusting the first and second adjustable appendage support members 220 and 222 operates or functions to adjust positions of the left and right jointed leg appendages 102 and 104 relative to one another, as well as relative to at least one of the sagittal plane SP or the coronal plane CP (either one of these alone, or both of these together, depending upon the configuration of the first and second adjustable appendage support members 220 and 222 and the guide member 214). This adjustment moves the robotic system between a first stance (e.g., initial stance) and a second stance (e.g., subsequent stance) different than the first stance. This adjustment feature further functions to facilitate adjustment of the left and right jointed leg appendages 102 and 104 relative to a user U operating the robotic system 100, thus accommodating users of different size. FIG. 8 illustrates an example of the range of forward to backward adjustment of the first leg appendage 102 achievable by adjustment of the first adjustable appendage support member 220 relative to the guide member 214 and the coronal plane CP of the robotic system. As illustrated the first end 228 of the guide member 214 is received within in the slot 234 formed in the first adjustable appendage support member 220, with the first adjustable appendage support member 220 coupled to the first end 228 of the guide member 214 via fasteners 232. By removal of the fasteners 232, the first adjustable appendage support member 220 can slide along the first end 228 of the guide member 214 to move in a forward/rearward direction D2 relative to the guide member 214 and the coronal plane CP, thereby moving the left jointed leg appendage 102 forward or rearward relative to a frame mount 216 of the robotic system 100, and therefore relative to a body of a user U wearing the robotic system 100.

Although not shown, the first adjustable appendage support member 220 can be adjustable side to side in a lateral direction relative to the guide member 214 and the sagittal plane SP between first and second positions (not shown, but see FIGS. 4A-7), as discussed above. Of course, although not shown, the second adjustable appendage support member 222 can be adjustable at least one of forward to backward or side to side relative to the guide member 214 and at least one of the sagittal or coronal planes to adjust the right jointed leg appendage 104 relative to the user U in the same or a similar manner as for the left jointed leg appendage 102.

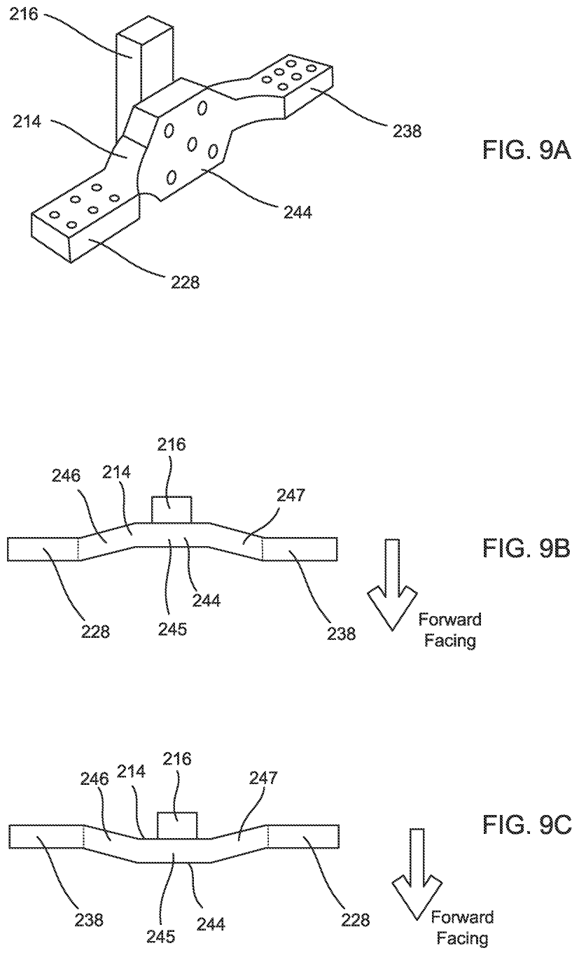

Additional adjustment of the first adjustable appendage support member 220 and the second adjustable appendage support member 222 (and hence the left and right jointed leg appendages 102 and 104) can be made relative to the coronal plane CP in a rearward/forward direction D2 by configuring the guide member 214 to comprise a unique central portion. For example, as illustrated in FIG. 9A, the guide member 214 can comprise a central portion 244. The first and second ends 228 and 238 of the guide member 214 can be supported by and extend from the central portion 244. Specifically, the central portion 244 can comprise first and second extension portions 246 and 247 that extend outward and away from a base portion 245, wherein distal ends (i.e., ends furthest from the base portion) of the first and second extension portions 246 and 247 terminate in a plane offset from a plane of a surface of the base portion 245, such as the surface of the base portion 245 that is interfaced with the frame mount 216, or from a surface of the frame mount 216 itself. The first and second ends 228 and 238 of the guide member 214 can be configured to extend from the distal ends of the first and second extension portions 246 and 247, respectively. In the example shown, the central portion 244 comprises a V-shape, although this is not intended to be limiting in any way. In one example mounting arrangement, the base portion 245 of the central portion 244 of the guide member 214 can be coupled to the frame mount 216 in a forward oriented configuration, such that the first and second ends 228 and 238 of the guide member 214 are supported in a plane offset at a forward location from the frame mount 216 (see FIG. 9B), thereby providing a first adjustment position for the first and second ends 228 and 238 of the guide member, the adjustable appendage support members 220 and 222, and therefore the left and right appendages 102 and 104 mounted thereto relative to the coronal plane CP of the robotic system 100 and a user operating the robotic system 100.

Alternatively, the central portion 244 of the guide member 214 can be coupled to the frame mount 216 in a rearward oriented configuration, such that the first and second ends 228 and 238 of the guide member 214 are supported in a plane offset at a rearward location from the frame mount 216 (see FIG. 9C), thereby providing a second adjustment position for the first and second ends 228 and 238 of the guide member 2145, the adjustable appendage support members 220 and 222, and therefore the left and right appendages 102 and 104 mounted thereto relative to the coronal plane CP of the robotic system 100. A user can, therefore, install the guide member 214 on the frame mount 216 in such a way that additional front to back adjustment is possible depending on the size and shape of the user, or the needs and purpose to be achieved with the robot.

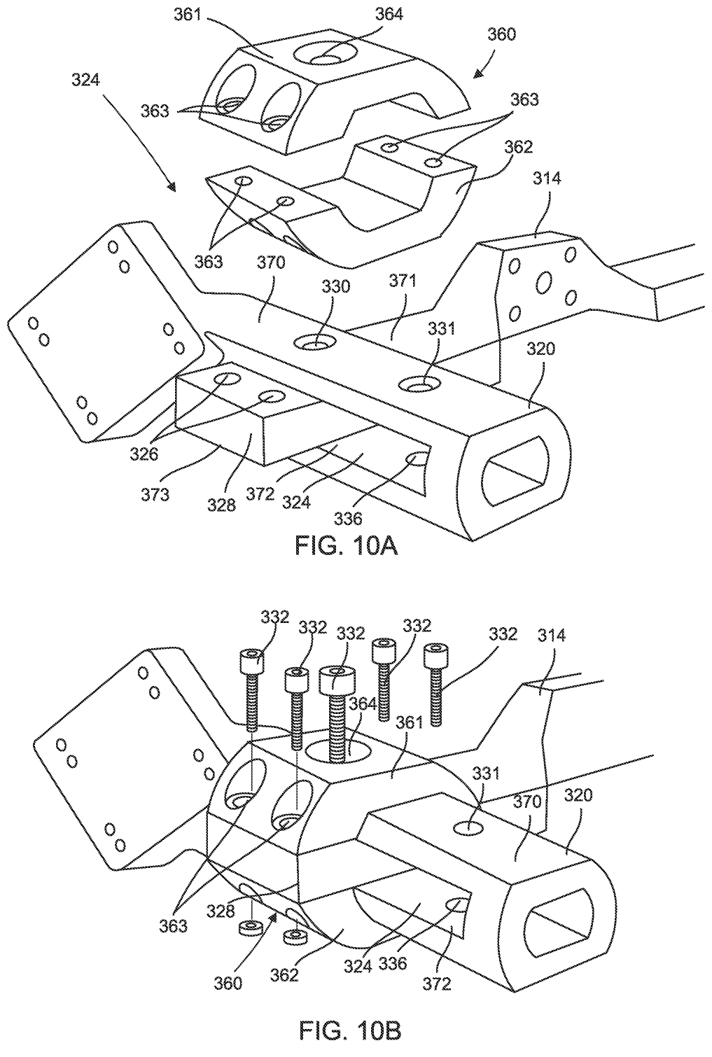

In an additional example, with reference to FIG. 10, the adjustable appendage support member(s) 320 can be coupled to the guide member 314 with a support clamp 360 of the adjustment mechanism 324 to provide extra support and stabilization for the adjustable appendage support member 320 on the guide member 314. In the example illustrated in FIG. 10A, a guide member 314 is moveable within a slot 324 of an adjustable appendage support member 320. As described in other examples, the adjustable appendage support member 320 can include one or more holes 330, 331, 336 formed therein. Likewise, the guide member 314 can include one or more holes 326 and 327 formed in an end 328 thereof to correspond with the holes 330, 331, 336 of the adjustable appendage support member 320.

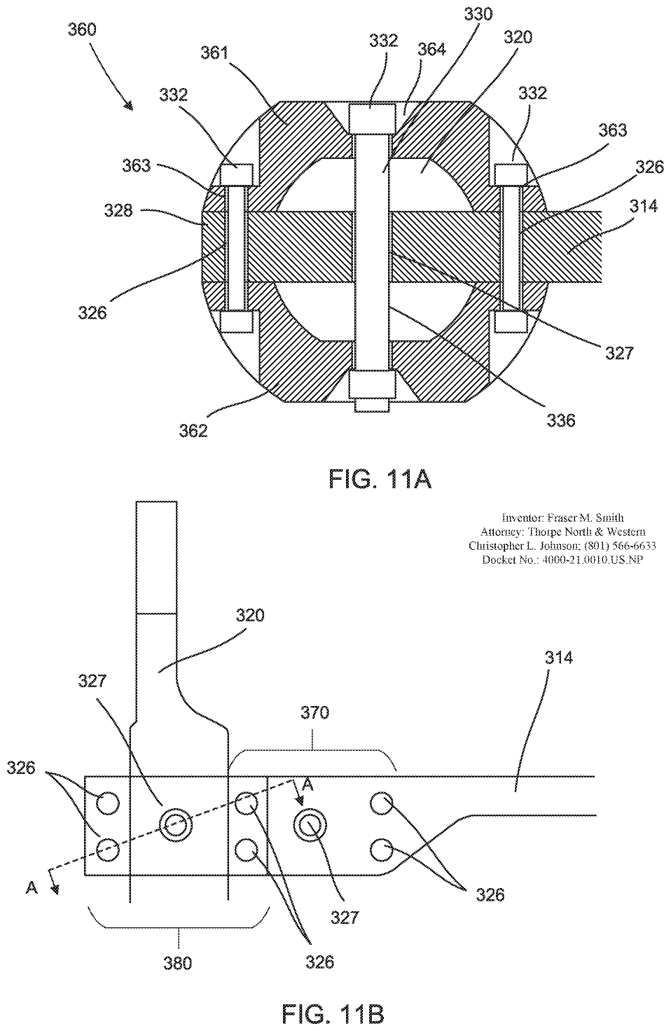

The adjustment mechanism in the example illustrated in FIG. 10A can comprise a support clamp 360 having both an upper body 361 and a lower body 362. The upper body 361 can be configured to fix an upper portion 370 of the first adjustable appendage support member to an upper portion 371 of the first end 328 of the guide member 314, each having one or more holes 363 and 364 formed therein. The lower body 362 can be configured to fix a lower portion 372 of the first adjustable appendage support member to a lower portion 373 of the first end 328 of the guide member 314, each having one or more holes 363 and 364 formed therein. The holes 363 can be formed to align with one or more of the plurality of holes 326 formed in the guide member 314. The holes 364 can be formed to align with the one or more of the holes 330, 331, 336 formed in the adjustable appendage support member 320. The support clamp 360 can be configured to clamp the adjustable appendage support member 320 to the guide member 314 by insertion of one or more fasteners 332 into the one or more holes 363, 364 of the support clamp 360 aligned with one or more holes 363 of the guide member 314 and one or more holes 330, 331, 336 of the adjustable appendage support member 320. In FIG. 10B, the support clamp 360 is shown supporting the guide member 314 and the adjustable appendage support member 320 in a coupled configuration. The one or more fasteners 332 can be inserted into the various holes 326, 330, 331, 336, 363, and/or 364 of the support clamp 360, adjustable appendage support member 314, and the guide member 320 in order to secure the adjustable appendage support member 320 and the guide member 314 together. FIG. 11A illustrates a cross-sectional view of the support clamp 360 coupled to the adjustable appendage support member 320 and the guide member 314, with the fasteners 332 disposed in the holes of each of the components. The cross-sectional view of FIG. 11A is taken along line AA shown in FIG. 11B.

The support clamp 360 can support the adjustable appendage support member 320 on the guide member 314 at a plurality of distances relative to a sagittal plane SP of the robot and at a plurality of distances relative to a coronal plane CP of the robot. As shown in FIG. 11B, the support clamp 360 can couple the adjustable appendage support member 320 to the guide member 314 in at least a medial position 370 and a lateral position 380 relative to the sagittal plane SP. Similarly, the adjustable appendage support member 320 can be adjusted relative to the coronal plane by being coupled to the guide member 314 using a rearward hole 331 formed in the adjustable appendage support member 320 that corresponds to a rearward position, or by being coupled to the guide member 314 using a forward hole 330 formed in the adjustable appendage support member 320 that corresponds to a forward position (or using a plurality of holes that provide different coronal adjustments). It is to be understood that any number of forward, rearward, medial, or lateral positions are possible by adding additional holes in additional positions to the guide member 314 and the adjustable appendage support member 320. Additionally, different numbers and arrangements of holes are possible in any possible configuration without limitation.

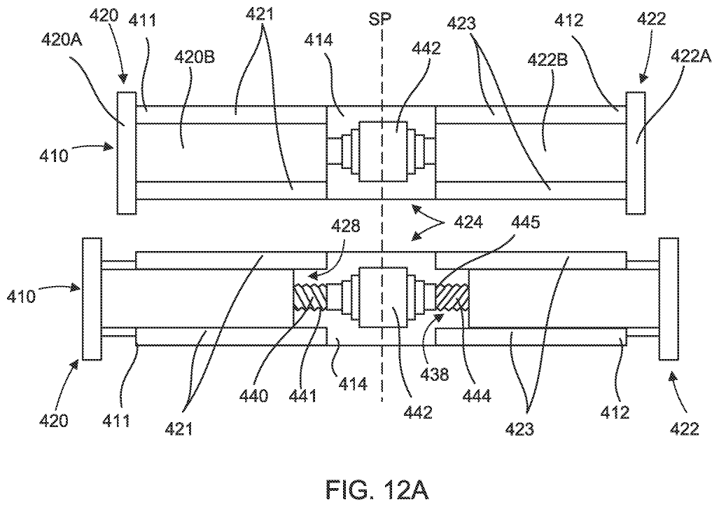

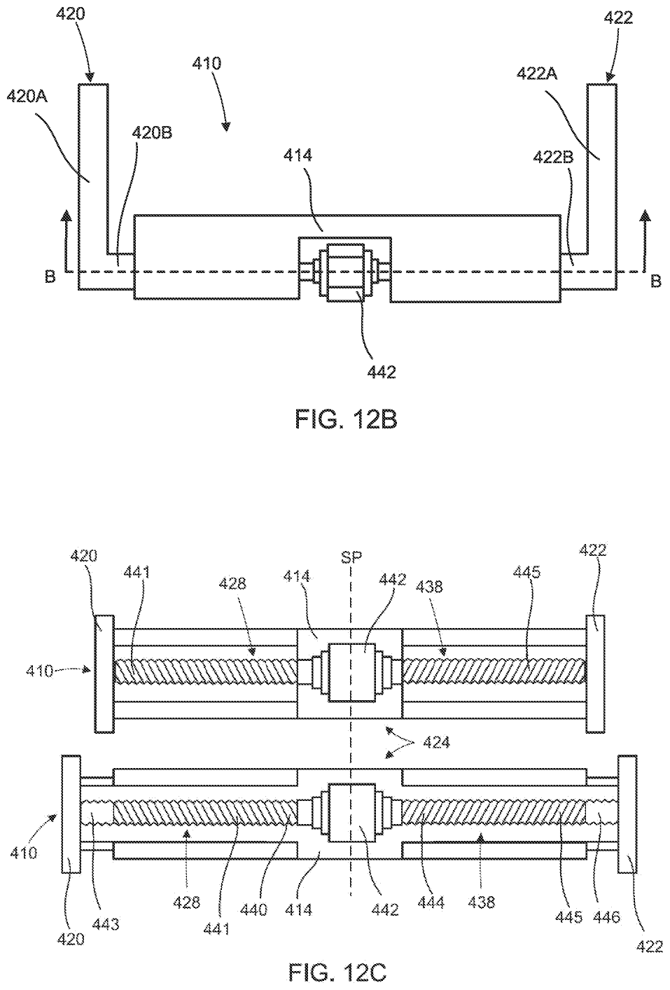

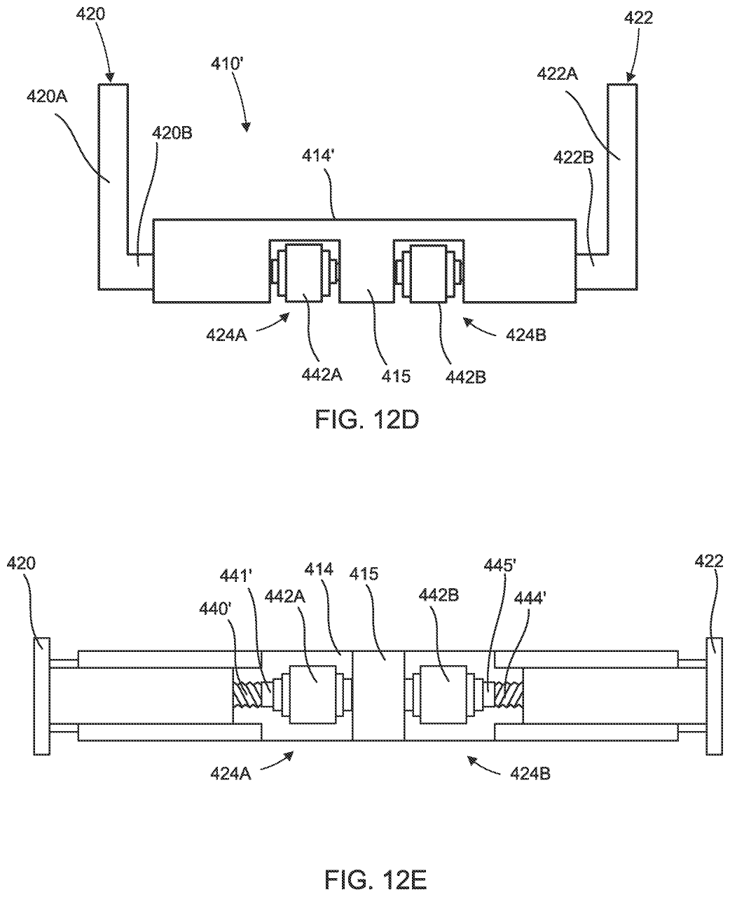

FIGS. 12A-12C illustrate a stance adjustment system 410 in accordance with another example of the present disclosure. FIG. 12A illustrates the stance adjustment system 410 in both a retracted position associated with a first stance of a robotic system (upper portion of FIG. 12A) and an extended position associated with a second stance of the robotic system (lower portion of FIG. 12A). The stance adjustment system 410 can be operable to adjust a stance of a robotic system between a first stance and a second stance of the robotic system.

The stance adjustment system 410 can include a guide member 414 having a first end 411 and a second end 412 opposite to the first end 411. The guide member 414 can be fixed relative to a robotic system (e.g., fixed to a frame mount or other member of the robotic system or can serve as the frame mount for other parts of the robot). The stance adjustment system 410 can further include a first adjustable appendage support member 420 including a first appendage mounting portion 420A to which the first ground contacting appendage is mounted and an adjustment portion 420B adjustably coupled to the first end 411 of the guide member 414. The stance adjustment system 410 can further include a second adjustable appendage support member 422 including a second appendage mounting portion 422A to which the second ground contacting appendage is mounted and an adjustment portion 422B adjustably coupled to the second end 412 of the guide member 414.

As illustrated in FIGS. 12A and 12C, the guide member 414 can include first guide rails 421 formed on the first end 411 of the guide member 414. The first guide rails 421 can receive at least a part of the adjustment portion 420B of the first adjustable appendage support member 420 and can slideably support at least a portion of the first adjustable appendage support member 420 to constrain motion of the first adjustable appendage support member 420 to medial or lateral directions within the guide member 414. Similarly, the guide member 414 can include second guide rails 423 formed on the second end 412 of the guide member 414. The second guide rails 423 can receive at least a part of the adjustment portion 422B of the second adjustable appendage support member 422 and can slideably support at least a portion of the second adjustable appendage support member 422 to constrain motion of the second adjustable appendage support member 422 to medial or lateral directions within the guide member 414. The first and second adjustable appendage support members 420 and 422 can be configured to adjust position and slide along the left and right guide rails 421 and 423 in response to operation of an adjustment mechanism 424.

The adjustment mechanism 424 of the stance adjustment system 410 can be operated to adjust the first adjustable appendage support member 420 between a first position (e.g., the retracted position relative to the guide member 414 shown in the upper portion of FIG. 12A) and a second position (e.g., the extended position relative to the guide member 414 shown in the lower portion of FIG. 12A). The adjustment mechanism 424 can further be operated to adjust the second adjustable appendage support member 422 between a first position (e.g., the retracted position relative to the guide member 414 and the sagittal plane shown in the upper portion of FIG. 12A) and a second position (e.g., the extended position relative to the guide member 414 and sagittal plane SP shown in FIGS. 12A and 12C).

Adjusting position of the first and second adjustable appendage support members 420 and 422 also changes positions of first and second ground contacting appendages fixed to the first and second adjustable appendage support members 420 and 422 and the stance of the these, which can be for a variety of purposes as discussed herein (e.g., to enhance stability of the robotic system, or to accommodate and more comfortably fit different users of different sizes if the robotic system is an exoskeleton, or others). Indeed, the adjustment mechanism 424, by adjusting the positions of the first and second adjustable appendage support members 420 and 422 and appendages between the first and second positions, can be operable to adjust a stance of the robotic system from a first stance to a second stance. The first and second stances can comprise different distances of the first ground contacting appendage and the second ground contacting appendage about the ground surface relative to the sagittal plane of the robotic system.

Further description of the adjustment mechanism 424 will be made with reference to FIGS. 12B and 12C. FIG. 12B illustrates a top view of the stance adjustment system 410. FIG. 12C illustrates a cross-sectional view of the stance adjustment system 410 taken along line BB shown in FIG. 12B. FIG. 12C illustrates the stance adjustment system 410 in both a retracted position associated with a first stance of a robotic system (see upper portion of FIG. 12C) and an extended position associated with a second stance of the robotic system (see lower portion of FIG. 12C).

As shown in FIGS. 12A-12C, the adjustment mechanism 424 can further comprise an actuator 442 that is operable to adjust the first adjustable appendage support member 420 between the first position and the second position to thereby adjust the stance of the robotic system between the first stance and the second stance. The actuator 442 can also be operable to adjust the second adjustable appendage support member 422 between the first position and the second position to thereby adjust the stance of the robotic system between the first stance and the second stance. By operation of the actuator 442, the first adjustable appendage support member 420 can extend or retract relative to the guide member 414 and the sagittal plane SP. Simultaneously, or alternatively, operation of the actuator 442 can extend or retract the second adjustable appendage support member 422 relative to the guide member 414 and the sagittal plane SP.

The adjustment mechanism 424 can be coupled to the first and second adjustable appendage support members 420 and 422. More specifically, the adjustment mechanism 424 can be coupled to the adjustment portions 420B and 422B of the first and second adjustable appendage support members 420 and 422. The adjustment mechanism 424 can include a first interface 428 at which the first adjustable appendage support member 420 adjustably couples to the adjustment mechanism 424. The adjustment mechanism 424 can further include a second interface 438 at which the second adjustable appendage support member 422 adjustably couples to the adjustment mechanism 424. At the first interface 428, the first adjustable appendage support member 420 can include a threaded hole 443 defined in the adjustment portion 420B of the first adjustable appendage support member 420. The adjustment mechanism 424 can include a first elongated rod 441 coupled to the actuator 442 and having a threaded surface 440 formed thereon. The threaded surface 440 of the first elongated rod 441 can be configured to engage with the threaded hole 443 of the adjustment portion 420B first adjustable appendage support member 420.

At the second interface 438, the second adjustable appendage support member 422 can include a threaded hole 446 defined in the adjustment portion 422B of the second adjustable appendage support member 422. The adjustment mechanism 424 can include a second elongated rod 445 coupled to the actuator 442 and having a threaded surface 444 formed thereon. The threaded surface 444 of the second elongated rod 445 can be configured to engage with the threaded hole 446 of the adjustment portion 422B of the second adjustable appendage support member 422. Adjustment of the positions of the first and second adjustable appendage support members 420 and 422 can be accomplished by rotation of the actuator 442 to cause the first and second adjustable appendage support members 420 and 422 translate along the first and second elongated rods 441 and 445 by engagement of the threads of threaded holes 443 and 446 with the threaded surfaces 440 and 444.

In the configuration shown in FIGS. 12A-12C, in which both the first and second adjustable appendage support members 420 and 422 are simultaneously adjustable by actuation of a single actuator 442, the adjustment mechanism 424 can alternatively be referred to as an adjustable bridge that connects the first ground contacting appendage 102 to the second ground contacting appendage 104 via the first and second adjustable appendage support members 420 and 422. The adjustable bridge/mechanism 424 can be operable to facilitate adjustment of the first and second adjustable appendage support members 420 and 422 and the first and second ground contacting appendages 102 and 104. With the adjustable bridge/mechanism 424, the actuator 442 can be operable to simultaneously adjust the second adjustable appendage support member 422 and the first adjustable appendage support member 420. The first adjustable appendage support member 422 can be adjusted between a first position and a second position of the first adjustable appendage support member 422 relative to the sagittal plane SP of the robotic system, the first position and the second position of the first adjustable appendage support member 420 being respectively associated with the first stance and the second stance. The second adjustable appendage support member 422 can also, and at the same time, be adjusted between a first position and a second position of the second adjustable appendage support member 422 relative a sagittal plane SP of the robotic system, the first position and the second position of the second adjustable appendage support member 422 being respectively associated with the first stance and the second stance.

As further illustrated in FIGS. 12A-12C, the actuator 442 can be operable to move first and second elongated rods 441 and 445 to adjust the first and second adjustable appendage support members 420 and 422 by a same amount relative to the sagittal plane. For example, rotation of the actuator 442 can move both the first and second adjustable appendage support members 420 and 422 away from or toward the sagittal plane SP by a substantially equal or equal amount. In other words, actuation of the actuator 442 can move the first adjustable appendage support member 420 a distance x away from or toward the sagittal plane SP and can also move the second adjustable appendage support member 422 the same distance x away from or toward the sagittal plane SP. In such a configuration, positions of the first and second adjustable appendage support members 420 and 422, whether before, during, or after adjustment, remain symmetrical about the sagittal plane SP. Accordingly, in their respective first positions, in their respective second positions, in positions other than the first and second positions, and in both a first or second stance of the robot, the first and second adjustable appendage support members 420 and 422 can be maintained symmetrical about the sagittal plane SP.

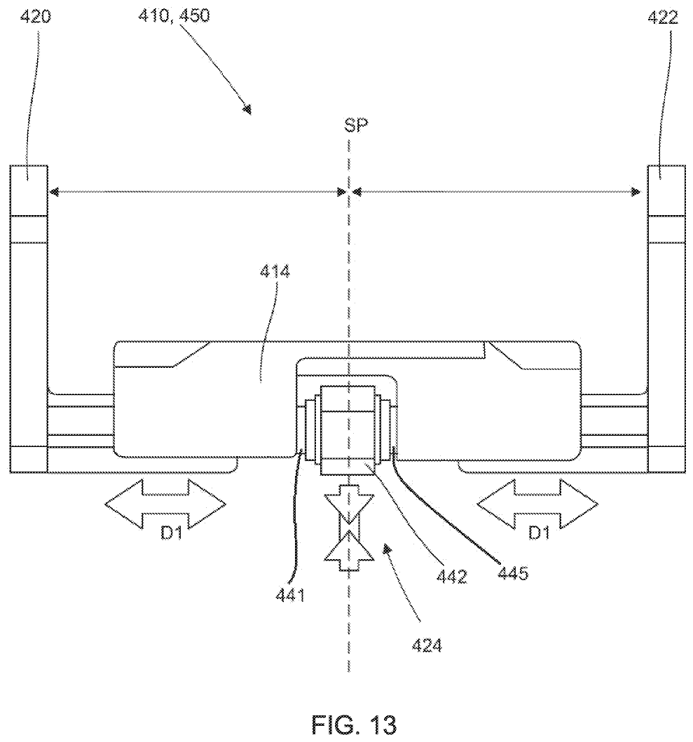

The actuator 442 can be operated by a user or a motor to rotate. Rotation of the actuator 442 in a clockwise (e.g., first direction) or counter-clockwise direction (e.g., second direction), as shown in FIG. 13, can cause rotation of the first elongated rod 441 and the second elongated rod 445. Rotation of the first and second elongated rods 441 and 445 can cause the first adjustable appendage support member 420 to translate along the first elongated rod 441 and the second adjustable appendage support member 422 to translate along the second elongated rod 445 in medial or lateral directions D1 to adjust a distance between the first ground contacting appendage 102 and the second ground contacting appendage 104, or a distance of either of these relative to the sagittal plane SP.

Rotation of the actuator 442 in a first direction (e.g., clockwise) can causes the first adjustable appendage support member 420 and the second adjustable appendage support member 422 to adjust away from the sagittal plane SP, thereby increasing a distance between the first ground contacting appendage and the second ground contacting appendage to adjust the stance of the robotic system between the first stance and the second stance. Rotation of the actuator 442 in a second direction (e.g., counter clockwise) different than the first direction can cause the first adjustable appendage support member 420 and the second adjustable appendage support member 422 to adjust away from the sagittal plane, thereby increasing a distance between the first ground contacting appendage and the second ground contacting appendage to adjust the stance of the robotic system between the first stance and the second stance.

The threaded surfaces 440 and 444 can be formed with any desired thread configuration (e.g., pitch, direction, etc.) on the elongated rods 441 and 445. However, it will be advantageous to form the first and second threaded surfaces 440 and 444 with opposite direction threads from each other, as shown in FIG. 12B, such that rotation of the actuator 442 in a first direction causes the first adjustable appendage support member 420 to separate from the second adjustable appendage support member 422, thereby increasing a distance between first and second ground contacting appendages 102 and 104. Furthermore, rotation of the actuator 442 in a second direction causes the first adjustable appendage support member 420 to move closer to the second adjustable appendage support member 422, thereby decreasing a distance between first and second ground contacting appendages 102 and 104. Accordingly, forming the threaded surfaces 440 and 444 to have opposite thread directions allows the adjustable bridge to be operable to move and adjust a distance between both of the adjustable appendage support members 420 and 422 with just a single motion or actuation of the actuator 442. Thus, the adjustable bridge according to the present disclosure can facilitate single handed and single user adjustment of a relative distance between the ground contacting appendages of a robotic system 100 (e.g., to accommodate multiple different sizes of users of an exoskeleton therein).

Furthermore, those skilled in the art will recognize that the threaded configurations shown in FIGS. 12A-17B allow for theoretically infinite adjustment positions achievable for the appendages within the range of movement of the adjustable appendage support members, and, therefore, provides for a theoretically infinite number of stances and hip width adjustments for the robot. The configuration further allows for accommodating a theoretically infinite amount of hip widths for users wearing an exoskeleton with the shown configuration. Additionally, the threaded configuration allows the adjustable appendage support members to remain stable at a desired position and to essentially be locked at the desired position while the actuator is not being turned.

It will be appreciated that, in alternative examples, each of the first and second adjustable appendage support members 420 and 422 can be actuated separately using separate first and second adjustment mechanisms 424A and 424B. For example, as shown in FIGS. 12D and 12E, a stance adjustment system 410′ can include first and second adjustment mechanisms 424A and 424B respectively having first and second actuators 442A and 442B, each supported by guide member 414′ and engaged with first and second adjustable appendage support members 420 and 422. In other words, each of the first and second adjustable appendage support members 420 and 422 can be associated with separate individual first and second adjustment mechanisms 424A and 424B that respectively adjust one of the first and second adjustable appendage support members 420 and 422 individually. Furthermore, each of the first and second adjustable appendage support members 420 and 422 can be moved or positioned by actuation of respective first and second actuators 442A and 442B that are each separately operable to respectively adjust the position of the first and second adjustable appendage support members 420 and 422 and associated ground contacting appendages relative to the guide member to adjust the stance of the robotic system relative to the sagittal plane between the first stance and the second stance.

To facilitate separate movement of the individual first and second adjustable appendage support members 420 and 422, the first and second adjustment mechanisms 424A and 424B can include the following elements. The first adjustment mechanism 424A can be coupled to the first adjustable appendage support member 420. More specifically, the adjustment mechanism 424A can be coupled to the adjustment portion 420B of the first adjustable appendage support member 420. The first adjustment mechanism 424A can include an interface at which the first adjustable appendage support member 420 adjustably couples to the first adjustment mechanism 424A. Similar to as illustrated in FIGS. 12A-12C, at the interface the first adjustable appendage support member 420 can include a threaded hole 443 defined in the adjustment portion 420B of the first adjustable appendage support member 420. The first adjustment mechanism 424A can include a first elongated rod 441′ coupled to the first actuator 442A and having a threaded surface 440′ formed thereon. The threaded surface 440′ of the first elongated rod 441′ can be configured to engage with the threaded hole 443 of the adjustment portion 420B of the first adjustable appendage support member 420.

The second adjustment mechanism 424B can be coupled to the second adjustable appendage support member 422. More specifically, the second adjustment mechanism 424B can be coupled to the adjustment portion 422B of the second adjustable appendage support member 422. The second adjustment mechanism 424B can include an interface at which the second adjustable appendage support member 422 adjustably couples to the second adjustment mechanism 424B. Similar to as illustrated in FIGS. 12A-12C, at the interface the second adjustable appendage support member 422 can include a threaded hole 446 defined in the adjustment portion 422B of the second adjustable appendage support member 422. The second adjustment mechanism 424B can include a second elongated rod 445′ coupled to the second actuator 442B and having a threaded surface 444′ formed thereon. The threaded surface 444′ of the second elongated rod 445′ can be configured to engage with the threaded hole 446 of the adjustment portion 422B of the second adjustable appendage support member 422.

Adjustment of the positions of the first and second adjustable appendage support members 420 and 422 can be accomplished separately by separate rotation of the actuators 442A and 442B to cause the first and second adjustable appendage support members 420 and 422 to translate along the first and second elongated rods 441′ and 445′ by engagement of the threads of threaded holes 443 and 446 with the threaded surfaces 440′ and 444′. Each of the actuators 442A and 442B can be supported by the guide member 414′ separately to allow individual turning and adjustment of the actuators 442A and 442B. For example, each of the actuators 442A and 442B can be separate from each other and supported about a center support 415 of the guide member 414′. The actuators 442A and 442B are not connected to each other but are supported by the center support 415 so that turning of one actuator does not affect the state or position of the other actuator.

Each of the first and second actuators 442A and 442B can be operated by a user or a motor to rotate. Rotation of one or more of the actuators 442A and 442B in a clockwise (e.g., first direction) or counter-clockwise direction (e.g., second direction), can cause rotation of the first elongated rod 441′ and/or the second elongated rod 445′. Rotation of the first and/or second elongated rods 441′ and 445′ can cause the first adjustable appendage support member 420 to translate along the first elongated rod 441′ and/or the second adjustable appendage support member 422 to translate along the second elongated rod 445′ in medial or lateral directions to adjust a distance between the first ground contacting appendage 102 and the second ground contacting appendage 104.

Individual rotation of one or more of the first and second actuators 442A, 442B in a first direction (e.g., clockwise) can cause the first adjustable appendage support member 420 and the second adjustable appendage support member 422 to individually adjust away from the sagittal plane, thereby increasing a distance between the first ground contacting appendage and the second ground contacting appendage to adjust the stance of the robotic system between the first stance and the second stance. Individual rotation of one or more of the first and second actuators 442A, 442B in a second direction (e.g., counter clockwise) different than the first direction can cause the first adjustable appendage support member 420 and the second adjustable appendage support member 422 to individually adjust toward the sagittal plane, thereby increasing a distance between the first ground contacting appendage and the second ground contacting appendage to adjust the stance of the robotic system between the first stance and the second stance. The rotation directions for extension and retraction of the respective adjustable appendage support members relative to the sagittal plane SP can be the same or different for the different actuators 442A and 442B.

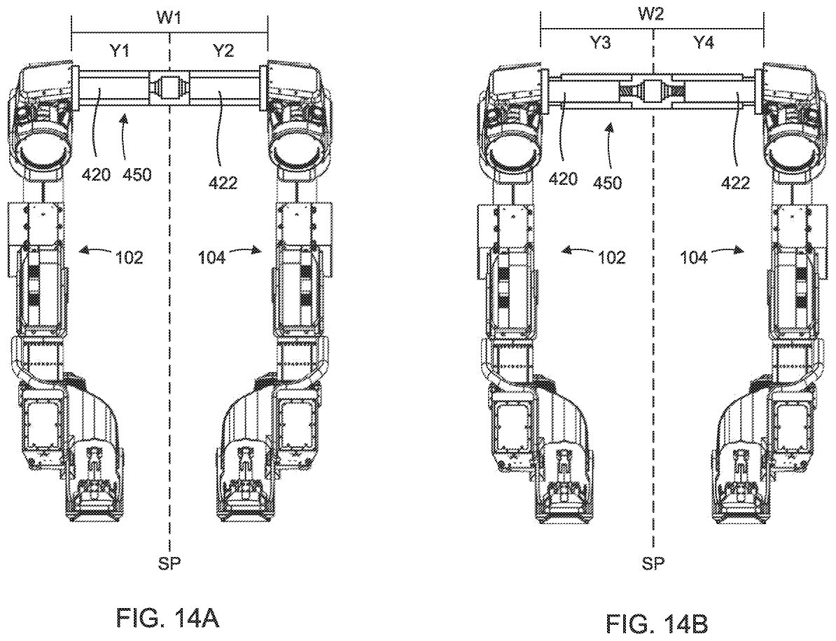

An example of adjusting the stance (e.g. distances of the appendages 102 and 104 from each other, distances between adjustable appendage support members 420 and 422, and/or distances of the adjustable appendage support members 420 and 422 and ground contacting appendages 102 and 104 from the sagittal plane SP) is illustrated in FIGS. 14A and 14B. FIG. 14A illustrates a rear view of appendages 102 and 104 connected to each other by the adjustable bridge. In FIG. 14A, the adjustable bridge is in a state in which the first adjustable appendage support member 420 and the second adjustable appendage support member 422 are in a fully retracted position relative to the sagittal plane SP. In the retracted state, the distance between the appendages 102 and 104 is W1 and the distances of the first adjustable appendage support member 420 and the second adjustable appendage support member 422 from the sagittal plane SP are indicated by Y1 and Y2. The positions of the first and second adjustable appendage support members 420 and 422 at distances Y1 and Y2 can be referred to as the first positions of the first and second adjustable appendage support members 420 and 422, the first positions being associated with a first stance (e.g., shown in FIG. 14A) of the robotic system. By rotating the actuator 442, the first adjustable appendage support member 420 and the second adjustable appendage support member 422 can be extended outward from the retracted positions to adjust the stance from a first stance (distance W1) to a wider second stance (distance W2) and to increase the distances of the first adjustable appendage support member 420 and the second adjustable appendage support member 422 from the sagittal plane SP to Y3 and Y4. The positions of the first and second adjustable appendage support members 420 and 422 at distances Y3 and Y4 can be referred to as the second positions of the first and second adjustable appendage support members 420 and 422, the second positions being associated with a second stance (e.g., shown in FIG. 14B) of the robotic system. From the extended position shown in FIG. 14B, the first adjustable appendage support member 420 and the second adjustable appendage support member 422 can be moved back to the retracted position of FIG. 14A by rotating the actuator in an opposite direction.

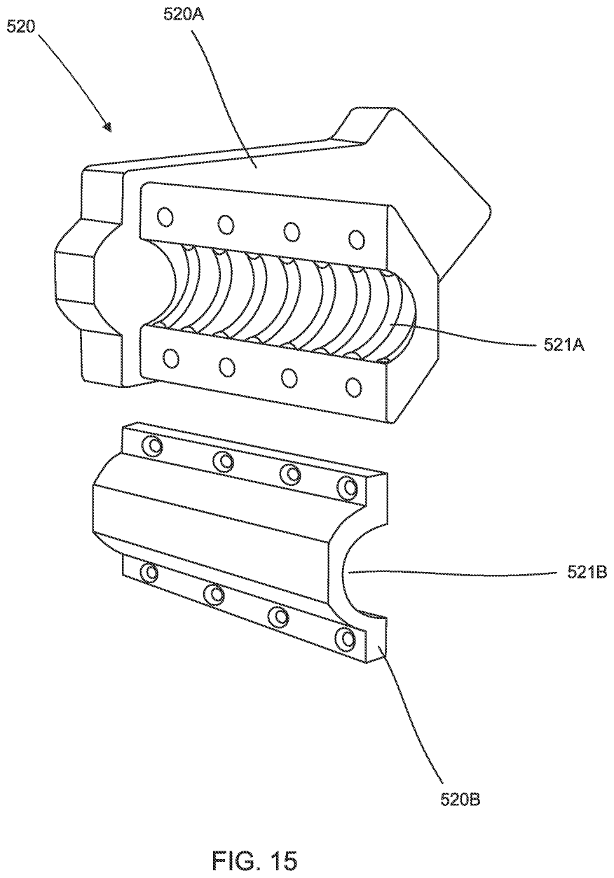

It will be appreciated that various modifications and changes can be made to the devices described herein. For example, an alternative configuration of the adjustable appendage support members is illustrated in FIG. 15. As shown, an adjustable appendage support member 520 can comprise a support portion 520A and a cover portion 520B. Instead of forming a threaded hole in a single member to receive the elongated rod, the adjustable appendage support member 520 can include a first threaded groove 521A defined in the support portion 520A configured to partially receive the threaded surface of an elongated rod. The cover portion 520B can include a second threaded groove 521B that can be disposed to face the first threaded groove 521A of the support portion 520A in order to together define the threaded hole 521 in the adjustable appendage support member 520. The first and second threaded grooves 521A and 521B can be formed such that, when put together, the threads of the grooves 521A and 521B form a continuous thread pattern and define a threaded hole configured to receive a threaded elongated rod. The cover portion 520B can be removably coupled to the support portion 520A by any means (e.g., fasteners, pins, adhesive, joining, or otherwise).

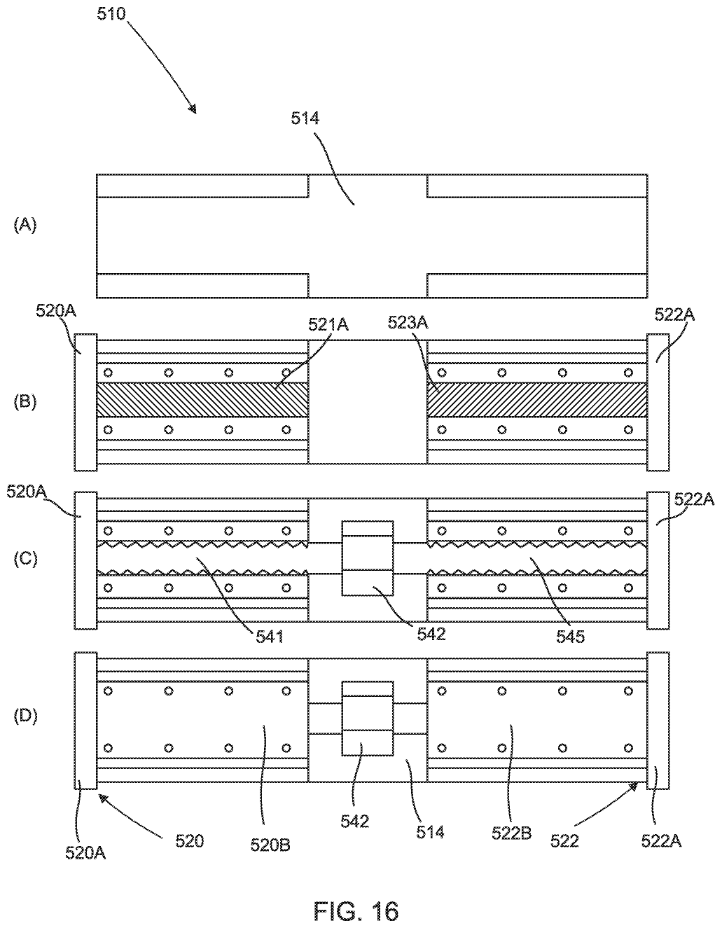

In an example of a stance adjustment system 510 including first and second adjustable appendage support members 520 and 522 similar to the configuration shown in FIG. 15, the stance adjustment system 510 can be assembled without needing the elongated rods 541 and 545 to be twisted into place by rotation into a threaded hole 521. Such rotation can be time consuming and labor intensive, requiring time and several turns of the elongated rod to insert the elongated rod fully into the adjustable appendage support member shown in FIG. 12A. Instead, with the stance adjustment system 510, a guide member 514 can be provided (as shown in (A) of FIG. 16) and the support portions 520A and 522A of the first and second adjustable appendage support members 520 and 522 can be inserted into the guide member 514 (as shown in (B) of FIG. 16). With the support portions 520A and 522A disposed in the guide member 514, the actuator 542 and elongated rods 541 and 545 can be placed in the threaded grooves 521A and 523A defined by the support portions 520A and 522A to mate the threaded surfaces of the elongated rods with the threaded grooves 521A and 523A of the support portions 520A and 522A (as shown in (C) of FIG. 16). With the actuator 542 and elongated rods 541 and 545 in place in the support portions 520A and 522A, the cover portions 520B and 522B can cover the elongated rods 541 and 545 in the support portions 520A and 520b with the second threaded grooves 521B and 523B interfacing with the threaded surfaces of the elongated rods 541 and 545. The cover portions 520B and 522B can then be removably coupled to the support portions 520A and 522A (as shown in (D) of FIG. 16). In such a manner the elongated rods 541 and 545 can properly interface with the adjustable appendage support members 520 and 522 without requiring time consuming insertion and manipulation of the elongated rods 541 and 545 into the first and second adjustable appendage support members 520 and 522.

The actuator 542 can be operable to adjust the first and second elongated rods 541 and 545 to adjust the first and second adjustable appendage support members 520A and 522A by a same amount relative to the sagittal plane. For example, rotation of the actuator 542 can move both the first and second adjustable appendage support members 520A and 522A away from or toward the sagittal plane SP by a substantially equal or equal amount. In other words, actuation of the actuator 542 can move the first adjustable appendage support member 520A a distance x away from or toward the sagittal plane SP and can also move the second adjustable appendage support member 522A the same distance x away from or toward the sagittal plane SP. In such a configuration, positions of the first and second adjustable appendage support members 520A and 522A, whether before, during, or after adjustment, remain symmetrical about the sagittal plane SP. Accordingly, in their respective first positions, in their respective second positions, in positions other than the first and second positions, and in both a first or second stance of the robot, the first and second adjustable appendage support members 520A and 522A can be maintained symmetrical about the sagittal plane SP.

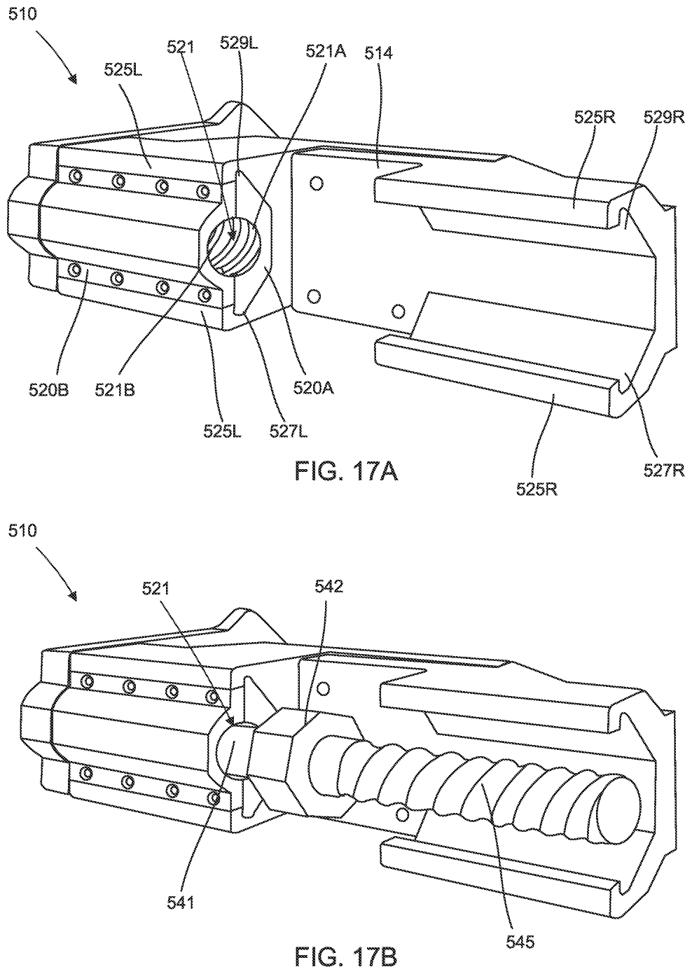

FIGS. 17A and 17B illustrate perspective views of the stance adjustment system 510. As described in other examples herein, the guide member 514 can include left guide rails 525L on both upper and lower sides of the guide member 514 configured to receive the first adjustable appendage support member 520 and to slideably support at least a portion of the first adjustable appendage support member 520 to constrain motion of the first adjustable appendage support member 520 to medial or lateral directions within the guide member 514. Similarly, the guide member 514 can include right guide rails 525R on both upper and lower sides of the guide member 514 that receive a second adjustable appendage support member 522. The adjustable appendage support members 520 and 522 can be configured to move along the guide rails 525L and 525R in response to actuation of the actuator 542. The guide rails 525L and 525R can define a lower channels 527L and 527R as well as upper channels 529L and 529R that receive the support portions 520A and 522A of adjustable appendage support members 520 and 522. The cover portions 520B and 522B can be disposed outside of the channels 527L, 527R, 529L, and 529R but respectively between the left guide rails 525L and the right guide rails 525R to allow the cover portions 520B and 522B to couple to the support portions 520A and 522A while the support portions 520A and 522A are disposed in the channels 527L, 527R, 529L, and 529R.

As illustrated in FIG. 17B, the elongated rod 541 coupled to the actuator 542, can be received into the threaded hole 521 defined in the adjustable appendage support member 520 and formed by the first threaded groove 521A of the support portion 520A and the second threaded groove 521B of the cover portion 520B. The actuator 542 can be located between the elongated rods 541 and 545 and the guide rails 525L and 525R configured to support the adjustable appendage support members 520 and 522.

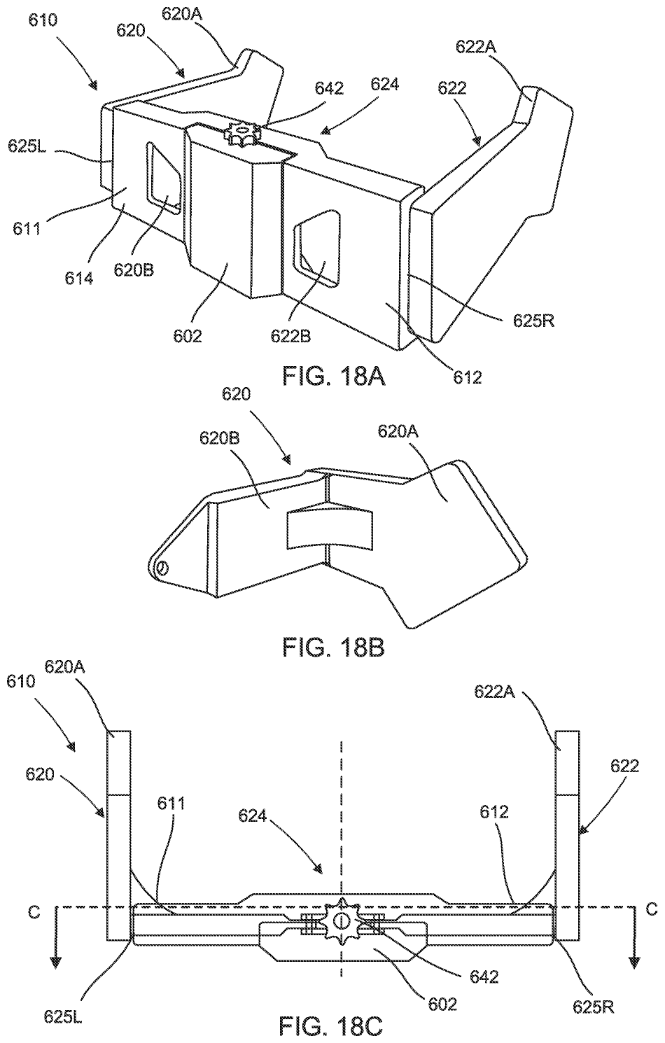

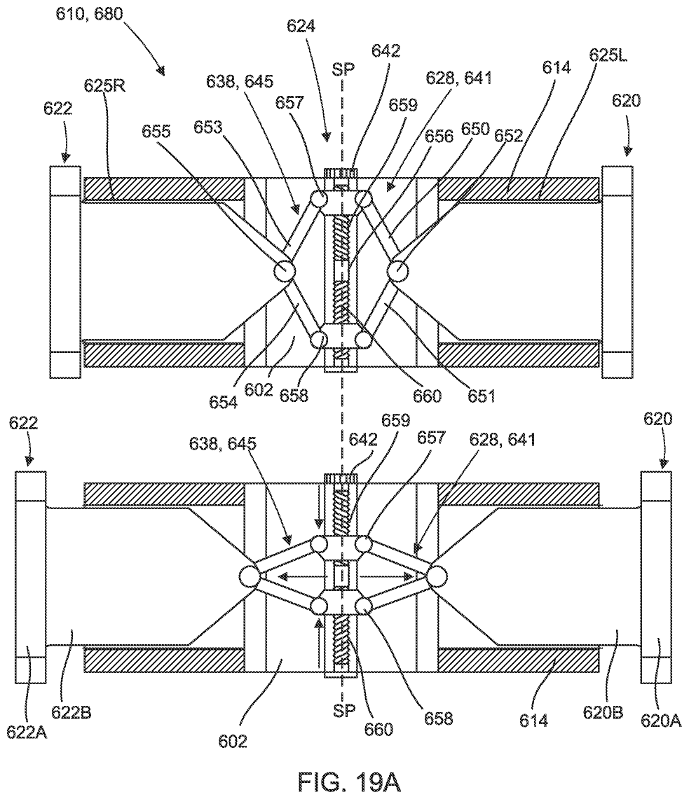

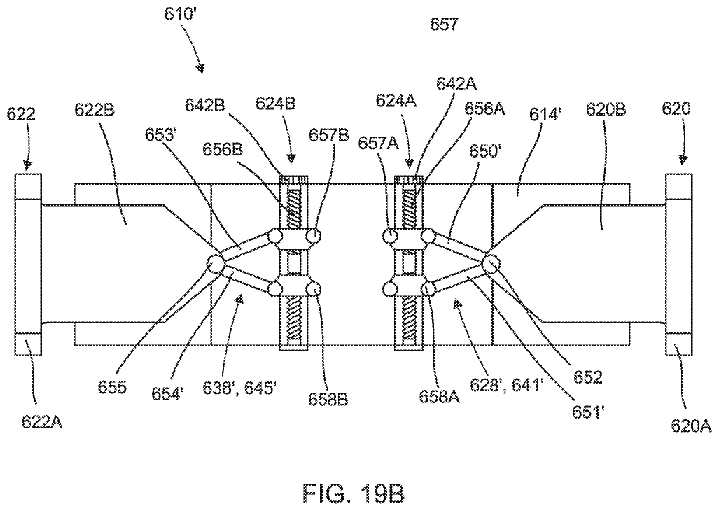

FIGS. 18A, 18B, and 18C illustrate a stance adjustment system 610 in accordance with an example of the present disclosure. FIG. 19A illustrates the stance adjustment system 610 in both a retracted position associated with a first stance of a robotic system (upper portion of FIG. 19A) and an extended position associated with a second stance of the robotic system (lower portion of FIG. 19A). The stance adjustment system 610 can be operable to adjust a stance of a robotic system between a first stance and a second stance of the robotic system.

The stance adjustment system 610 can include a guide member 614 having a first end 611 and a second end 612 opposite to the first end 611. The guide member 614 can be fixed relative to a robotic system (e.g., fixed to a spine or other member of the robotic system). The stance adjustment system 610 can further include a first adjustable appendage support member 620 including a first appendage mounting portion 620A to which the first ground contacting appendage 102 is mounted and an adjustment portion 620B adjustably coupled to the first end 611 of the guide member 614. The stance adjustment system 610 can further include a second adjustable appendage support member 622 including a second appendage mounting portion 622A to which the second ground contacting appendage 104 is mounted and an adjustment portion 622B adjustably coupled to the second end 612 of the guide member 614.

The guide member 614 can include a first slot 625L formed in the first end 611 of the guide member 614. The first slot 625L can receive at least a part of the adjustment portion 620B of the first adjustable appendage support member 620 and can slideably support at least a portion of the first adjustable appendage support member 620 to constrain motion of the first adjustable appendage support member 620 to medial or lateral directions within the guide member 614. Similarly, the guide member 614 can include second slot 625R formed in the second end 612 of the guide member 614. The second slot 625R can receive at least a part of the adjustment portion 622B of the second adjustable appendage support member 622 and can slideably support at least a portion of the second adjustable appendage support member 622 to constrain motion of the second adjustable appendage support member 622 to medial or lateral directions within the guide member 614. The first and second adjustable appendage support members 620 and 622 can be configured to adjust position and slide within the first and second slots 625L and 625R in response to operation of an adjustment mechanism 624.

The adjustment mechanism 624 of the stance adjustment system 610 can be operated to adjust the first adjustable appendage support member 620 between a first position (e.g., the retracted position relative to the guide member 614 shown in the upper portion of FIG. 19A) and a second position (e.g., the extended position relative to the guide member 614 shown in the lower portion of FIG. 19A). The adjustment mechanism 624 can further be operated to adjust the second adjustable appendage support member 622 between a first position (e.g., the retracted position relative to the guide member 614 and sagittal plane shown in the upper portion of FIG. 19A) and a second position (e.g., the extended position relative to the guide member 614 and sagittal plane SP shown in the lower portion of FIG. 19A).

Adjusting position of the first and second adjustable appendage support members 620 and 622 also changes positions of first and second ground contacting appendages fixed to the first and second adjustable appendage support members 620 and 622. The adjustment mechanism 624, by adjusting the positions of the first and second adjustable appendage support members 620 and 622 and appendages between the first and second positions, can be operable to adjust a stance of the robotic system from a first stance to a second stance. The first and second stances can comprise different distances of the first ground contacting appendage and the second ground contacting appendage relative to the sagittal plane of the robotic system.

Further description of the adjustment mechanism 624 will be made with reference to FIGS. 18A-20. FIG. 18C illustrates a top view of the stance adjustment system 610. FIG. 19A illustrates a cross-sectional view of the stance adjustment system 610 taken along line CC shown in FIG. 18C. FIG. 19A illustrates the stance adjustment system 610 in both a retracted position associated with a first stance of a robotic system (upper portion of FIG. 19A) and an extended position associated with a second stance of the robotic system (lower portion of FIG. 19A).

As shown in FIG. 19A, the adjustment mechanism 624 can further include an actuator 642 that is operable to adjust the first adjustable appendage support member 620 between the first position and the second position to thereby adjust the stance of the robotic system between the first stance and the second stance. The actuator 642 can also be operable to adjust the second adjustable appendage support member 622 between the first position and the second position to thereby adjust the stance of the robotic system between the first stance and the second stance. By operation of the actuator 642, the first adjustable appendage support member 620 can extend or retract relative to the guide member 614 and the sagittal plane SP. Additionally or alternatively, operation of the actuator 642 can extend or retract the second adjustable appendage support member 622 relative to the guide member 614 and the sagittal plane SP.

The adjustment mechanism 624 can be coupled to the first and second adjustable appendage support members 620 and 622. More specifically, the adjustment mechanism 624 can be coupled to the adjustment portions 620B and 622B of the first and second adjustable appendage support members 620 and 622. The adjustment mechanism can further be coupled to the guide member 614. The adjustment mechanism 624 can include a first interface 628 at which the first adjustable appendage support member 620 adjustably couples to the adjustment mechanism 624. The adjustment mechanism 624 can further include a second interface 638 at which the second adjustable appendage support member 622 adjustably couples to the adjustment mechanism 624.

At the first interface 628, the adjustment mechanism 624 can include a first linkage 641 coupling the first adjustable appendage support member 620 to the actuator 642. The first linkage 641 can include a first link 650 and a second link 651 having ends that are rotatably coupled together at coupling 652. At the second interface 638, the adjustment mechanism 624 can include a second linkage 645 coupling the second adjustable appendage support member 622 to the actuator 642. The second linkage 645 can include a third link 653 and a fourth link 654 having ends that are rotatably coupled together at coupling 655. The first link 650 and the second link 651 of the first linkage 641 can rotate about the coupling 652. Likewise, the third link 653 and the fourth link 654 of the second linkage 645 can rotate about the coupling 655.

The actuator 642 can be operable to cause movement of the first linkage to adjust a position of the first adjustable appendage support member 620 relative to the guide member 614 and can be operable to cause movement of the second linkage 645 to adjust a position of the second adjustable appendage support member 622 relative to the guide member 614. The actuator 642 can be operable to move the first linkage and the second linkage to adjust the first adjustable appendage support member and the second adjustable appendage support member between their respective first positions and their respective second positions, to thereby adjust the stance of the robotic system from the first stance to the second stance.

The actuator 642 can comprise a threaded rod 656 coupled to a knob operable to be turned by a motor or by hand by a user. The adjustment mechanism 624 can further comprise threaded brackets 657 and 658, each respectively and moveably engaged with a first and second threaded surface 659 and 660 formed on the threaded rod 656. The first linkage 641 and the second linkage 645 can be coupled to the threaded brackets 657 and 658 to facilitate movement of the first and second linkages 641 and 645 in response to movement of the threaded brackets 657 and 658 on the threaded rod 656. For example, an end of the first link 650 can be rotatably coupled to a first threaded bracket 657 while the opposite end of the first link 650 is rotatably coupled to an end of the second link 651 and the first adjustable appendage support member 620 at coupling 652. Another end of the second link 651 can be rotatably coupled to a second threaded bracket 658.

The second linkage 645 can be connected to the same first and second threaded bracket 657 and 658 that the first linkage 641 is connected to, or the second linkage 645 can be connected to different threaded brackets than the first linkage 641 is connected to. For example, an end of the third link 653 of the second linkage 645 can be rotatably coupled to an end of the fourth link 654 and the second adjustable appendage support member 622 at coupling 655 while another end of the third link 653 is rotatably connected to a threaded bracket (e.g., the first threaded bracket 657 or, alternatively, a separate threaded bracket engaged with the same or a separate threaded rod). An end of the fourth link 654 can be rotatably coupled to the third link 653 and the second adjustable appendage support member 622 at coupling 655 while another end of the fourth link 654 is rotatably connected to a threaded bracket (e.g., the second threaded bracket 658 or, alternatively, a separate threaded bracket engaged with the same or a separate threaded rod). Accordingly, the first and second linkages 641 and 645 can be moved together by actuation of a single actuator, or can each be associated with separate actuators to facilitate separate movement/flexing/actuation of the first and second linkages 641 and 645.

Rotation of the threaded rod 656 of the actuator 642 can cause the threaded brackets 657 and 658 to move along the threaded rod 656 to adjust positions of the first linkage 641 and the second linkage 645 relative to each other, thereby adjusting a distance between the first adjustable appendage support member 620 and the second adjustable appendage support member 622 to adjust a distance between the first ground contacting appendage 102 and the second ground contacting appendage 104. The adjustment of the ground contacting appendages can adjust the stance of the robot between a second stance and a first stance to improve stability of the robot in a walking or standing operation.

In the configuration of the stance adjustment system 610 shown in FIG. 19A, in which both the first and second adjustable appendage support members 620 and 622 are simultaneously adjustable by actuation of a single actuator 642, the adjustment mechanism 624 can alternatively be referred to as an adjustable bridge that connects the first ground contacting appendage 102 to the second ground contacting appendage 104 via the first and second adjustable appendage support members 620 and 622. The adjustable bridge/mechanism 624 can be operable to facilitate adjustment of the first and second adjustable appendage support members 620 and 622 and the first and second ground contacting appendages 102 and 104. With the adjustable bridge/mechanism 624, the actuator 642 can be operable to adjust simultaneously adjust the second adjustable appendage support member 622 and the first adjustable appendage support member 620. The first adjustable appendage support member 622 can be adjusted between a first position and a second position of the first adjustable appendage support member 622 relative to the sagittal plane SP of the robotic system, the first position and the second position of the first adjustable appendage support member 620 being respectively associated with the first stance and the second stance. The second adjustable appendage support member 622 can also, and at the same time, be adjusted between a first position and a second position of the second adjustable appendage support member 622 relative a sagittal plane SP of the robotic system, the first position and the second position of the second adjustable appendage support member 622 being respectively associated with the first stance and the second stance.

As illustrated in FIG. 19A, the actuator 642 can be operable to adjust the first and second linkages 641 and 645 to adjust the first and second adjustable appendage support members 620 and 622 by a same amount relative to the sagittal plane. For example, rotation of the actuator 642 can move both the first and second linkages 641 and 645, which can in turn adjust the first and second adjustable appendage support members 620 and 622 away from or toward the sagittal plane SP by a substantially equal or equal amount. In other words, actuation of the actuator 642 can move the first adjustable appendage support member 620 a distance x away from or toward the sagittal plane SP and can also move the second adjustable appendage support member 622 the same distance x away from or toward the sagittal plane SP. In such a configuration, positions of the first and second adjustable appendage support members 620 and 622, whether before, during, or after adjustment, remain symmetrical about the sagittal plane SP. Accordingly, in their respective first positions, in their respective second positions, in positions other than the first and second positions, and in both a first or second stance of the robot, the first and second adjustable appendage support members 620 and 622 can be maintained symmetrical about the sagittal plane SP.

The actuator 642 can be operated by a user or a motor to rotate. Rotation of the actuator 642 in a clockwise (e.g., first direction) or counter-clockwise direction (e.g., second direction), can cause rotation of the elongated rod 656 including the first and second threaded surfaces 659 and 660. Rotation of the elongated rod 656 can cause the first threaded bracket 657 to translate along the elongated rod 656 by engaging with the first threaded surface 659, and the second threaded bracket 657 to translate along the elongated rod 656 by engaging with the second threaded surface 660. The translation of the first and second threaded brackets 657 and 658 along the elongated rod 656 in turn can cause the first and second linkages 641 and 645 to move or flex to adjust positions of the first adjustable appendage support member 422 and the second adjustable appendage support member 422 in medial or lateral directions to adjust a distance between the first ground contacting appendage 102 and the second ground contacting appendage 104.

For example, as illustrated in FIG. 19A, rotation of the actuator 642 in a first direction (e.g., clockwise) can cause the threaded brackets 657 and 658 to move closer to each other on the elongated rod 656. As the threaded brackets 657 and 658 move closer together on the elongated rod 656, the first and second linkages 641 and 645 will flex away from the sagittal plane SP. Furthermore, the couplings 652 and 655 where the first and second adjustable appendage support members 620 and 622 are coupled to the first and second linkages 641 and 645 will flex away from the sagittal plane SP due to the movement of the linkages 641 and 645. Movement of the couplings away from the sagittal plane SP will cause the first adjustable appendage support member 620 and the second adjustable appendage support member 622 to adjust away from the sagittal plane SP, thereby increasing a distance between the first ground contacting appendage and the second ground contacting appendage to adjust the stance of the robotic system between the first stance and the second stance.

Alternately, as illustrated in FIG. 19A, rotation of the actuator 642 in a second direction (e.g., counter clockwise) different than the first direction can cause the threaded brackets 657 and 658 to move away from each other on the elongated rod 656. As the threaded brackets 657 and 658 move away from each other on the elongated rod 656, the first and second linkages 641 and 645 will flex toward from the sagittal plane SP. Furthermore, the couplings 652 and 655 where the first and second adjustable appendage support members 620 and 622 are coupled to the first and second linkages 641 and 645 will flex toward the sagittal plane SP due to the movement of the linkages 641 and 645. Movement of the couplings toward the sagittal plane SP will cause the first adjustable appendage support member 620 and the second adjustable appendage support member 622 to adjust toward the sagittal plane SP, thereby decreasing a distance between the first ground contacting appendage and the second ground contacting appendage to adjust the stance of the robotic system between the first stance and the second stance.

The threaded surfaces 659 and 660 can be formed with any desired thread direction on the elongated rod 656. However, it will be advantageous to form the first and second threaded surfaces 659 and 660 with opposite direction threads from each other, as shown in FIG. 19A, such that rotation of the actuator 642 in a first direction causes the threaded brackets 657 and 658 to move toward each other on the elongated rod 656, in turn causing the first adjustable appendage support member 620 to separate from the second adjustable appendage support member 622 and the sagittal plane SP. Such adjustment thereby increases a distance between first and second ground contacting appendages 102 and 104. Furthermore, rotation of the actuator 642 in a second direction causes the threaded brackets 657 and 658 to move away from each other on the elongated rod 656, in turn causing first adjustable appendage support member 620 to move toward the second adjustable appendage support member 622 and the sagittal plane SP, thereby decreasing a distance between first and second ground contacting appendages 102 and 104. Accordingly, forming the threaded surfaces 659 and 660 to have opposite thread directions allows the adjustable bridge/mechanism 624 to be operable to move and adjust a distance between both of the adjustable appendage support members 620 and 622 with just a single motion or actuation of the actuator 642. Thus, the adjustable bridge/mechanism 624 according to the present disclosure can facilitate single handed and single user adjustment of a hip width between the ground contacting appendages of a robotic system 100 to accommodate multiple different sizes of users therein.

Furthermore, the configurations shown in FIGS. 18A-19B allow for theoretically infinite adjustment positions achievable for the appendages within the range of movement of the adjustable appendage support members, and, therefore, provides for a theoretically infinite number of stances and hip width adjustments for the robot. The configuration further allows for accommodating a theoretically infinite amount of hip widths for users wearing an exoskeleton with the shown configuration. Additionally, the threaded configuration allows the adjustable appendage support members to remain stable at a desired position and to essentially be locked at the desired position while the actuator is not being turned.

It will be appreciated that, in alternative examples, each of the first and second adjustable appendage support members 620 and 622 can be actuated separately using separate first and second adjustment mechanisms 624A and 624B. For example, as shown in FIG. 19B, a stance adjustment system 610′ can include first and second adjustment mechanisms 624A and 624B respectively having first and second actuators 642A and 442B, each supported by guide member 614′ and engaged with first and second adjustable appendage support members 620 and 622. In other words, each of the first and second adjustable appendage support members 620 and 622 can be associated with separate individual first and second adjustment mechanisms 624A and 624B that respectively adjust one of the first and second adjustable appendage support members 620 and 622 individually. Furthermore, each of the first and second adjustable appendage support members 620 and 622 can be moved or positioned by actuation of respective first and second actuators 642A and 642B that are each separately operable to respectively adjust the position of the first and second adjustable appendage support members 620 and 622 and associated ground contacting appendages.

To facilitate separate movement of the individual first and second adjustable appendage support members 620 and 622, the first and second adjustment mechanisms 624A and 624B can include the following elements. The first adjustment mechanism 624A can be coupled to the first adjustable appendage support member 620. More specifically, the adjustment mechanism 624A can be coupled to the adjustment portion 620B of the first adjustable appendage support member 620. The first adjustment mechanism 624A can include a first interface 628′ at which the first adjustable appendage support member 620 adjustably couples to the first adjustment mechanism 624A. The second adjustment mechanism 624B can be coupled to the second adjustable appendage support member 622. More specifically, the second adjustment mechanism 624B can be coupled to the adjustment portion 622B of the second adjustable appendage support member 622. The second adjustment mechanism 624B can include a second interface 638′ at which the second adjustable appendage support member 622 adjustably couples to the second adjustment mechanism 624B.

Similar to as illustrated in FIGS. 18A-19A, at the interface 628′, the adjustment mechanism 624A can include a first linkage 641′ coupling the first adjustable appendage support member 620 to the first adjustment mechanism 624A. The first linkage 641′ can include a first link 650′ and a second link 651′ having ends that are rotatably coupled together at coupling 652. The first actuator 642A can comprise a threaded rod 656A coupled to a knob operable to be turned by a motor or by hand by a user. The first adjustment mechanism 624A can further comprise threaded brackets 657A and 658A, each respectively and moveably engaged with the threaded rod 656A. The first linkage 641′ can be coupled to the threaded brackets 657A and 658A to facilitate movement of the first linkage 641′ in response to movement of the threaded brackets 657A and 658A on the threaded rod 656A. For example, an end of the first link 650′ can be rotatably coupled to a first threaded bracket 657A while the opposite end of the first link 650 is rotatably coupled to an end of the second link 651′ and the first adjustable appendage support member 620 at coupling 652. Another end of the second link 651′ can be rotatably coupled to a second threaded bracket 658A.

At the second interface 638′, the adjustment mechanism 624B can include a second linkage 645′ coupling the second adjustable appendage support member 622 to the second adjustment mechanism 624B. The second linkage 645′ can include a link 653′ and a link 654′ having ends that are rotatably coupled together at coupling 655. The second actuator 642B can comprise a threaded rod 656B coupled to a knob operable to be turned by a motor or by hand by a user. The second adjustment mechanism 624B can further comprise threaded brackets 657B and 658B, each respectively and moveably engaged with the threaded rod 656B. The second linkage 645′ can be coupled to the threaded brackets 657B and 658B to facilitate movement of the second linkage 645′ in response to movement of the threaded brackets 657B and 658B on the threaded rod 656B. For example, an end of the link 653′ can be rotatably coupled to a threaded bracket 657B while the opposite end of the link 653′ is rotatably coupled to an end of the link 654′ and the second adjustable appendage support member 620 at coupling 655. Another end of the link 654′ can be rotatably coupled to another threaded bracket 658A.

It will be appreciated that rotation of the threaded rods 656A and 656B of the actuators 642A and 642B can cause the threaded brackets 657A, 657B, 658A, and 658B to move along respective the threaded rods 656A and 656B to adjust positions of the first linkage 641′ and the second linkage 645′ relative to each other, thereby adjusting a distance between the first adjustable appendage support member 620 and the second adjustable appendage support member 622 to adjust a distance between the first ground contacting appendage 102 and the second ground contacting appendage 104. The adjustment of the ground contacting appendages can adjust the stance of the robot between a second stance and a first stance to improve stability of the robot in a walking or standing operation.

It will be apparent from the descriptions above regarding FIGS. 18A-19A how the operation of the adjustment mechanisms 624A and 624B accomplish adjustment of the first and second adjustable appendage support members 620 and 622 and appendages coupled thereto. Adjustment of the positions of the first and second adjustable appendage support members 620 and 622 can be accomplished separately by separate rotation of the actuators 642A and 642B to cause the first and second adjustable appendage support members 620 and 622 to move by movement of the linkages 641′, 645′ and couplings 652 and 655. The actuators 642A and 642B are not connected to each other in any way but are supported by the guide member 614′ separately so that turning of one actuator does not affect the state or position of the other actuator.

Each of the first and second actuators 642A and 642B can be operated by a user or a motor to rotate. Rotation of one or more of the actuators 642A and 642B in a clockwise (e.g., first direction) or counter-clockwise direction (e.g., second direction), can cause rotation of the first elongated rod 656A and/or the second elongated rod 656B. Rotation of the first and/or second elongated rods 656A and 656B can cause the first adjustable appendage support member 620 to adjust via movement of the linkage 641′ and/or the second adjustable appendage support member 622 to adjust via movement of the linkage 645′ in medial or lateral directions to adjust a distance between the first ground contacting appendage 102 and the second ground contacting appendage 104.

Individual rotation of one or more of the first and second actuators 642A, 642B in a first direction (e.g., clockwise or counter clockwise) can cause the first adjustable appendage support member 620 and the second adjustable appendage support member 622 to individually adjust away from the sagittal plane, thereby increasing a distance between the first ground contacting appendage and the second ground contacting appendage to adjust the stance of the robotic system between the first stance and the second stance. Individual rotation of one or more of the first and second actuators 642A, 642B in a second direction (e.g., counter clockwise or counter clockwise) different than the first direction can cause the first adjustable appendage support member 620 and the second adjustable appendage support member 622 to individually adjust toward the sagittal plane, thereby increasing a distance between the first ground contacting appendage and the second ground contacting appendage to adjust the stance of the robotic system between the first stance and the second stance. The rotation directions for extension and retraction of the respective adjustable appendage support members relative to the sagittal plane SP can be the same or different for the different actuators 642A and 642B.

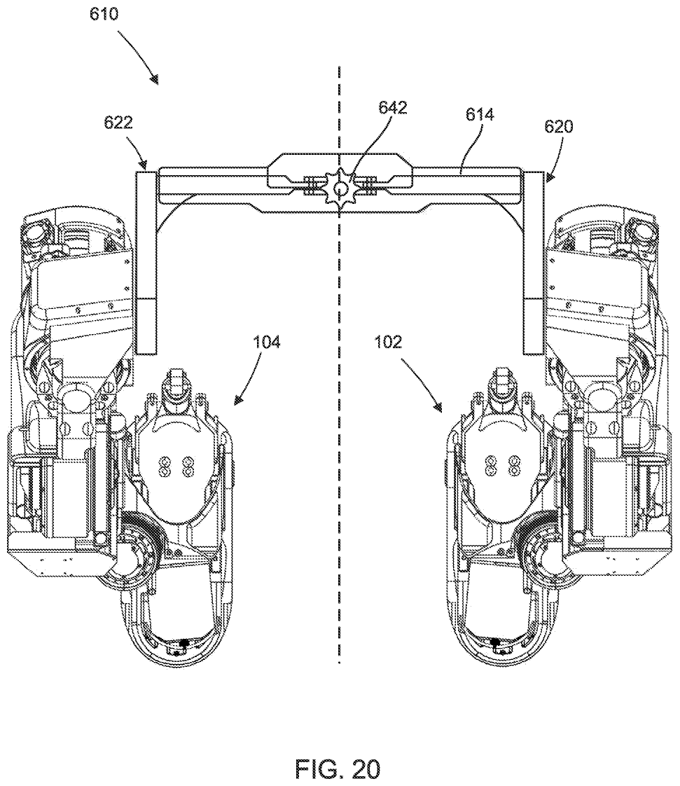

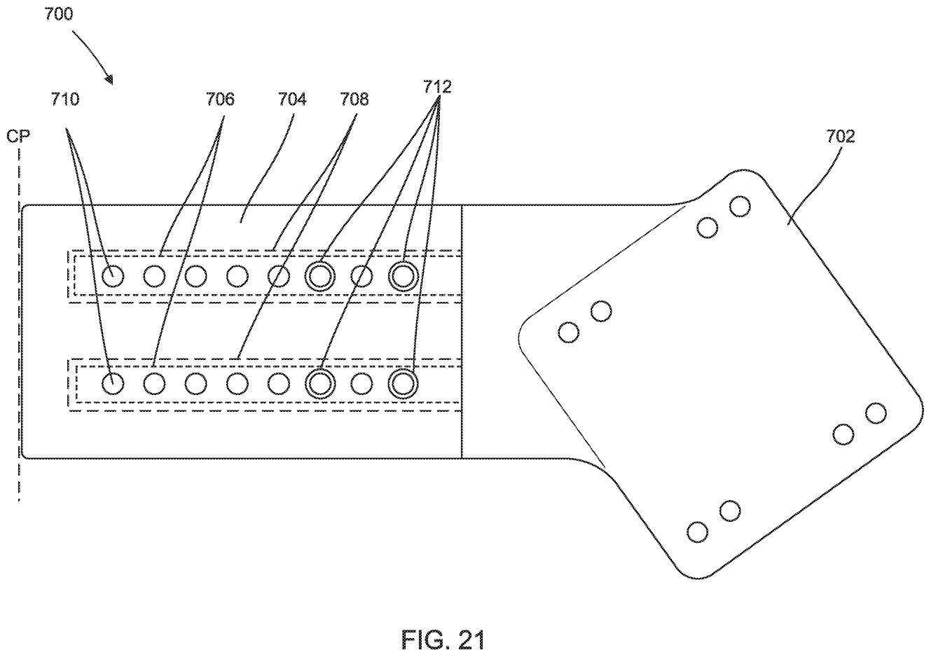

It will be appreciated that the stances and distances W1, W2, Y1, Y2, Y3, and Y4 illustrated in FIGS. 14A and 14B with respect to stance adjustment system 410 are equally applicable to the stance adjustment system 610. While the function and structure of stance adjustment system 610 is different from stance adjustment system 410, the stance adjustment system 410 of FIGS. 14A and 14B can be replaced by stance adjustment system 610 without altering the first and second positions of the adjustable appendage support members, the first and second positions of the ground contacting appendages, or the first and second stances of the robotic system. Accordingly, it will be appreciated that FIGS. 14A and 14B illustrate the stance adjustment carried out by either of stance adjustment system 410 or stance adjustment system 610. Additionally, FIG. 20 illustrates the stance adjustment system 610 connected to the appendages 102 and 104. By turning of the actuator 642, the appendages 102 and 104 can be positioned further apart or closer together according to the needs of stability of the robot, or the size of a person wearing the robot as an exoskeleton.

Additional modifications can be made to the elements and mechanisms described herein. For example, an adjustable appendage support member 700, as in any of the examples described herein, can be adjustable in forward and rearward direction to adjust the stance of a robot relative to a coronal plane CP of a robotic system. For example, in the examples described with respect to FIGS. 21-25, the adjustable appendage support members (in accordance with any of the exemplary adjustable appendage support members described herein) can be modified to include coronal adjustment mechanism. The coronal adjustment mechanism can couple an appendage mounting portion to the adjustment portion of an adjustable appendage support member. The coronal adjustment mechanism can be operable to facilitate adjustment of the adjustable appendage support member and the first ground contacting appendage between a first coronal position and a second coronal position relative to a coronal plane of the robotic system. The first coronal position of the first adjustable appendage support member can be associated with a first coronal stance of the robotic system. A second coronal position of the adjustable appendage support member can be associated with a second coronal stance of the robotic system. The first and second coronal stances can comprise different distances of the first ground contacting appendage relative to the coronal plane of the robotic system.

It will be appreciated that one or more of the first and second adjustable appendage support members described herein can include coronal adjustment as described herein. Each exemplary device for facilitating coronal adjustment of ground contacting appendages is described below with reference to FIGS. 21-25.

As illustrated in FIG. 21, the adjustable appendage support member 700 can include a forward portion 702 and a rearward portion 704. The forward portion 702 can be used as an appendage mounting portion configured to receive and support an appendage (e.g., appendages 102 or 104) of the robot. The rearward portion 704 can be configured to interface with a guide member of any stance adjustment systems according to the principles described herein. The rearward portion 704 and the forward portion 702 can be separate members from each other in order to facilitate separation of the forward portion 702 from the rearward portion 704. FIG. 21 illustrates the forward portion 702 of the adjustable appendage support member 700 in a retracted position (e.g., first coronal position) relative to the rearward portion 704.

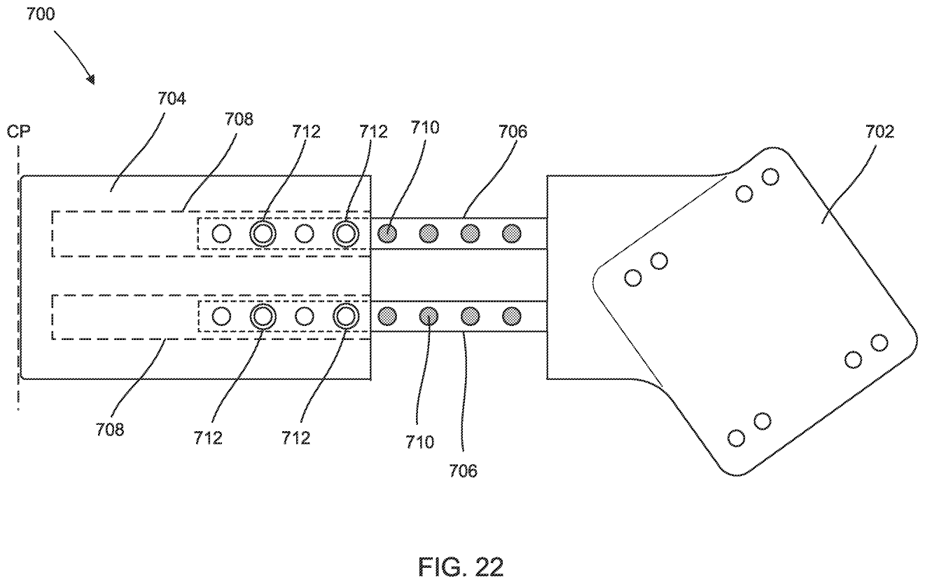

One or more rails 706 can be fixed to the forward portion 702. The rails 706 can be received inside one or more corresponding channels 708 formed in the rearward portion 704 and can be slideably moved within the channels 708. A plurality of holes 710 can be formed in the rails 706 and one or more holes 712 can be formed in the rearward portion 704 to align and correspond with one or more of the plurality of holes 710 formed in the rails 708. Accordingly, to move the forward portion 702 relative to the rearward portion 704 and to adjust the distance of the forward portion 702 from the coronal plane CP, the forward portion 702 can be moved to extend the rails 706 out of the channels 708 formed in the rearward portion 704. The forward portion 702 disposed in an extended position is illustrated in FIG. 22.

As shown in FIG. 22, as the rails 706 are moved out of the channels 708, the holes 710 of the rails 706 pass by the holes 712 formed in the rearward portion 704. Any of the holes 710 of the rails 706 can be caused to align with one or more of the holes 712 of the rearward portion 704. In a desired position (e.g., extended or second coronal position) and distance from the coronal plane CP, the forward portion 702 can be fastened in place by inserting a fastener through one or more holes 712 of the rearward portion 704 and the corresponding hole 710 in the rails 706. By this operation, the distance of the forward portion 702 from the coronal plane CP can be adjusted and the forward portion 702 can be fixed in place at the desired position from the coronal plane CP and the rearward portion 704.

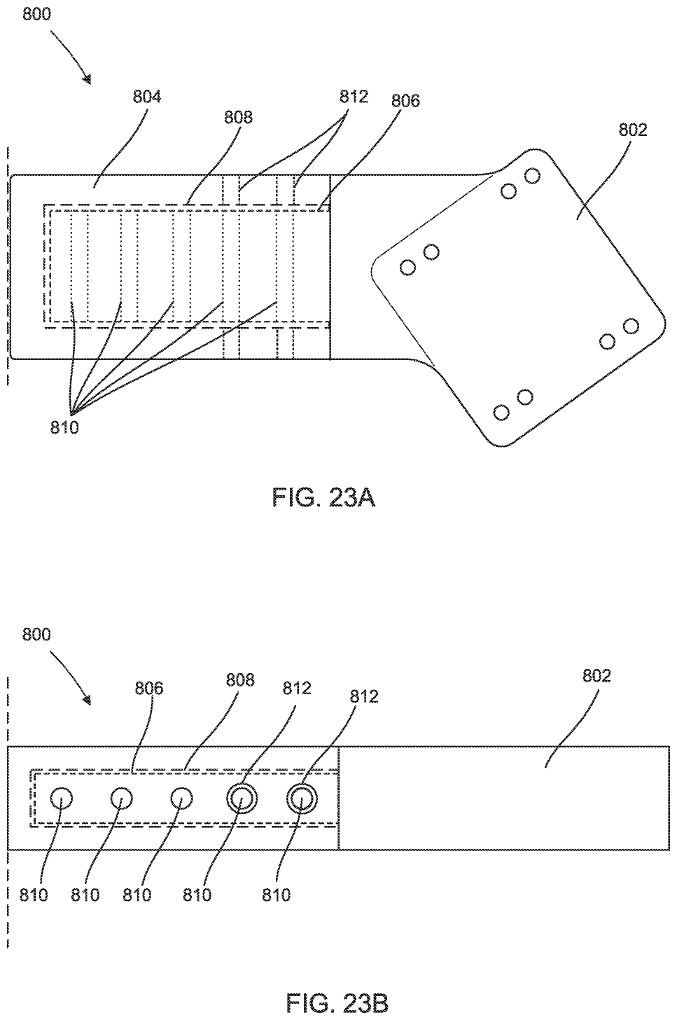

In an alternative example of an adjustable appendage support member 800 illustrated in FIGS. 23A and 23B, the forward portion 802 can include a plate 806 sized to be received in a slot 808 formed in the rearward portion 804. Holes 812 can be formed through a top of the rearward portion 804 and holes 810 can be formed in the top of the plate 806 as shown in the top view of the adjustable appendage support member 800 illustrated in FIG. 23B. The plate 806 can be slideably moved within the slot 808 to adjust a distance from the frontward portion 802 to the rearward portion 804 as well as a distance from the frontward portion 802 to the coronal plane CP. Any of the holes 810 of the plate 806 can be caused to align with one or more of the holes 812 of the rearward portion 804. In a desired position and distance from the coronal plane CP, the forward portion 802 can be fastened in place by inserting a fastener through the hole 812 of the rearward portion 804 and the corresponding hole 810 in the plate 806. By this operation, the distance of the forward portion 802 from the coronal plane CP can be adjusted and the forward portion 802 can be fixed in place at the desired position from the coronal plane CP and the rearward portion 804.

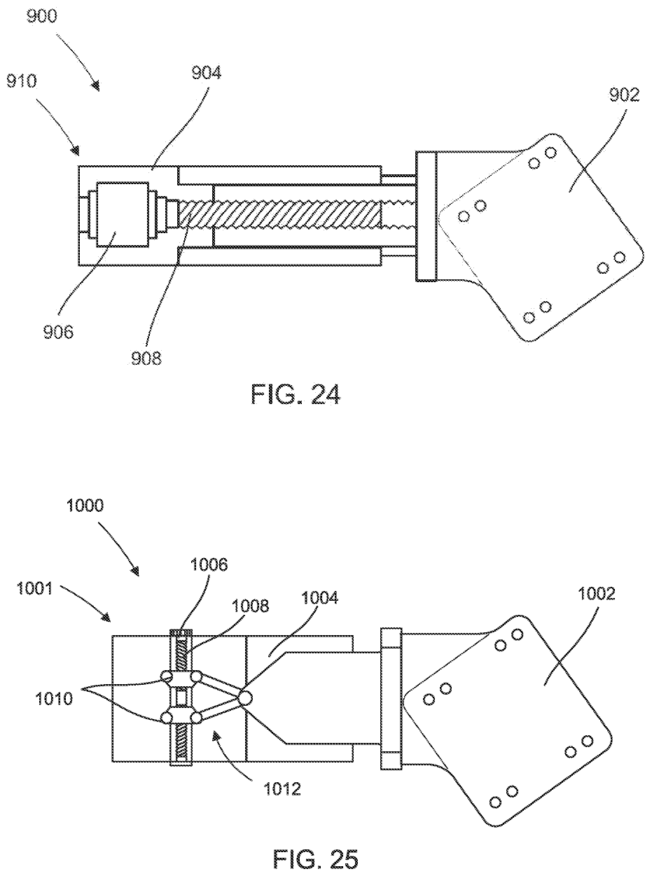

Alternatively, the coronal plane CP adjustment of a forward portion 902 of an adjustable appendage support member 900 can be carried out by mechanisms similar to adjustable mechanism 424 of FIG. 12A and FIG. 19A. Illustrations of such coronal plane adjustment mechanisms are illustrated in FIGS. 24 and 25. Coronal plane adjustment mechanism 910 is illustrated in FIG. 24 and coronal plane adjustment mechanism 1000 is illustrated in FIG. 25. The functioning of these mechanisms will be apparent by the parts of the disclosure discussing FIGS. 12A, 12B, and 19A. The coronal plane adjustment mechanism 924 of FIG. 24 can include a forward portion 902 and a rear portion 904. An actuator 906 and elongated rod 908 configured to interface with the forward portion 902 can be provided, similar to actuators and elongated rods of FIGS. 12A and 12B, to provide the functionality of the coronal plane adjustment mechanism 924. The coronal plane adjustment mechanism 1001 of FIG. 25 can adjust an adjustable appendage support member 1000 including a forward portion 1002 and a rear portion 1004. An actuator 1006, threaded rod 1008, threaded brackets 1010, and linkage 1012 can further be provided, similar to actuators and other mechanisms of FIG. 19A, to provide the functionality of the coronal plane adjustment mechanism 1000.

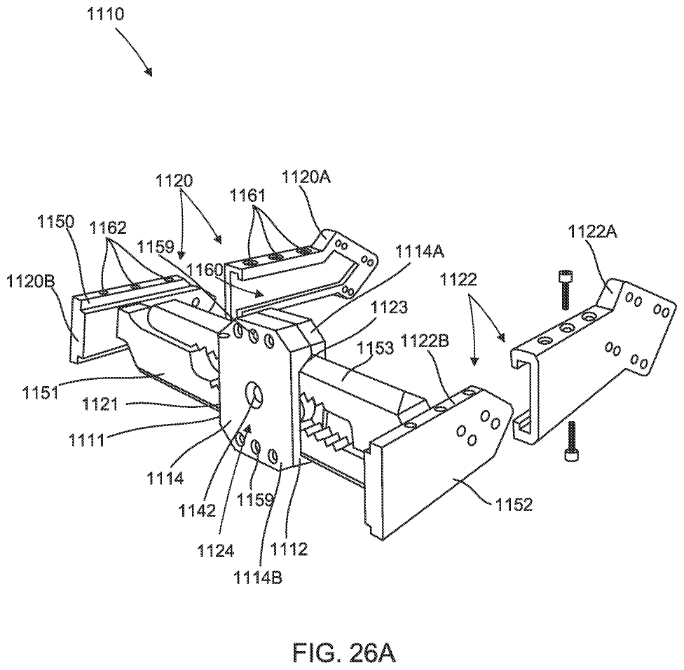

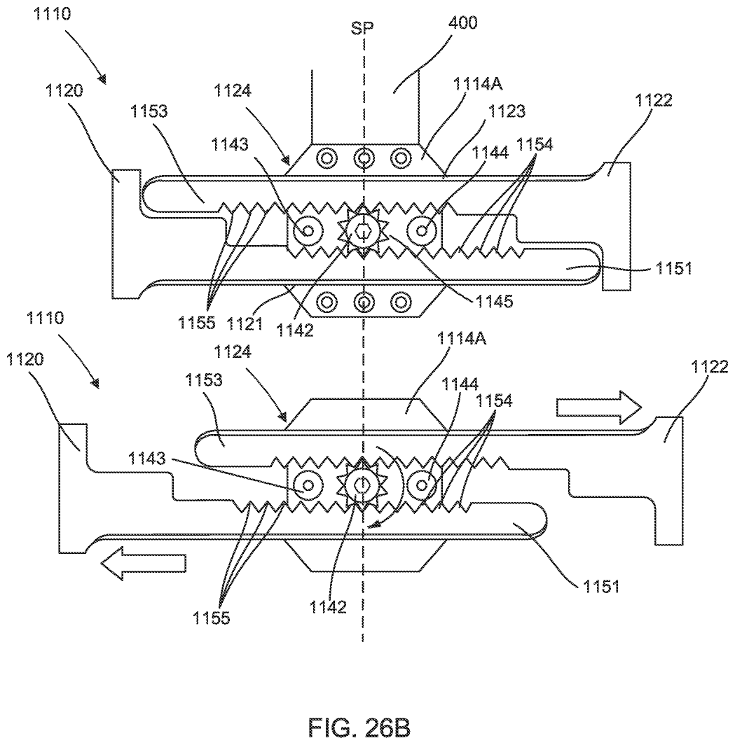

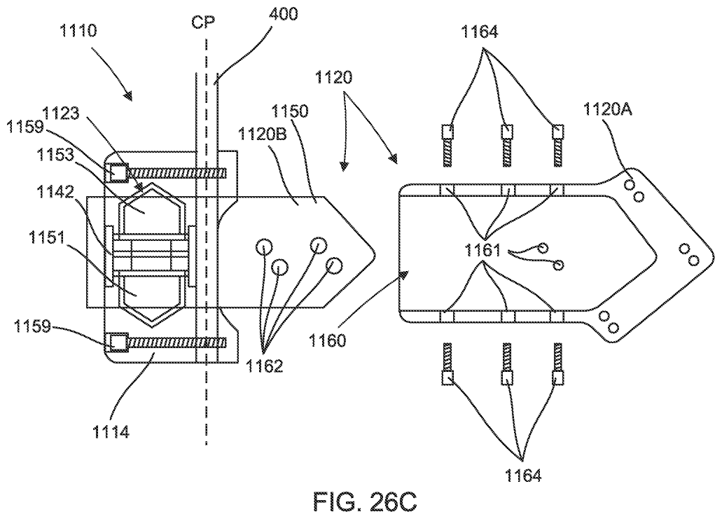

FIGS. 26A-26C illustrate a stance adjustment system 1110 in accordance with another example of the present disclosure. FIG. 26A illustrates an isometric view of the stance adjustment system 1110. The stance adjustment system 1110 can include a guide member 1114 having a first end 1111 and a second end 1112 opposite to the first end 1111. The guide member 1114 can be fixed relative to a robotic system (e.g., fixed to a frame mount 400 or other member of the robotic system or can serve as the frame mount for other parts of the robot). The guide member 1114 can be fixed to the frame mount 400 via a plurality of holes 1159 that can correspond to holes in the frame mount 400 and can receive fasteners to couple the guide member 1114 to the frame mount 400. The stance adjustment system 1110 can further include a first adjustable appendage support member 1120 including a first appendage mounting portion 1120A to which the first ground contacting appendage is mounted and an adjustment portion 1120B adjustably coupled to the first end 1111 of the guide member 1114. The adjustment portion 1120B can include a mount portion 1150 configured to receive the first appendage mounting portion 1120A thereon. The adjustment portion 1120B can further include a first rack 1150 coupled to the mount portion 1150 to facilitate adjustment of the adjustment portion 1120B relative to the guide member 1114. As will be further described later, the first appendage mounting portion 1120A can be removably and adjustably coupled to the adjustment portion 1120B to facilitate adjustment of the first ground contacting appendage relative to a coronal plane of the robot.

The stance adjustment system 1110 can further include a second adjustable appendage support member 1122 including a second appendage mounting portion 1122A to which the second ground contacting appendage is mounted and an adjustment portion 1122B adjustably coupled to the second end 1112 of the guide member 1114. The adjustment portion 1122B can include a mount portion 1152 configured to receive the second appendage mounting portion 1122A thereon. The adjustment portion 1120B can further include a second rack 1153 to facilitate adjustment of the adjustment portion 1120B relative to the guide member 1114. Similar to the first adjustable appendage support member 1120, the second appendage mounting portion 1122A can be removably and adjustably coupled to the adjustment portion 1122B to facilitate adjustment of the second ground contacting appendage relative to a coronal plane of the robot.

As illustrated in FIG. 26A, the guide member 1114 can comprise a front plate 1114A and a rear plate 1114B coupled to each other to define a hollow space between the plates 1114A and 1114B. The guide member 1114 can define a first opening 1121 formed in a first end 1111 of the guide member 1114. The first opening 1121 can receive the first rack 1151 of the adjustment portion 1120B of the first adjustable appendage support member 1120 and can slideably support the first rack 1151 of the first adjustable appendage support member 1120 to constrain motion of the first adjustable appendage support member 1120 to medial or lateral directions within the guide member 1114. As shown in FIG. 26A, the first rack 1151 can be inserted into the first opening 1121 of the guide member 1114 and can continue through the guide member 1114 and exit out of the second opening 1123 of the guide member.

Similarly, the guide member 1114 can define a second opening 1123 formed in the second end 1112 of the guide member 1114. The second opening 1123 can receive the second rack 1153 of the adjustment portion 1122B of the second adjustable appendage support member 1122 and can slideably support the second rack 1153 of the second adjustable appendage support member 1122 to constrain motion of the second adjustable appendage support member 1122 to medial or lateral directions within the guide member 1114. As shown in FIG. 26A, the second rack 1153 can be inserted into the second opening 1123 of the guide member 1114 and can continue through the guide member 1114 and exit out of the first opening 1121 of the guide member 1114. The first and second adjustable appendage support members 1120 and 1122 can be configured to adjust position and slide inward and/or outward from the first and second openings 1121 and 1123 in response to operation of an adjustment mechanism 1124.

The operation of the adjustment mechanism 1124 is described with reference to FIGS. 26A and 26B. FIG. 26B shows the stance adjustment system 1110 in both a retracted position associated with a first stance of a robotic system (upper portion of FIG. 26B) and an extended position associated with a second stance of the robotic system (lower portion of FIG. 26B). The stance adjustment system 1110 can be operable to adjust a stance of a robotic system between a first stance and a second stance of the robotic system. The adjustment mechanism 1124 of the stance adjustment system 1110 can be operated to adjust the first adjustable appendage support member 1120 between a first position (e.g., the retracted position relative to the guide member 1114 shown in the upper portion of FIG. 26B) and a second position (e.g., the extended position relative to the guide member 1114 shown in the lower portion of FIG. 26B). The adjustment mechanism 1124 can further be operated to adjust the second adjustable appendage support member 1122 between a first position (e.g., the retracted position relative to the guide member 1114 and the sagittal plane shown in the upper portion of FIG. 26B) and a second position (e.g., the extended position relative to the guide member 1114 and sagittal plane SP shown in the lower portion of FIG. 26B).

Adjusting position of the first and second adjustable appendage support members 1120 and 1122 also changes positions of first and second ground contacting appendages fixed to the first and second adjustable appendage support members 1120 and 1122 and the stance of these, which can be for a variety of purposes as discussed herein (e.g., to enhance stability of the robotic system, or to accommodate and more comfortably fit different users of different sizes if the robotic system is an exoskeleton, or others). Indeed, the adjustment mechanism 1124, by adjusting the positions of the first and second adjustable appendage support members 1120 and 1122 and appendages between the first and second positions, can be operable to adjust a stance of the robotic system from a first stance to a second stance. The first and second stances can comprise different distances of the first ground contacting appendage and the second ground contacting appendage about the ground surface relative to the sagittal plane of the robotic system.

As described above, FIG. 26B illustrates the stance adjustment system 1110 in both a retracted position associated with a first stance of a robotic system (see upper portion of FIG. 26B) and an extended position associated with a second stance of the robotic system (see lower portion of FIG. 26B). To adjust the first and second adjustable appendage support members 1120 and 1122 between first positions and second positions, the adjustment mechanism 1124 can comprise a pinion gear 1142 (which can be referred to as an actuator) that is operable to adjust the first adjustable appendage support member 1120 between the first position and the second position to thereby adjust the stance of the robotic system between the first stance and the second stance. The adjustment mechanism 1124 can further include support rollers 1143 and 1144 to provide support to the first and second racks 1151 and 1153 within the guide member 1114.

The pinion gear 1142 can include a plurality of teeth 1145 that engage with a plurality of teeth 1154 on the first rack 1151. Therefore, by turning the pinion gear 1142, whether by hand, motor, or otherwise, the teeth 1145 of the pinion gear 1142 engage with the teeth 1154 of the first rack 1151 and adjust the first adjustable appendage support member 1120 inward or outward of the first opening 1121 of the guide member 1114 to extend or retract the first adjustable appendage support member 1120 and first ground contacting appendage between a first position and a second position relative to the guide member 1114 and the sagittal plane SP. The pinion gear 1142 can also be operable to adjust the second adjustable appendage support member 1122 between the first position and the second position to thereby adjust the stance of the robotic system between the first stance and the second stance. The teeth 1154 of the pinion gear 1142 can engage with a plurality of teeth 1155 on the second rack 1153. Therefore, by turning the pinion gear 1142, whether by hand, motor, or otherwise, the teeth 1145 of the pinion gear 1142 engage with the teeth 1155 of the second rack 1151 and adjust the second adjustable appendage support member 1122 inward or outward of the second opening 1123 of the guide member 1114 to extend or retract the second adjustable appendage support member 1122 and first ground contacting appendage between a first position and a second position relative to the guide member 1114 and the sagittal plane SP. Simultaneously, or alternatively, operation of the pinion gear 1142 can extend or retract the second adjustable appendage support member 1122 relative to the guide member 1114 and the sagittal plane SP.

The adjustment mechanism 1124 can be coupled to the first and second adjustable appendage support members 1120 and 1122. More specifically, the adjustment mechanism 1124 can be coupled to the first rack and the second rack 1151 and 1153 of the first and second adjustable appendage support members 1120 and 1122. The adjustment mechanism 1124 can include a first interface (e.g., the interface between the teeth 1145 of the pinion gear 1142 and the teeth 1154 of the first rack 1151) at which the first adjustable appendage support member 1120 adjustably couples to the adjustment mechanism 1124. The adjustment mechanism 1124 can further include a second interface (e.g., the interface between the teeth 1145 of the pinion gear 1142 and the teeth 1155 of the first rack 1153) at which the second adjustable appendage support member 1122 adjustably couples to the adjustment mechanism 1124. Adjustment of the positions of the first and second adjustable appendage support members 1120 and 1122 can be accomplished by rotation of the pinion gear 1142, by hand, motor, or otherwise, to cause the teeth 1145 of the pinion gear to engage with the teeth 1154 and 1155 of the racks 1151 and 1153.

In the configuration shown in FIGS. 26A-26B, in which both the first and second adjustable appendage support members 1120 and 1122 are simultaneously adjustable by actuation of a single actuator (e.g., pinion gear 1142), the adjustment mechanism 1124 can alternatively be referred to as an adjustable bridge that connects the first ground contacting appendage 102 to the second ground contacting appendage 104 via the first and second adjustable appendage support members 1120 and 1122. The adjustable bridge/stance adjustment mechanism 1124 can be operable to facilitate adjustment of the first and second adjustable appendage support members 1120 and 1122 and the first and second ground contacting appendages 102 and 104. With the adjustable bridge/stance adjustment mechanism 1124, the pinion gear 1142 can be operable to simultaneously adjust the second adjustable appendage support member 1122 and the first adjustable appendage support member 1120. The first adjustable appendage support member 1122 can be adjusted between a first position and a second position of the first adjustable appendage support member 1122 relative to the sagittal plane SP of the robotic system, the first position and the second position of the first adjustable appendage support member 1120 being respectively associated with the first stance and the second stance. The second adjustable appendage support member 1122 can also, and at the same time, be adjusted between a first position and a second position of the second adjustable appendage support member 1122 relative a sagittal plane SP of the robotic system, the first position and the second position of the second adjustable appendage support member 1122 being respectively associated with the first stance and the second stance.

As further illustrated in FIGS. 26A-26B, the pinion gear 1142 can be operable to move first and second racks 1151 and 1153 to adjust the first and second adjustable appendage support members 1120 and 1122 by a same amount relative to the sagittal plane. For example, rotation of the pinion gear 1142 can move both the first and second adjustable appendage support members 1120 and 1122 away from or toward the sagittal plane SP by a substantially equal or equal amount. In other words, actuation of the pinion gear 1142 can move the first adjustable appendage support member 1120 a distance x away from or toward the sagittal plane SP and can also move the second adjustable appendage support member 1122 the same distance x away from or toward the sagittal plane SP. In such a configuration, positions of the first and second adjustable appendage support members 1120 and 1122, whether before, during, or after adjustment, remain symmetrical about the sagittal plane SP. Accordingly, in their respective first positions, in their respective second positions, in positions other than the first and second positions, and in both a first or second stance of the robot, the first and second adjustable appendage support members 1120 and 1122 can be maintained symmetrical about the sagittal plane SP.

The pinion gear 1142 can be operated by a user or a motor. Rotation of the pinion gear 1142 in a clockwise (e.g., first direction) or counter-clockwise direction (e.g., second direction), as shown in FIG. 26B, can cause translation of the first rack 1151 and the second rack 1153 inward/outward from the guide member 1114. Translation of the first rack 1151 and the second rack 1153 in medial or lateral directions from the guide member 1114 can adjust a distance between the first ground contacting appendage 102 and the second ground contacting appendage 104, or a distance of either of these relative to the sagittal plane SP.

Rotation of the pinion gear 1142 in a first direction (e.g., clockwise) can cause the first adjustable appendage support member 1120 and the second adjustable appendage support member 1122 to adjust away from the sagittal plane SP, thereby increasing a distance between the first ground contacting appendage and the second ground contacting appendage to adjust the stance of the robotic system between the first stance and the second stance. Rotation of the pinion gear 1142 in a second direction (e.g., counter clockwise) different than the first direction can cause the first adjustable appendage support member 1120 and the second adjustable appendage support member 1122 to adjust away from the sagittal plane, thereby increasing a distance between the first ground contacting appendage and the second ground contacting appendage to adjust the stance of the robotic system between the first stance and the second stance.

Having the first rack 1151 and the second rack 1153 engaged with the same pinion gear 1142 allows the adjustable bridge (e.g., stance adjustment mechanism 1110) to be operable to move and adjust a distance between both of the adjustable appendage support members 1120 and 1122 with just a single motion or actuation of the pinion gear 1142. Thus, the adjustable bridge according to the present disclosure can facilitate single handed and single user adjustment of a relative distance between the ground contacting appendages of a robotic system 100 (e.g., to accommodate multiple different sizes of users of an exoskeleton therein).

Furthermore, those skilled in the art will recognize that the rack and pinion configurations shown in FIGS. 26A-26B allow for theoretically infinite adjustment positions achievable for the appendages within the range of movement of the adjustable appendage support members, and, therefore, provides for a theoretically infinite number of stances and hip width adjustments for the robot. The configuration further allows for accommodating a theoretically infinite amount of hip widths for users wearing an exoskeleton with the shown configuration. Additionally, the threaded configuration allows the adjustable appendage support members to remain stable at a desired position and to essentially be locked at the desired position while the pinion gear is not being turned.

It will be appreciated that, in alternative examples, each of the first and second adjustable appendage support members 1120 and 1122 can be actuated separately using separate pinion gears to interface with the first and second racks independently. In other words, each of the first and second adjustable appendage support members 1120 and 1122 can be associated with separate individual first and second pinion gears that respectively adjust one of the first and second adjustable appendage support members 1120 and 1122 individually. Furthermore, each of the first and second adjustable appendage support members 1120 and 1122 can be moved or positioned by actuation of respective first and second pinion gears that are each separately operable to respectively adjust the position of the first and second adjustable appendage support members 1120 and 1122 and associated ground contacting appendages relative to the guide member to adjust the stance of the robotic system relative to the sagittal plane between the first stance and the second stance.

The stance adjustment system 1110 can further be configured to provide for adjustment of the ground contacting appendages relative to a coronal plane of the robot. FIG. 26C illustrates a cross sectional view of the stance adjustment system 1110 taken along the sagittal plane SP of FIG. 26B with a view toward the first adjustable appendage support member 1120. As shown in FIGS. 26A and 26C, the first appendage mounting portion 1120A can define a slot 1160. The slot 1160 can receive the mount portion 1150 of the adjustment portion 1120B therein. A plurality of holes 1161 can be formed in an upper, lower, and/or side surface of the first appendage mounting portion 1120A. A plurality of corresponding holes 1162 can be formed in the mount portion 1150. A plurality of fasteners 1164 can be inserted into the holes 1161 and holes 1162 to fix the first appendage mounting portion 1120A to the mount portion 1150. The holes 1161 of the first appendage mounting portion 1120A can each align with one of the corresponding holes 1162 in the mount portion 1150 to fix the first appendage mounting portion 1120A in a first position (e.g. retracted position) relative to the coronal plane CP. Alternatively, the first appendage mounting portion 1120A can be extended forward on the mount portion 1150 such that holes 1161 correspond to different holes 1162 in the mount portion 1150 than in the first position such that the first appendage mounting portion 1120A is in a second position (e.g., extended position) relative to the coronal plane CP. It will be appreciated that any number of holes 1161 and 1162 can be formed in the mount portion 1150 and the first appendage mounting portion 1120A to provide any number of desired positions relative to the coronal plane CP for the first appendage mounting portion 1120A.

The various examples and mechanisms described above can be incorporated into a robotic system. The robotic system can comprise a lower exoskeleton portion configured to receive at least a portion of a lower body of a user. The robotic system can further include a device for adjusting a stance of the robotic system relative to a sagittal plane of the robotic system. The adjustment device can be any adjustment device in accordance with the principles described herein. The robotic system can further include an upper exoskeleton portion configured to receive at least a portion of an upper body of a user. The guide member (e.g., any of the guide members described herein) of the adjustment mechanism is not limited as to where it can be located on the robot. For example, the guide member can be coupled to the lower exoskeleton portion. Alternatively, the guide member can be coupled to one or more of the upper exoskeleton portion in a configuration where the lower appendages of the exoskeleton are supported by the upper exoskeleton portion. Additionally, the guide member can be fixed to both the upper and lower exoskeleton portions.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Although the disclosure may not expressly disclose that some embodiments or features described herein can be combined with other embodiments or features described herein, this disclosure should be read to describe any such combinations that would be practicable by one of ordinary skill in the art. The use of “or” in this disclosure should be understood to mean non-exclusive or, e.g., “and/or,” unless otherwise indicated herein.

Furthermore, the described features, structures, or characteristics can be combined in any suitable manner in one or more examples. In the preceding description, numerous specific details were provided, such as examples of various configurations to provide a thorough understanding of examples of the described technology. It will be recognized, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A robotic system configured to provide different stances, the robotic system comprising:
a first ground contacting appendage; and
a stance adjustment system operable to adjust a stance of the robotic system between a first stance and a second stance, the stance adjustment system comprising:
a guide member comprising a first end and a second end opposite to the first end;
a first adjustable appendage support member comprising a first appendage mounting portion to which the first ground contacting appendage is mounted and an adjustment portion adjustably coupled to the first end of the guide member; and
an adjustment mechanism coupled to at least one of the guide member and the first adjustable appendage support member, the adjustment mechanism being operable to facilitate adjustment of the first adjustable appendage support member and the first ground contacting appendage between a first position and a second position relative to a sagittal plane of the robotic system,
wherein the first position of the first adjustable appendage support member is associated with the first stance, and the second position of the first adjustable appendage support member is associated with the second stance, and
wherein the first and second stances comprise different distances of the first ground contacting appendage relative to the sagittal plane of the robotic system.

2. The robotic system of claim 1, wherein the guide member comprises a first slot defined in the first end and configured to receive at least a part of the adjustment portion of the first adjustable appendage support member, and
wherein the first adjustable appendage support member is configured to adjust position within the first slot in response to operation of the adjustment mechanism to adjust the first adjustable appendage support member between the first position and the second position.

3. The robotic system of claim 1, wherein the guide member comprises a first guide rail formed in the first end and configured to slideably support at least a part of the adjustment portion of the first adjustable appendage support member, and
wherein the first adjustable appendage support member is configured to slide along the first guide rail in response to operation of the adjustment mechanism to adjust the first adjustable appendage support member between the first position and the second position.

4. The robotic system of claim 1, wherein the adjustment mechanism comprises:
a first actuator operable to adjust the first adjustable appendage support member between the first position and the second position to thereby adjust the stance of the robotic system between the first stance and the second stance.

5. The robotic system of claim 4, wherein:
the first adjustable appendage support member comprises a threaded hole formed in the adjustment portion; and
the adjustment mechanism further comprises:
a first elongated rod coupled to the first actuator and having a threaded surface formed thereon, the threaded surface of the first elongated rod being configured to engage with the threaded hole of the first adjustable appendage support member;
wherein the first actuator is operable to cause rotation of the first elongated rod causing the first adjustable appendage support member to adjust position along the first elongated rod between the first position and the second position to thereby adjust the stance of the robotic system between the first stance and the second stance.

6. The robotic system of claim 4, wherein:
the adjustment mechanism comprises a first linkage coupling the first adjustable appendage support member to the first actuator; and
the actuator is operable to move the first linkage to adjust the first adjustable appendage support member between the first position and the second position to thereby adjust the stance of the robotic system between the first stance and the second stance.

7. The robotic system of claim 1, further comprising:
a second adjustable appendage support member comprising a second appendage mounting portion to which the second ground contacting appendage is mounted and an adjustment portion adjustably coupled to the second end of the guide member.

8. The robotic system of claim 7, further comprising:
a second adjustment mechanism coupled to at least one of the guide member and the second adjustable appendage support member, the second adjustment mechanism being operable to facilitate adjustment of the second adjustable appendage support member and the second ground contacting appendage between a first position and a second position relative a sagittal plane of the robotic system,
wherein the first position of the second adjustable appendage support member is associated with the first stance, and the second position of the second adjustable appendage support member is associated with the second stance.

9. The robotic system of claim 8, wherein the guide member comprises a second slot defined in the second end and configured to receive at least a part of the adjustment portion of the second adjustable appendage support member, and
wherein the second adjustable appendage support member is configured to adjust position within the second slot in response to operation of the adjustment mechanism to adjust the second adjustable appendage support member from the first position to the second position.

10. The robotic system of claim 8, wherein the guide member comprises a second guide rail formed in the second end and configured to slideably support at least a part of the adjustment portion of the second adjustable appendage support member, and
wherein the second adjustable appendage support member is configured to slide along the second guide rail in response to operation of the adjustment mechanism to adjust the second adjustable appendage support member between the first position and the second position.

11. The robotic system of claim 8, wherein the second adjustment mechanism comprises:
a second actuator operable to adjust the second adjustable appendage support member between the first position and the second position to thereby adjust the stance of the robotic system between the first stance and the second stance.

12. The robotic system of claim 7, wherein the adjustment mechanism comprises:
an adjustable bridge that connects the first ground contacting appendage to the second ground contacting appendage via the first and second adjustable appendage support members, and is operable to facilitate adjustment of the first and second adjustable appendage support members and the first and second ground contacting appendages, the adjustable bridge comprising:
an actuator;
wherein the actuator is operable to adjust the first adjustable appendage support member between the first position and the second position, and
wherein the actuator is operable to adjust the second adjustable appendage support member between a first position and a second position of the second adjustable appendage support member relative to a sagittal plane of the robotic system, the first position and the second position of the second adjustable appendage support member being respectively associated with the first stance and the second stance.

13. The robotic system of claim 12, wherein the actuator is operable to adjust the first and second adjustable appendage support members by a same amount relative to the sagittal plane such that positions of the first and second adjustable appendage support members are symmetrical about the sagittal plane in both the first stance and the second stance.

14. The robotic system of claim 13, wherein:
the first adjustable appendage support member comprises a threaded hole formed in the adjustment portion thereof; and
the adjustment mechanism further comprises:
a first elongated rod coupled to the actuator and having a threaded surface formed thereon, the threaded surface of the first elongated rod being configured to engage with the threaded hole of the first adjustable appendage support member.

15. The robotic system of claim 14, wherein:
the second adjustable appendage support member comprises a threaded hole formed in the adjustment portion thereof; and
the adjustment mechanism further comprises:
a second elongated rod coupled to the actuator and having a threaded surface formed thereon, the threaded surface of the second elongated rod being configured to engage with the threaded hole of the second adjustable appendage support member.

16. The robotic system of claim 15, wherein the actuator is operable to cause rotation of the first elongated rod and the second elongated rod causing the first adjustable appendage support member to adjust position along the first elongated rod between the first position and the second position, and the second adjustable appendage support member to adjust position along the second elongated rod between the first position and the second position to adjust the stance of the robotic system from the first stance to the second stance.

17. The robotic system of claim 16, wherein rotation of the actuator in a first direction causes the first adjustable appendage support member and the second adjustable appendage support member to adjust away from the sagittal plane, thereby increasing a distance between the first ground contacting appendage and the second ground contacting appendage.

18. The robotic system of claim 17, wherein rotation of the actuator in a second direction causes the first adjustable appendage support member and the second adjustable appendage support member to adjust towards the sagittal plane, thereby decreasing a distance between the first ground contacting appendage and the second ground contacting appendage.

19. The robotic system of claim 12, wherein the adjustable bridge comprises
a first linkage coupling the first adjustable appendage support member to the actuator; and
a second linkage coupling the second adjustable appendage support member to the actuator,
wherein the actuator is operable to move the first linkage and the second linkage to adjust the first adjustable appendage support member and the second adjustable appendage support member between their respective first positions and their respective second positions, to thereby adjust the stance of the robotic system from the first stance to the second stance.

20. The robotic system of claim 19, wherein the actuator is operable to adjust the first and second linkages to adjust the first and second adjustable appendage support members by a same amount relative to the sagittal plane such that positions of the first and second adjustable appendage support members are symmetrical about the sagittal plane in both the first stance and the second stance.

21. The robotic system of claim 19, wherein the actuator comprises a threaded rod having a threaded surface formed thereon.

22. The robotic system of claim 21, wherein the adjustment mechanism further comprises one or more threaded brackets moveably engaged with the threaded surface of the threaded rod, and
wherein the first linkage and the second linkage are each coupled to the one or more threaded brackets.

23. The robotic system of claim 22, wherein rotation of the threaded rod of the actuator causes the threaded brackets to adjust position along the threaded surface of the threaded rod to adjust positions of the first linkage and the second linkage, thereby moving the first and second adjustable appendage support members between their respective first positions and second positions to adjust the stance of the robotic system from the first stance to the second stance.

24. The robotic system of claim 1, wherein the adjustment mechanism comprises:
a plurality of holes formed in one or more of the first end and the second end of the guide member at a plurality of different distances from the sagittal plane;
one or more holes formed in the first adjustable appendage support member and configured to align with one or more of the plurality of holes formed in one or more of the first end and the second end of the guide member; and
one or more fasteners configured to couple the first adjustable appendage support member to the guide member at a desired distance from the sagittal plane.

25. The robotic system of claim 24, wherein the one or more holes formed in the first adjustable appendage support member are formed at a plurality of different distances relative the coronal plane of the robotic system to facilitate adjustment of the first adjustable appendage support member relative to the coronal plane.

26. The robotic system of claim 24, further comprising:
a clamp comprising:
an upper body configured to fix an upper portion of the first adjustable appendage support member to an upper portion of the first end of the guide member, the upper body having one or more holes formed therein configured to align with one or more holes of the guide member and one or more holes of the first adjustable appendage support member; and
a lower body configured to fix a lower portion of the first adjustable appendage support member to a lower portion of the first end of the guide member, the lower body having one or more holes formed therein configured to align with one or more holes of the guide member, one or more holes of the first adjustable appendage support member, and one or more holes of the upper body of the clamp,
wherein the clamp is configured to clamp the adjustable appendage support member to the guide member by insertion of one or more fasteners into the one or more holes of the upper body and the lower body of the clamp aligned with one or more holes of the guide member and one or more holes of the first adjustable appendage support member.

27. The robotic system of claim 1, further comprising:
a first coronal adjustment mechanism coupled to the first appendage mounting portion and the adjustment portion of the first adjustable appendage support member, the first coronal adjustment mechanism being operable to facilitate adjustment of the first adjustable appendage support member and the first ground contacting appendage between a first coronal position and a second coronal position relative to a coronal plane of the robotic system,
wherein the first coronal position of the first adjustable appendage support member is associated with a first coronal stance of the robotic system, and the second coronal position of the first adjustable appendage support member is associated with a second coronal stance of the robotic system, and
wherein the first and second stances comprise different distances of the first ground contacting appendage relative to the coronal plane of the robotic system.

28. The robotic system of claim 27, further comprising:
a second adjustable appendage support member comprising a second appendage mounting portion to which the second ground contacting appendage is mounted and an adjustment portion adjustably coupled to the second end of the guide member; and
a second coronal adjustment mechanism coupled to the second appendage mounting portion and the adjustment portion of the second adjustable appendage support member, the second coronal adjustment mechanism being operable to facilitate adjustment of the second adjustable appendage support member and the second ground contacting appendage between a first coronal position and a second coronal position relative to a coronal plane of the robotic system,
wherein the first coronal position of the second adjustable appendage support member is associated with a first coronal stance of the robotic system, and the second coronal position of the second adjustable appendage support member is associated with a second coronal stance of the robotic system, and
wherein the first and second stances comprise different distances of the second ground contacting appendage relative to the coronal plane of the robotic system.

29. The robotic system of claim 1, further comprising:
a lower exoskeleton portion configured to receive at least a portion of a lower body of a user;
an upper exoskeleton portion configured to receive at least a portion of an upper body of a user; and
a frame mount coupled to one or more of the lower exoskeleton portion and the upper exoskeleton portion,
wherein the guide member of the stance adjustment system is coupled to the frame mount.

30. The robotic system of claim 1, further comprising:
a lower exoskeleton portion configured to receive at least a portion of a lower body of a user;
an upper exoskeleton portion configured to receive at least a portion of an upper body of a user; and
wherein the lower exoskeleton portion and the upper exoskeleton portion are coupled to the stance adjustment system.

31. The robotic system of claim 1, wherein the adjustment mechanism is operable to facilitate adjustment of the first adjustable appendage support member and the first ground contacting appendage between three or more positions relative to a sagittal plane of the robotic system.

32. The robotic system of claim 8, wherein the second adjustment mechanism is operable to facilitate adjustment of the second adjustable appendage support member and the second ground contacting appendage between three or more positions relative to a sagittal plane of the robotic system.

33. The robotic system of claim 12, wherein the adjustable bridge is operable to facilitate adjustment of each of the first and second adjustable appendage support members between three or more positions relative to a sagittal plane of the robotic system.

34. The robotic system of claim 4, wherein the actuator comprises a pinion gear and the adjustment mechanism comprises:
a first rack coupling the first adjustable appendage support member to the pinion gear;
wherein the pinion gear is operable to move the first rack to adjust the first adjustable appendage support member between the first position and the second position, to thereby adjust the stance of the robotic system from the first stance to the second stance.

35. The robotic system of claim 12, wherein the actuator comprises a pinion gear and the adjustable bridge comprises:
a first rack coupling the first adjustable appendage support member to the pinion gear; and
a second rack coupling the second adjustable appendage support member to the pinion gear,
wherein the pinion gear is operable to move the first rack and the second rack to adjust the first adjustable appendage support member and the second adjustable appendage support member between their respective first positions and their respective second positions, to thereby adjust the stance of the robotic system from the first stance to the second stance.

36. The robotic system of claim 35, wherein the pinion gear is operable to adjust the first and second racks to adjust the first and second adjustable appendage support members by a same amount relative to the sagittal plane such that positions of the first and second adjustable appendage support members are symmetrical about the sagittal plane in both the first stance and the second stance.

37. A robotic system comprising:
a first ground contacting appendage;
a second ground contacting appendage; and
a stance adjustment system operable to adjust a stance of the robotic system between a first stance and a second stance, the stance adjustment system comprising:
a guide member comprising a first end and a second end opposite to the first end;
a first adjustable appendage support member comprising a first appendage mounting portion to which the first ground contacting appendage is mounted and an adjustment portion adjustably coupled to the first end of the guide member;
a second adjustable appendage support member comprising a second appendage mounting portion to which the second ground contacting appendage is mounted and an adjustment portion adjustably coupled to the second end of the guide member; and
an adjustment mechanism coupled to the first adjustable appendage support member and the second adjustable appendage support member, the adjustment mechanism being operable to facilitate adjustment of the first and second adjustable appendage support members and first and second ground contacting appendages between first positions and second positions relative to a sagittal plane of the robotic system,
wherein the first positions of the first and second adjustable appendage support member are associated with the first stance, and the second positions of the first and second adjustable appendage support members are associated with the second stance, and
wherein the first and second stances comprise different distances of the first and second ground contacting appendages relative to the sagittal plane of the robotic system.

38. The robotic system of claim 36, wherein the guide member comprises a first slot defined in the first end configured to receive at least a part of the adjustment portion of the first adjustable appendage support member, and a second slot defined in the second end configured to receive at least a part of the adjustment portion of the second adjustable appendage support member,
wherein the first adjustable appendage support member is configured to adjust position within the first slot and the second adjustable appendage support member is configured to adjust position within the second slot in response to operation of the adjustment mechanism to adjust the first and second adjustable appendage support members between the first positions and the second positions.

39. The robotic system of claim 37, wherein the guide member comprises a first guide rail formed in the first end configured to slideably support at least a part of the adjustment portion of the first adjustable appendage support member, and a second guide rail formed in the second end configured to slidably support at least a part of the adjustment portion of the second adjustable appendage support member,
wherein the first adjustable appendage support member is configured to move along the first guide rail and the second adjustable appendage support member is configured to move along the second guide rail in response to operation of the adjustment mechanism to adjust the first and second adjustable appendage support members between the first positions and the second positions.

40. The robotic system of claim 37, wherein the adjustment mechanism further comprises:
an actuator operable to adjust the first and second adjustable appendage support members between the first positions and the second positions to thereby adjust the stance of the robotic system from the first stance to the second stance.

41. The robotic system of claim 40, wherein:
the first adjustable appendage support member comprises a threaded hole formed in the adjustment portion thereof;
the second adjustable appendage support member comprises a threaded hole formed in the adjustment portion thereof; and
the adjustment mechanism further comprises:
a first elongated rod coupled to the actuator and having a threaded surface formed thereon, the threaded surface of the first elongated rod being configured to engage with the threaded hole of the first adjustable appendage support member; and
a second elongated rod coupled to the actuator and having a threaded surface formed thereon, the threaded surface of the second elongated rod being configured to engage with the threaded hole of the second adjustable appendage support member;
wherein the actuator is operable to cause rotation of the first and second elongated rods causing the first and second adjustable appendage support members to respectively adjust position along the first and second elongated rods from between respective first positions to respective second positions to thereby adjust the stance of the robotic system from the first stance to the second stance.

42. The robotic system of claim 41, wherein the actuator is operable to adjust the first and second adjustable appendage support members by a same amount relative to the sagittal plane such that positions of the first and second adjustable appendage support members are symmetrical about the sagittal plane in both the first stance and the second stance.

43. The robotic system of claim 42, wherein rotation of the actuator in a first direction causes the first and second adjustable appendage support members to adjust away from the sagittal plane, thereby increasing a distance between the first ground contacting appendage and the second ground contacting appendage.

44. The robotic system of claim 43, wherein rotation of the actuator in a second direction causes the first and second adjustable appendage support members to adjust towards the sagittal plane, thereby decreasing a distance between the first ground contacting appendage and the second ground contacting appendage.

45. The robotic system of claim 41, wherein the adjustment mechanism comprises:
a first linkage coupling the first adjustable appendage support member to the actuator; and
a second linkage coupling the second adjustable appendage support member to the actuator,
wherein the actuator is operable to move the first linkage and the second linkage to adjust the first adjustable appendage support member and the second adjustable appendage support member between the respective first positions and second positions, to thereby adjust the stance of the robotic system from the first stance to the second stance.

46. The robotic system of claim 45, wherein the actuator is operable to adjust the first and second linkages to adjust the first and second adjustable appendage support members by a same amount relative to the sagittal plane such that positions of the first and second adjustable appendage support members are symmetrical about the sagittal plane in both the first stance and the second stance.

47. The robotic system of claim 45, wherein the actuator comprises a threaded rod having a threaded surface formed thereon.

48. The robotic system of claim 47, wherein the adjustment mechanism further comprises one or more threaded brackets moveably engaged to the threaded rod,
wherein the first linkage and the second linkage are each coupled to the one or more threaded brackets.

49. The robotic system of claim 48, wherein rotation of the threaded rod of the actuator causes the threaded brackets to adjust position along the threaded surface of the threaded rod to adjust positions of the first linkage and the second linkage, thereby moving the first and second adjustable appendage support members between their respective first positions and second positions to adjust the stance of the robotic system from the first stance to the second stance.

50. The robotic system of claim 49, wherein a first operation of the actuator causes the first adjustable appendage support member and the second adjustable appendage support member to adjust away from the sagittal plane, thereby increasing a distance between the first ground contacting appendage and the second ground contacting appendage.

51. The robotic system of claim 50, wherein a second operation of the actuator causes the first adjustable appendage support member and the second adjustable appendage support member to adjust towards the sagittal plane, thereby decreasing a distance between the first ground contacting appendage and the second ground contacting appendage.

52. The robotic system of claim 37, further comprising:
a first coronal adjustment mechanism coupled to the first appendage mounting portion and the adjustment portion of the first adjustable appendage support member, the first coronal adjustment mechanism being operable to facilitate adjustment of the first adjustable appendage support member and the first ground contacting appendage between a first coronal position and a second coronal position relative to a coronal plane of the robotic system,
wherein the first coronal position of the first adjustable appendage support member is associated with a first coronal stance of the robotic system, and the second coronal position of the first adjustable appendage support member is associated with a second coronal stance of the robotic system, and
wherein the first and second stances comprise different distances of the first ground contacting appendage relative to the coronal plane of the robotic system.

53. The robotic system of claim 37, further comprising:
a second adjustable appendage support member comprising a second appendage mounting portion to which the second ground contacting appendage is mounted and an adjustment portion adjustably coupled to the second end of the guide member; and
a second coronal adjustment mechanism coupled to the second appendage mounting portion and the adjustment portion of the second adjustable appendage support member, the second coronal adjustment mechanism being operable to facilitate adjustment of the second adjustable appendage support member and the second ground contacting appendage between a first coronal position and a second coronal position relative to a coronal plane of the robotic system,
wherein the first coronal position of the second adjustable appendage support member is associated with a first coronal stance of the robotic system, and the second coronal position of the second adjustable appendage support member is associated with a second coronal stance of the robotic system, and
wherein the first and second stances comprise different distances of the second ground contacting appendage relative to the coronal plane of the robotic system.

54. The robotic system of claim 37, further comprising:
a lower exoskeleton portion configured to receive at least a portion of a lower body of a user;
an upper exoskeleton portion configured to receive at least a portion of an upper body of a user; and
a frame mount coupled to one or more of the lower exoskeleton portion and the upper exoskeleton portion,
wherein the guide member of the stance adjustment system is coupled to the frame mount.

55. The robotic system of claim 37, further comprising:
a lower exoskeleton portion configured to receive at least a portion of a lower body of a user;
an upper exoskeleton portion configured to receive at least a portion of an upper body of a user; and
wherein the lower exoskeleton portion and the upper exoskeleton portion are coupled to the stance adjustment system.

56. The robotic system of claim 37, wherein the adjustment mechanism is operable to facilitate adjustment of each of the first and second adjustable appendage support members between three or more positions relative to a sagittal plane of the robotic system.

57. The robotic system of claim 37, wherein the actuator comprises a pinion gear and the adjustment mechanism comprises:
a first rack coupling the first adjustable appendage support member to the pinion gear; and
a second rack coupling the second adjustable appendage support member to the pinion gear,
wherein the pinion gear is operable to move the first rack and the second rack to adjust the first adjustable appendage support member and the second adjustable appendage support member between their respective first positions and their respective second positions, to thereby adjust the stance of the robotic system from the first stance to the second stance.

58. The robotic system of claim 57, wherein the pinion gear is operable to adjust the first and second racks to adjust the first and second adjustable appendage support members by a same amount relative to the sagittal plane such that positions of the first and second adjustable appendage support members are symmetrical about the sagittal plane in both the first stance and the second stance.

59. A robotic exoskeleton configured to accommodate users of different size, the robotic exoskeleton comprising:
a first ground contacting appendage comprising one or more joints corresponding to respective degrees of freedom of a first leg of a user;
a second ground contacting appendage comprising one or more joints corresponding to respective degrees of freedom of a second leg of the user; and
a stance adjustment system operable to adjust a stance of the robotic exoskeleton from a first stance to a second stance, the stance adjustment system comprising:
a guide member comprising a first end and a second end opposite to the first end;
a first adjustable appendage support member comprising a first appendage mounting portion to which the first ground contacting appendage is mounted and an adjustment portion moveably coupled to the first end of the guide member;
a second adjustable appendage support member comprising a second appendage mounting portion to which the second ground contacting appendage is mounted and a second adjustment portion moveably coupled to the second end of the guide member; and
an adjustment mechanism coupled to the first adjustable appendage support member and the second adjustable appendage support member, the adjustment mechanism being operable to facilitate adjustment of the first and second adjustable appendage support members and first and second ground contacting appendages between first positions and second positions relative to a sagittal plane of the robotic system,
wherein the first positions of the first and second adjustable appendage support member are associated with the first stance, and the second positions of the first and second adjustable appendage support members are associated with the second stance, and
wherein the first and second stances comprise different distances of the first and second ground contacting appendages relative to the sagittal plane of the robotic system to accommodate different hip widths of the different users.

60. The robotic exoskeleton of claim 59, wherein the guide member comprises a first slot defined in the first end configured to receive at least a part of the adjustment portion of the first adjustable appendage support member, and a second slot defined in the second end configured to receive at least a part of the adjustment portion of the second adjustable appendage support member,
wherein the first adjustable appendage support member is configured to adjust position within the first slot and the second adjustable appendage support member is configured to adjust position within the second slot in response to operation of the adjustment mechanism to adjust the first and second adjustable appendage support members between the first positions and the second positions.

61. The robotic exoskeleton of claim 59, wherein the guide member comprises a first guide rail formed in the first end configured to slideably support at least a part of the adjustment portion of the first adjustable appendage support member, and a second guide rail formed in the second end configured to slideably support at least a part of the adjustment portion of the second adjustable appendage support member,
wherein the first adjustable appendage support member is configured to move along the first guide rail and the second adjustable appendage support member is configured to move along the second guide rail in response to operation of the adjustment mechanism to adjust the first and second adjustable appendage support members between the first positions and the second positions.

62. The robotic exoskeleton of claim 59, wherein the adjustment mechanism further comprises:
an actuator operable to adjust the first and second adjustable appendage support members between the respective first positions and second positions to thereby adjust the stance of the robotic system from the first stance to the second stance.

63. The robotic exoskeleton of claim 62, wherein:
the first adjustable appendage support member comprises a threaded hole formed in the adjustment portion thereof;
the second adjustable appendage support member comprises a threaded hole formed in the adjustment portion thereof; and
the adjustment mechanism further comprises:
a first elongated rod coupled to the actuator and having a threaded surface formed thereon, the threaded surface of the first elongated rod being configured to engage with the threaded hole of the first adjustable appendage support member; and
a second elongated rod coupled to the actuator and having a threaded surface formed thereon, the threaded surface of the second elongated rod being configured to engage with the threaded hole of the second adjustable appendage support member;
wherein the actuator is operable to cause rotation of the first and second elongated rods causing the first and second adjustable appendage support members to respectively adjust position along the first and second elongated rods from between respective first positions to respective second positions to thereby adjust the stance of the robotic system from the first stance to the second stance.

64. The robotic exoskeleton of claim 63, wherein the actuator is operable to cause rotation of the first and second elongated rods to adjust the first and second adjustable appendage support members by a same amount relative to the sagittal plane such that positions of the first and second adjustable appendage support members are symmetrical about the sagittal plane in both the first stance and the second stance.

65. The robotic exoskeleton of claim 63, wherein rotation of the actuator in a first direction causes the first and second adjustable appendage support members to adjust away from the sagittal plane, thereby increasing a distance between the first ground contacting appendage and the second ground contacting appendage.

66. The robotic exoskeleton of claim 65, wherein rotation of the actuator in a second direction causes the first and second adjustable appendage support members to adjust towards the sagittal plane, thereby decreasing a distance between the first ground contacting appendage and the second ground contacting appendage.

67. The robotic exoskeleton of claim 62, wherein the adjustment mechanism comprises:
a first linkage coupling the first adjustable appendage support member to the actuator; and
a second linkage coupling the second adjustable appendage support member to the actuator,
wherein the actuator is operable to move the first linkage and the second linkage to adjust the first adjustable appendage support member and the second adjustable appendage support member between the respective first positions and second positions, to thereby adjust the stance of the robotic system from the first stance to the second stance.

68. The robotic exoskeleton of claim 67, wherein the actuator is operable to adjust the first and second linkages to adjust the first and second adjustable appendage support members by a same amount relative to the sagittal plane such that positions of the first and second adjustable appendage support members are symmetrical about the sagittal plane in both the first stance and the second stance.

69. The robotic exoskeleton of claim 67, wherein the actuator comprises a threaded rod having a threaded surface formed thereon.

70. The robotic exoskeleton of claim 69, wherein the adjustment mechanism further comprises one or more threaded brackets moveably engaged to the threaded rod,
wherein the first linkage and the second linkage are each coupled to the one or more threaded brackets.

71. The robotic exoskeleton of claim 70, wherein rotation of the threaded rod of the actuator causes the threaded brackets to adjust position along the threaded surface of the threaded rod to adjust positions of the first linkage and the second linkage, thereby moving the first and second adjustable appendage support members between their respective first positions and second positions to adjust the stance of the robotic system from the first stance to the second stance.

72. The robotic exoskeleton of claim 71, wherein a first operation of the actuator causes the first adjustable appendage support member and the second adjustable appendage support member to adjust away from the sagittal plane, thereby increasing a distance between the first ground contacting appendage and the second ground contacting appendage.

73. The robotic exoskeleton of claim 72, wherein a second operation of the actuator causes the first adjustable appendage support member and the second adjustable appendage support member to adjust towards the sagittal plane, thereby decreasing a distance between the first ground contacting appendage and the second ground contacting appendage.

74. The robotic exoskeleton of claim 59, further comprising:
a first coronal adjustment mechanism coupled to the first appendage mounting portion and the adjustment portion of the first adjustable appendage support member, the first coronal adjustment mechanism being operable to facilitate adjustment of the first adjustable appendage support member and the first ground contacting appendage between a first coronal position and a second coronal position relative to a coronal plane of the robotic system,
wherein the first coronal position of the first adjustable appendage support member is associated with a first coronal stance of the robotic system, and the second coronal position of the first adjustable appendage support member is associated with a second coronal stance of the robotic system, and
wherein the first and second stances comprise different distances of the first ground contacting appendage relative to the coronal plane of the robotic system.

75. The robotic exoskeleton of claim 59, further comprising:
a second adjustable appendage support member comprising a second appendage mounting portion to which the second ground contacting appendage is mounted and an adjustment portion adjustably coupled to the second end of the guide member; and
a second coronal adjustment mechanism coupled to the second appendage mounting portion and the adjustment portion of the second adjustable appendage support member, the second coronal adjustment mechanism being operable to facilitate adjustment of the second adjustable appendage support member and the second ground contacting appendage between a first coronal position and a second coronal position relative to a coronal plane of the robotic system,
wherein the first coronal position of the second adjustable appendage support member is associated with a first coronal stance of the robotic system, and the second coronal position of the second adjustable appendage support member is associated with a second coronal stance of the robotic system, and
wherein the first and second stances comprise different distances of the second ground contacting appendage relative to the coronal plane of the robotic system.

76. The robotic exoskeleton of claim 59, further comprising:
a lower exoskeleton portion configured to receive at least a portion of a lower body of a user;
an upper exoskeleton portion configured to receive at least a portion of an upper body of a user; and
a frame mount coupled to one or more of the lower exoskeleton portion and the upper exoskeleton portion,
wherein the guide member of the stance adjustment system is coupled to the frame mount.

77. The robotic exoskeleton of claim 59, further comprising:
a lower exoskeleton portion configured to receive at least a portion of a lower body of a user;
an upper exoskeleton portion configured to receive at least a portion of an upper body of a user; and
wherein the lower exoskeleton portion and the upper exoskeleton portion are coupled to the stance adjustment system.

78. The robotic exoskeleton of claim 59, wherein the stance adjustment system is operable to facilitate adjustment of each of the first and second adjustable appendage support members between three or more positions relative to a sagittal plane of the robotic system.

79. The robotic exoskeleton of claim 59, wherein the actuator comprises a pinion gear and the adjustment mechanism comprises:
a first rack coupling the first adjustable appendage support member to the pinion gear; and
a second rack coupling the second adjustable appendage support member to the pinion gear,
wherein the pinion gear is operable to move the first rack and the second rack to adjust the first adjustable appendage support member and the second adjustable appendage support member between their respective first positions and their respective second positions, to thereby adjust the stance of the robotic system from the first stance to the second stance.

80. The robotic exoskeleton of claim 79, wherein the pinion gear is operable to adjust the first and second racks to adjust the first and second adjustable appendage support members by a same amount relative to the sagittal plane such that positions of the first and second adjustable appendage support members are symmetrical about the sagittal plane in both the first stance and the second stance.

81. A method of facilitating stance adjustment of a robotic system, the method comprising:
configuring the robotic system to include a first ground contacting appendage;
configuring the robotic system to include a stance adjustment system operable to adjust a stance of the robotic system from a first stance to a second stance;
configuring the stance adjustment system to include a guide member comprising a first end and a second end opposite to the first end;
configuring the stance adjustment system to include a first adjustable appendage support member comprising a first appendage mounting portion to which the first ground contacting appendage is mounted and an adjustment portion adjustably coupled to the guide member; and
configuring the stance adjustment system to include an adjustment mechanism coupled to at least one of the guide member and the first adjustable appendage support member, the adjustment mechanism being operable to facilitate adjustment of the first adjustable appendage support member and the first ground contacting appendage between a first position and a second position relative to a sagittal plane of the robotic system,
wherein the adjustment mechanism is operable to move the first adjustable appendage support member from a first position associated with the first stance to a second position associated with the second stance, the first and second positions having different distances relative to the sagittal plane of the robotic system,
wherein the first position of the first adjustable appendage support member is associated with the first stance, and the second position of the first adjustable appendage support member is associated with the second stance, and
wherein the first and second stances comprise different distances of the first ground contacting appendage relative to the sagittal plane of the robotic system.
